(19) United States
(12) Patent Application Publication
(10) Pub. No.: US 2025/0076330 A1
(43) Pub. Date: Mar. 6, 2025

(54) MEASURING CHIP, AUTOMATIC ANALYZING APPARATUS, REACTION CUVETTE, AND AUTOMATIC ANALYZING SYSTEM

(71) Applicant: CANON MEDICAL SYSTEMS CORPORATION, Otawara-shi (JP)

(72) Inventors: Shozo HASHIMOTO, Nasushiobara (JP); Tomohiro SUGIMURA, Utsunomiya (JP); Masahiro MASUBUCHI, Yaita (JP); Ryu TAKAHASHI, Nasushiobara (JP); Hiroko TAKAYAMA, Utsunomiya (JP); Yuki YASUDA, Sakura (JP)

(73) Assignee: CANON MEDICAL SYSTEMS CORPORATION, Otawara-shi (JP)

(21) Appl. No.: 18/821,284

(22) Filed: Aug. 30, 2024

(30) Foreign Application Priority Data
Sep. 1, 2023 (JP) 2023-142390
Sep. 1, 2023 (JP) 2023-142392

(51) Int. Cl. G01N 35/02; G01N 35/10

(52) U.S. Cl. CPC G01N 35/025; G01N 35/021; G01N 35/026; G01N 35/1067

(57) ABSTRACT

According to one embodiment, a measuring chip includes a chip body, an aspiration port, a plurality of terminals, and an attaching portion. The chip body accommodates a sample or a mixture liquid obtained by mixing a reagent that reacts with the sample or a diluent that dilutes the sample with the sample. The aspiration port is provided in the chip body and aspirate the sample or the mixture liquid. The plurality of terminals is provided in the chip body and measure a concentration of a target substance in the sample or the mixture liquid aspirated from the aspiration port. The attaching portion attaches the chip body to a transporter of an automatic analyzing apparatus.

### CROSS REFERENCE TO RELATED APPLICATIONS

This application is based upon and claims the benefit of priority from the prior Japanese Patent Application No. 2023-142390 and No. 2023-142392, filed on Sep. 1, 2023, the entire contents of which are incorporated herein by reference.

### FIELD

Embodiments disclosed in the present specification and the drawings relate to a measuring chip, an automatic analyzing apparatus, a reaction cuvette, and an automatic analyzing system.

### BACKGROUND

An automatic analyzing apparatus is an apparatus that analyzes a component of a test sample corresponding to each test item, for example, by optically measuring a mixture liquid obtained by mixing a sample such as a test sample collected from a subject such as blood or a standard sample of each test item with a reagent corresponding to each test item or a diluent that dilutes the sample. One of the test items of the automatic analyzing apparatus is measurement of an electrolyte item such as a sodium ion, a potassium ion, or a chlorine ion in the sample or the mixture liquid.

When using an electrolyte measuring unit for the measurement of the electrolyte item, the automatic analyzing apparatus feeds a sample or a mixture liquid to the electrolyte measuring unit and measures a potential of the fed sample or mixture liquid to measure a concentration of electrolyte in the sample or the mixture liquid. However, in the measurement of the electrolyte item using the electrolyte measuring unit, a mechanism for moving the sample or the mixture liquid to the electrolyte measurement unit, a mechanism for cleaning the electrolyte measuring unit, and the like are required, and it is difficult to miniaturize the automatic analyzing apparatus.

### BRIEF DESCRIPTION OF THE DRAWINGS

FIG. 1 is a block diagram illustrating an example of a functional configuration of an automatic analyzing apparatus according to a first embodiment;

FIG. 2 is a diagram illustrating an example of a configuration of an analysis mechanism according to the first embodiment;

FIG. 3 is a diagram illustrating an example of a configuration of a measuring chip according to the first embodiment;

FIGS. 4A and 4B are diagrams illustrating an example of a configuration of a supplier included in the analysis mechanism according to the first embodiment;

FIGS. 5A and 5B are diagrams illustrating an example of a configuration of a transportation mechanism according to the first embodiment;

FIG. 6 is an explanatory view for explaining a transportation path of the measuring chip and each position on the transportation path in the transportation mechanism according to the first embodiment;

FIGS. 7A to 7D are explanatory views for explaining a series of flow from attachment of the measuring chip to the transportation mechanism to disposal of the measuring chip in the analysis mechanism according to the first embodiment;

FIG. 8 is a flowchart showing contents of an electrolyte item measuring process executed by the automatic analyzing apparatus according to the first embodiment;

FIGS. 9A to 9E are explanatory views for explaining an operation example of the transportation mechanism in the electrolyte item measuring process according to the first embodiment;

FIG. 10 is a flowchart showing contents of a remaining amount reporting process executed by the automatic analyzing apparatus according to the first embodiment;

FIG. 11 is a flowchart showing contents of a disposal amount reporting process executed by the automatic analyzing apparatus according to the first embodiment;

FIG. 12 is a diagram illustrating an example of a configuration of a measuring chip according to a second embodiment;

FIGS. 13A to 13E are explanatory views for explaining a series of flow from attachment of the measuring chip to a transportation mechanism to disposal of the measuring chip in an analysis mechanism according to the second embodiment;

FIG. 14 is a diagram illustrating another example of a configuration of the measuring chip according to the second embodiment;

FIG. 15 is a diagram illustrating an example of a configuration of a measuring chip according to a third embodiment;

FIG. 16 is a diagram illustrating an example of a configuration of a transportation mechanism according to the third embodiment;

FIGS. 17A to 17D are explanatory views for explaining a series of flow from attachment of the measuring chip to the transportation mechanism to disposal of the measuring chip in an analysis mechanism according to the third embodiment;

FIG. 18 is a diagram illustrating an example of a configuration of an analysis mechanism according to a first modification;

FIG. 19 is a diagram illustrating an example of a configuration of a measuring chip according to the first modification;

FIG. 20 is a diagram illustrating an example of a configuration of a transportation mechanism according to the first modification;

FIG. 21 is a diagram illustrating an example of a configuration of a placing base included in the analysis mechanism according to the first modification;

FIG. 22 is an explanatory view for explaining an example of a transportation path of the measuring chip and each position on the transportation path in the transportation mechanism and a disposal chip transportation mechanism according to the first modification;

FIGS. 23A to 23F are explanatory views for explaining a series of flow from attachment of the measuring chip to the transportation mechanism to disposal of the measuring chip in the analysis mechanism according to the first modification;

FIG. 24 is a flowchart showing contents of an electrolyte item measuring process executed by an automatic analyzing apparatus according to the first modification;

FIG. 25 is an explanatory view for explaining another example of the transportation path of the measuring chip and each position on the transportation path in the transportation mechanism and the disposal chip transportation mechanism according to the first modification;

FIG. 26 is a diagram illustrating an example of a configuration of an analysis mechanism according to a second modification;

FIGS. 27A and 27B are diagrams illustrating an example of a configuration of an aspiration unit according to the second modification;

FIG. 28 is a conceptual diagram for explaining an example of a transportation path of a measuring chip and each position on the transportation path in a transportation mechanism according to the second modification;

FIG. 29 is a flowchart showing contents of an electrolyte item measuring process executed by an automatic analyzing apparatus according to the second modification;

FIGS. 30A to 30F are explanatory views for explaining an operation example of the transportation mechanism in the electrolyte item measuring process according to the second modification;

FIG. 31 is a diagram illustrating another example of the configuration of the transportation mechanism included in the analysis mechanism according to the second modification;

FIGS. 32A to 32D are explanatory views for explaining the transportation path of the measuring chip, each position on the transportation path, and an operation example of the transportation mechanism in another example of the configuration of the transportation mechanism according to the second modification;

FIGS. 33A to 33D are explanatory views for explaining the transportation path of the measuring chip, each position on the transportation path, and an operation example of the transportation mechanism in another example of the configuration of the transportation mechanism according to the second modification;

FIG. 34 is a diagram illustrating an example of a configuration of a transportation mechanism according to a third modification;

FIG. 35 is a diagram illustrating an example of a configuration of a measuring chip according to the third modification;

FIG. 36 is a diagram illustrating a state in which the measuring chip according to the third modification is attached to the transportation mechanism;

FIGS. 37A and 37B are diagrams illustrating another example of the transportation mechanism and the measuring chip according to the third modification;

FIG. 38 is a diagram illustrating another example of the transportation mechanism and the measuring chip according to the third modification;

FIG. 39 is a diagram illustrating another example of a state in which the measuring chip according to third modification is attached to the transportation mechanism;

FIGS. 40A and 40B are diagrams illustrating another example of a guiding portion and a correcting portion illustrated in FIGS. 38 and 39;

FIG. 41 is a block diagram illustrating an example of a functional configuration of an automatic analyzing apparatus according to a fourth embodiment;

FIG. 42 is a diagram illustrating an example of a configuration of an analysis mechanism according to the fourth embodiment;

FIGS. 43A to 43C are diagrams illustrating an example of a reaction cuvette used in the analysis mechanism illustrated in FIG. 2 in the fourth embodiment;

FIG. 44 is a configuration diagram of a photometric unit included in the analysis mechanism illustrated in FIG. 42 as viewed from above;

FIG. 45 is a configuration diagram of the photometric unit included in the analysis mechanism illustrated in FIG. 42 as viewed from a side surface;

FIG. 46 is a configuration diagram of another example of the photometric unit included in the analysis mechanism illustrated in FIG. 42 as viewed from above;

FIG. 47 is a diagram illustrating an example of a method of measuring a potential by a measurer according to the fourth embodiment;

FIG. 48 is a flowchart showing contents of a transportation process executed by the automatic analyzing apparatus according to the fourth embodiment;

FIG. 49 is a flowchart showing contents of an electrolyte item measuring process executed by the automatic analyzing apparatus according to the fourth embodiment;

FIG. 50 is a flowchart showing contents of a disposal amount reporting process executed by the automatic analyzing apparatus according to the fourth embodiment;

FIGS. 51A to 51C are diagrams illustrating another example of the reaction cuvette used in the analysis mechanism illustrated in FIG. 42 in the fourth embodiment;

FIG. 52 is a diagram illustrating another example of the method of measuring a potential by the measurer according to the fourth embodiment;

FIGS. 53A to 53C are diagrams illustrating another example of the reaction cuvette used in the analysis mechanism illustrated in FIG. 42 in the fourth embodiment;

FIG. 54 is a diagram illustrating another example of the method of measuring a potential by the measurer according to the fourth embodiment;

FIGS. 55A and 55B are diagrams illustrating another example of the method of measuring a potential by the measurer according to the fourth embodiment;

FIGS. 56A and 56B are diagrams illustrating another example of the method of measuring a potential by the measurer according to the fourth embodiment;

FIGS. 57A and 57B are diagrams illustrating another example of the reaction cuvette used in the analysis mechanism illustrated in FIG. 42 in the fourth embodiment;

FIG. 58 is a diagram illustrating another example of the method of measuring a potential by the measurer according to the fourth embodiment;

FIG. 59 is a block diagram illustrating an example of a functional configuration of an automatic analyzing apparatus according to a fifth embodiment;

FIG. 60 is a diagram illustrating an example of a configuration of an analysis mechanism according to the fifth embodiment;

FIGS. 61A to 61D are schematic diagrams illustrating an operation example of a terminal applier in the automatic analyzing apparatus according to the fifth embodiment;

FIG. 62 is a diagram illustrating an example of a method of measuring a potential by a measurer according to the fifth embodiment;

FIG. 63 is a flowchart showing contents of a transportation process executed by the automatic analyzing apparatus according to the fifth embodiment;

FIG. 64 is a diagram illustrating an example of a configuration of an analysis mechanism according to a sixth embodiment;

FIGS. 65A to 65C are diagrams illustrating an example of a reaction cuvette used in the analysis mechanism illustrated in FIG. 64 in the sixth embodiment;

FIGS. 66A to 66C are schematic diagrams illustrating an example of a configuration of a transfer unit in the sixth embodiment;

FIG. 67 is a schematic view illustrating a flow until the reaction cuvette is placed in a reaction disk in the sixth embodiment;

FIGS. 68A and 68B are diagrams illustrating an example of a method of measuring a potential by a measurer according to the sixth embodiment;

FIG. 69 is a diagram illustrating another example of the method of measuring a potential by the measurer according to the sixth embodiment; and

FIG. 70 is a diagram illustrating an example of a configuration of an analysis mechanism according to a fourth modification.

### DETAILED DESCRIPTION

Hereinafter, embodiments of a measuring chip, an automatic analyzing apparatus, a reaction cuvette, and an automatic analyzing system are described with reference to the drawings. Note that, in the following description, components having substantially the same functions and configurations are denoted by the same reference numerals, and redundant description is made only when necessary.

### First Embodiment

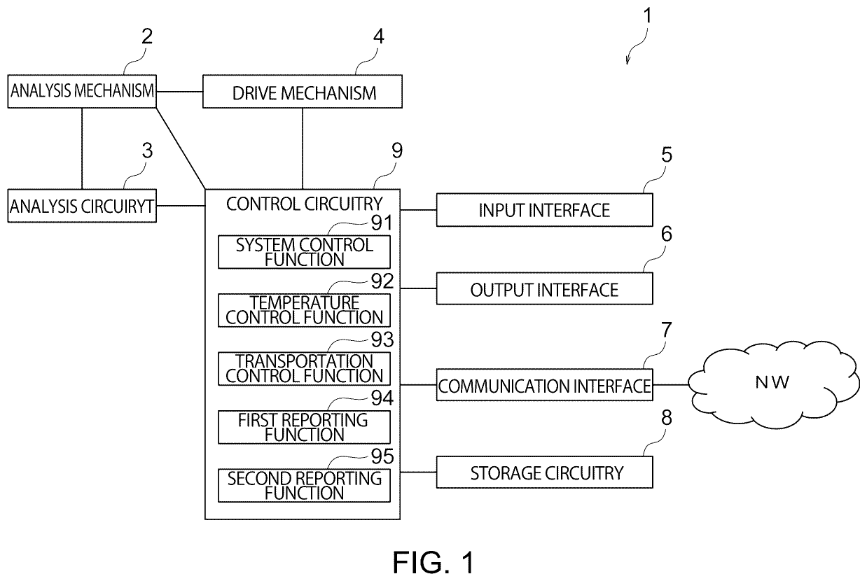

FIG. 1 is a block diagram illustrating an example of a functional configuration of an automatic analyzing apparatus according to a first embodiment. The automatic analyzing apparatus according to the present embodiment is, for example, an apparatus that measures components in a sample by measuring a mixture liquid of a sample to be measured and a reagent, a mixture liquid of a sample to be measured and a diluent, or the like. As illustrated in FIG. 1, an automatic analyzing apparatus 1 according to the present embodiment includes, for example, an analysis mechanism 2, an analysis circuitry 3, a drive mechanism 4, an input interface 5, an output interface 6, a communication interface 7, a storage circuitry 8, and a control circuitry 9.

The analysis mechanism 2 mixes a reagent used for each test item set in a sample such as a standard sample or a test sample with the sample. In addition, depending on the test item, the analysis mechanism 2 generates a mixture liquid obtained by mixing a diluent for diluting a sample with the sample. The analysis mechanism 2 measures a mixture liquid obtained by mixing a reagent with a sample, a mixture liquid of a sample and a diluent, or the like, and generates, for example, standard data and test data. In the present embodiment, the analysis mechanism 2 measures, for example, a sample, a mixture liquid of a sample and a reagent, or a mixture liquid of a sample and a diluent and generates standard data and test data associated with a potential. In the following description, when a standard sample and a test sample are expressed without distinction, the standard sample and the test sample may be simply referred to as “samples”.

The analysis circuitry 3 is a processor that generates calibration data, analysis data, and the like by analyzing the standard data and the test data generated by the analysis mechanism 2. The analysis circuitry 3 reads an analysis program from the storage circuitry 8 and generates calibration data, analysis data, and the like according to the read analysis program. For example, the analysis circuitry 3 generates, based on the standard data, calibration data indicating a relationship between the standard data and a standard value set in advance for the standard sample. In addition, the analysis circuitry 3 generates analysis data represented as a concentration value and an enzyme activity value based on the test data and the calibration data of the test item corresponding to the test data. Examples of the analysis data include data in which a concentration value is associated with an enzyme activity value, and data in which a concentration of a desired ion in a sample is recorded in time series. The analysis circuitry 3 outputs the generated calibration data, analysis data, and the like to the control circuitry 9.

The drive mechanism 4 drives the analysis mechanism 2 under control of the control circuitry 9. For example, the drive mechanism 4 is realized by a gear, a stepping motor, a belt conveyor, a lead screw, and the like. For example, the drive mechanism 4 rotates a transportation mechanism and the like described below at a predetermined angle.

The input interface 5 receives setting of an analysis parameter or the like of each test item related to a sample requested to be measured, for example, from a user or via an in-hospital network NW. The input interface 5 is realized by, for example, a mouse, a keyboard, a touch pad to which an instruction is input by touching an operation surface, and the like. The input interface 5 is connected to the control circuitry 9, converts an operation instruction input from the user into an electric signal, and outputs the electric signal to the control circuitry 9. Note that, in the present embodiment, the input interface 5 is not limited to an interface including physical operation components such as a mouse and a keyboard. For example, an electric signal processing circuitry that receives an electric signal corresponding to an operation instruction input from an external input device provided separately from the automatic analyzing apparatus 1 and outputs the electric signal to the control circuitry 9 is also included in the example of the input interface 5.

The output interface 6 is connected to the control circuitry 9 and outputs a signal supplied from the control circuitry 9. The output interface 6 is realized by, for example, a display circuitry, a print circuitry, an audio device, and the like. Examples of the display circuitry include a CRT display, a liquid crystal display, an organic EL display, an LED display, and a plasma display. Note that the display circuitry also includes a processing circuitry that converts data representing a display target into a video signal and outputs the video signal to the outside. The print circuitry includes, for example, a printer. Note that an output circuitry that outputs data representing the printing target to the outside is also included in the print circuitry. The audio device includes, for example, a speaker. Note that an output circuitry that outputs an audio signal to the outside is also included in the audio device.

The communication interface 7 is connected to, for example, the in-hospital network NW and connects the automatic analyzing apparatus 1 to the in-hospital network NW. The communication interface 7 performs data communication with a hospital information system (HIS) via the in-hospital network NW. Note that the communication interface 7 may perform data communication with the HIS via a laboratory information system (LIS) connected to the in-hospital network NW.

The storage circuitry 8 is configured with a recording medium readable by a processor such as a magnetic or optical recording medium, a semiconductor memory, or the like. Note that the storage circuitry 8 is not necessarily realized by a single storage device. For example, the storage circuitry 8 can be realized by a plurality of storage devices.

In addition, the storage circuitry 8 stores an analysis program executed by the analysis circuitry 3 and a control program executed by the control circuitry 9. The storage circuitry 8 stores the analysis data generated by the analysis circuitry 3 for each test item.

The control circuitry 9 is a processor that functions as a center of the automatic analyzing apparatus 1. The control circuitry 9 is an example of a processing circuitry. For example, the control circuitry 9 outputs a control signal for driving each unit of the analysis mechanism 2 to the drive mechanism 4. In addition, the control circuitry 9 realizes a function corresponding to an operation program stored in the storage circuitry 8 by executing the operation program. Note that the control circuitry 9 may include a storage area that stores at least a part of the data stored in the storage circuitry 8.

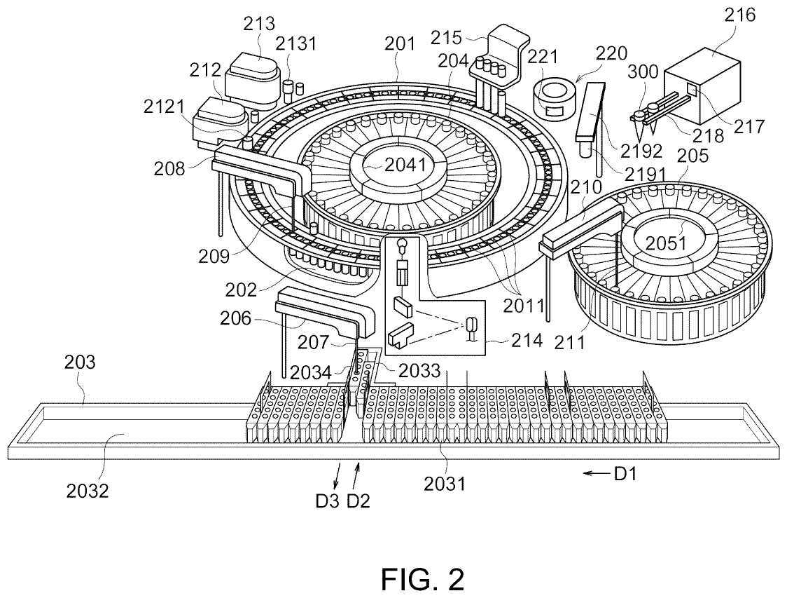

FIG. 2 is a diagram illustrating an example of a configuration of the analysis mechanism 2 according to the first embodiment. As illustrated in FIG. 2, the analysis mechanism 2 according to the present embodiment includes, for example, a reaction disk 201, a thermostatic unit 202, a rack sampler 203, a first reagent storage 204, a second reagent storage 205, a sample dispensing arm 206, a sample dispensing probe 207, a first reagent dispensing arm 208, a first reagent dispensing probe 209, a second reagent dispensing arm 210, a second reagent dispensing probe 211, a first stirring unit 212, a second stirring unit 213, a photometric unit 214, a cleaning unit 215, a storage container 216, a first detector 217, a supplier 218, a transportation mechanism 219, a disposal container 220, and a second detector 221.

The reaction disk 201 holds a plurality of reaction cuvettes 2011 arranged in a ring shape. The reaction disk 201 transports the plurality of reaction cuvettes 2011 along a predetermined path. Specifically, during the analysis operation of a mixture liquid of a sample and a reagent or a mixture liquid of a sample and a diluent, the reaction disk 201 alternately repeats rotation and stopping at predetermined time intervals by the drive mechanism 4. The reaction cuvette 2011 is formed of, for example, glass, polypropylene (PP), or acryl.

The thermostatic unit 202 stores a heating medium set at a predetermined temperature. The thermostatic unit 202 immerses the reaction cuvette 2011 in the stored heating medium to raise the temperature of a reaction solution accommodated in the reaction cuvette 2011 to a predetermined temperature and keep the temperature.

The rack sampler 203 movably supports sample racks 2031 capable of holding a plurality of sample cuvettes accommodating samples requested to be measured. A specimen such as blood requested to be measured is accommodated in the plurality of sample cuvettes. In the example illustrated in FIG. 2, the sample racks 2031 each capable of holding five sample cuvettes in parallel are illustrated.

The rack sampler 203 is provided with a transportation area 2032 for transporting the sample rack 2031. That is, the sample rack 2031 is transported from an insertion position where the sample rack 2031 is inserted to a collection position where the sample rack 2031 for which measurement is completed is collected by using the transportation area 2032. In the transportation area 2032, the plurality of sample racks 2031 aligned in a longitudinal direction are moved in a direction D1 by the drive mechanism 4.

Also, to move the sample cuvette held by the sample rack 2031 to a predetermined sample aspiration position, the rack sampler 203 is provided with an attraction area 2033 for attracting the sample rack 2031 from the transportation area 2032. The sample aspiration position is provided, for example, at a position where a moving track of the sample dispensing probe 207 in an up-down direction and a moving track of the opening of the sample cuvette supported by the rack sampler 203 and held by the sample rack 2031 intersect. In the attraction area 2033, the transported sample racks 2031 are moved in a direction D2 by the drive mechanism 4.

In addition, the rack sampler 203 is provided with a returning area 2034 for returning the sample rack 2031 holding the sample cuvette from which the sample is aspirated to the transportation area 2032. In the returning area 2034, the sample rack 2031 is moved in a direction D3 by the drive mechanism 4.

The first reagent storage 204 refrigerates a plurality of reagent cuvettes that accommodate a first reagent that reacts with a predetermined component included in a standard sample and a test sample. The first reagent is, for example, a buffer solution including bovine serum albumin (BSA) or the like. A reagent label is attached to the reagent cuvette. An optical mark representing reagent information is printed on the reagent label. As the optical mark, for example, an arbitrary pixel code such as a one-dimensional pixel code and a two-dimensional pixel code is used. The reagent information is information on the reagent accommodated in the reagent cuvette and includes, for example, a reagent name, a reagent manufacturer code, a reagent item code, a bottle type, a bottle size, a volume, a production lot number, and a valid period.

Also, the first reagent storage 204 refrigerates a plurality of standard sample cuvettes accommodating standard samples. Each of the plurality of standard sample cuvettes accommodates a standard sample of the same component having different concentration. Note that the standard sample cuvette may be held by the sample rack 2031. Also, the first reagent storage 204 refrigerates one or a plurality of diluent cuvettes accommodating diluents.

In the first reagent storage 204, a reagent rack 2041 is rotatably provided. The reagent rack 2041 holds a plurality of reagent cuvettes, and a plurality of standard sample cuvettes and diluent cuvettes to be arranged in an annular shape. The reagent rack 2041 is rotated by the drive mechanism 4. Also, in the first reagent storage 204, a reader (not illustrated) that reads the reagent information from the reagent label attached to the reagent cuvette is provided. The read reagent information is stored in the storage circuitry 8.

The second reagent storage 205 refrigerates a plurality of reagent cuvettes accommodating a second reagent paired with the first reagent of a two reagent system. The second reagent is a solution including an insoluble carrier, for example, a carrier particle, on which a predetermined antigen or antibody included in the sample and an antigen or antibody bound or separated by a specific antigen-antibody reaction are immobilized. The antigen or antibody bound or separated by a specific reaction may be an enzyme, a substrate, an aptamer, or a receptor. In the second reagent storage 205, a reagent rack 2051 is rotatably provided.

The reagent rack 2051 holds a plurality of reagent cuvettes to be arranged in an annular shape. Note that, in the second reagent storage 205, a standard sample cuvette accommodating a standard sample may be refrigerated. The reagent rack 2051 is rotated by the drive mechanism 4. Also, in the second reagent storage 205, a reader (not illustrated) that reads the reagent information from the reagent label attached to the reagent cuvette is provided. The read reagent information is stored in the storage circuitry 8.

A second reagent aspiration position is set at a predetermined position on the second reagent storage 205. The second reagent aspiration position is provided, for example, at a position where the rotating track of the second reagent dispensing probe 211 and the moving track of the openings of the reagent cuvettes annularly arranged in the reagent rack 2051 intersect.

The sample dispensing arm 206 is provided between the reaction disk 201 and the rack sampler 203. The sample dispensing arm 206 is provided to be movable up and down in a vertical direction and to be rotatable in a horizontal direction by the drive mechanism 4. The sample dispensing arm 206 holds the sample dispensing probe 207 at one end.

The sample dispensing probe 207 rotates along an arc-shaped rotating track according to the rotation of the sample dispensing arm 206. A dispensing position is provided on the rotating track. In addition, a sample discharge position for discharging the sample aspirated by the sample dispensing probe 207 to the reaction cuvette 2011 is provided on the rotating track of the sample dispensing probe 207. The sample discharge position is provided at a position where the rotating track of the sample dispensing probe 207 and the moving track of the reaction cuvette 2011 held by the reaction disk 201 intersect.

The sample dispensing probe 207 is driven by the drive mechanism 4 and moves in the up-down direction at the dispensing position or the sample discharge position. In addition, the sample dispensing probe 207 aspirates the sample from the sample cuvette at the dispensing position according to the control of the control circuitry 9. The sample dispensing probe 207 discharges the aspirated sample to the reaction cuvette 2011 positioned immediately below the sample discharge position according to the control of the control circuitry 9.

The first reagent dispensing arm 208 is provided in the vicinity of the outer periphery of the first reagent storage 204. The first reagent dispensing arm 208 is provided to be movable up and down in the vertical direction and to be rotatable in the horizontal direction by the drive mechanism 4. The first reagent dispensing arm 208 holds the first reagent dispensing probe 209 at one end.

The first reagent dispensing probe 209 rotates along an arc-shaped rotating track according to the rotation of the first reagent dispensing arm 208. A first reagent aspiration position where the first reagent dispensing probe 209 aspirates the first reagent, the standard sample, or the diluent is provided on the rotating track. The first reagent aspiration position is provided, for example, at a position where the rotating track of the first reagent dispensing probe 209 and the moving track of the openings of the reagent cuvettes, the standard sample cuvettes, or the diluent cuvettes annularly arranged in the reagent rack 2051 intersect. In addition, a first reagent discharge position for discharging the first reagent, the standard sample, or the diluent aspirated by the first reagent dispensing probe 209 to the reaction cuvette 2011 is set on the rotating track of the first reagent dispensing probe 209. The first reagent discharge position is provided at a position where the rotating track of the first reagent dispensing probe 209 and the moving track of the reaction cuvette 2011 held by the reaction disk 201 intersect.

The second reagent dispensing arm 210 is provided in the vicinity of the outer periphery of the first reagent storage 204. The second reagent dispensing arm 210 is provided to be movable up and down in the vertical direction and to be rotatable in the horizontal direction by the drive mechanism 4. The second reagent dispensing arm 210 holds the second reagent dispensing probe 211 at one end.

The second reagent dispensing probe 211 rotates along an arc-shaped rotating track according to the rotation of the second reagent dispensing arm 210. The second reagent aspiration position described above is provided on the rotating track. In addition, a second reagent discharge position for discharging the second reagent aspirated by the second reagent dispensing probe 211 to the reaction cuvette 2011 is set on the rotating track of the second reagent dispensing probe 211. The second reagent discharge position is provided at a position where the rotating track of the second reagent dispensing probe 211 and the moving track of the reaction cuvette 2011 held by the reaction disk 201 intersect.

The first stirring unit 212 is provided in the vicinity of the outer periphery of the reaction disk 201. The first stirring unit 212 includes a first stirring arm 2121 and also includes a first stirring bar provided at the distal end of the first stirring arm 2121. The first stirring unit 212 stirs the reaction solution of the standard sample and the first reagent accommodated in the reaction cuvette 2011 positioned at a first stirring position on the reaction disk 201 by the first stirring bar. Also, the first stirring unit 212 stirs the reaction solution of the test sample and the first reagent accommodated in the reaction cuvette 2011 positioned at the first stirring position on the reaction disk 201 by the first stirring bar. Note that the first stirring unit 212 may stir the reaction solution of the test sample and the diluent accommodated in the reaction cuvette 2011 positioned at the first stirring position on the reaction disk 201.

The second stirring unit 213 is provided in the vicinity of the outer periphery of the reaction disk 201. The second stirring unit 213 includes a second stirring arm 2131 and also includes a second stirring bar provided at the distal end of the second stirring arm 2131. The second stirring unit 213 stirs the reaction solution of the standard sample, the first reagent, and the second reagent accommodated in the reaction cuvette 2011 positioned at a second stirring position on the reaction disk 201 by the second stirring bar. Also, the second stirring unit 213 stirs the reaction solution of the test sample, the first reagent, and the second reagent accommodated in the reaction cuvette 2011 positioned at the second stirring position by the second stirring bar.

The photometric unit 214 optically measures the reaction solution of the sample, the first reagent, and the second reagent discharged into the reaction cuvette 2011. The photometric unit 214 includes a light source 2141 and a photodetector 2142. The photometric unit 214 emits light from the light source under the control of the control circuitry 9. The irradiated light is incident from a first side wall of the reaction cuvette 2011 and emitted from a second side wall facing the first side wall. The photometric unit 214 detects the light emitted from the reaction cuvette 2011 by the photodetector 2142. The photometric unit 214 corresponds to a photometric unit in the present embodiment. In addition, the photodetector 2142 corresponds to a light detection unit in the present embodiment.

Specifically, for example, the photodetector 2142 is disposed at a position on the optical axis of the light emitted from the light source 2141 to the reaction cuvette 2011. The photodetector 2142 detects light that passes through the reaction solution of the standard sample, the first reagent, and the second reagent in the reaction cuvette 2011. The automatic analyzing apparatus 1 acquires photometric data represented by the intensity of light detected by the photodetector 2142. Then, the automatic analyzing apparatus 1 generates standard data represented by an absorbance based on measurement data acquired from the photometric data at a predetermined timing. Also, the photodetector 2142 detects light that passes through the reaction solution of the test sample, the first reagent, and the second reagent in the reaction cuvette 2011. The automatic analyzing apparatus 1 acquires photometric data represented by the intensity of light detected by the photodetector 2142. Then, the automatic analyzing apparatus 1 generates test data represented by an absorbance based on measurement data acquired from the photometric data at a predetermined timing. The photometric unit 214 outputs the generated standard data and test data to the analysis circuitry 3.

The cleaning unit 215 cleans the inside of the reaction cuvette 2011 for which the measurement of the reaction solution by the photometric unit 214 is ended.

The storage container 216 stores a measuring chip 300. The storage container 216 according to the present embodiment stores a plurality of measuring chips 300.

The measuring chip 300 is a chip for measuring an electrolyte item. The measuring chip 300 stored in the storage container 216 is a disposable chip. The measuring chip 300 is transported by being attached to the transportation mechanism 219. The measuring chip 300 and the automatic analyzing apparatus 1 that analyzes the sample by using the sample or the mixture liquid accommodated in the measuring chip 300 configure an automatic analyzing system according to the present embodiment.

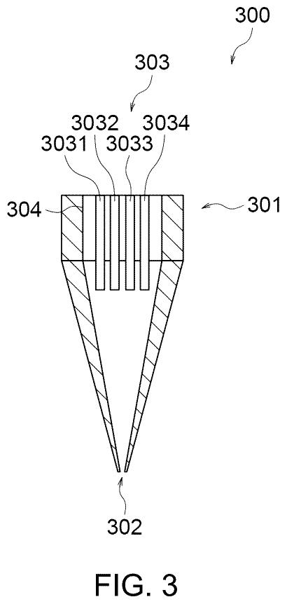

FIG. 3 is a diagram illustrating an example of a configuration of the measuring chip 300 according to the first embodiment. As illustrated in FIG. 3, the measuring chip 300 according to the present embodiment includes a chip body 301, an aspiration port 302, a plurality of terminals 303, and an attaching portion 304. The chip body 301 accommodates a sample, or a mixture liquid obtained by mixing a sample with a reagent to react with the sample or a diluent for diluting the sample. The aspiration port 302 is an opening provided in the chip body 301 for aspirating the sample or the mixture liquid.

The plurality of terminals 303 are provided in the chip body 301 and measure the concentration of the target substance in the sample or the mixture liquid aspirated from the aspiration port 302. Here, the target substance is an electrolyte such as a sodium ion, a potassium ion, or a chlorine ion. Note that the electrolyte may be a magnesium ion, an iron ion, a zinc ion, or the like.

The plurality of terminals 303 according to the present embodiment are provided on the chip body 301 so that an axial direction of each of the plurality of terminals 303 is perpendicular to a radial direction of the aspiration port 302. Further, the plurality of terminals 303 according to the present embodiment are provided on the chip body 301 by being integrally formed with the chip body 301. In the example illustrated in FIG. 3, the plurality of terminals 303 are four terminals. Note that four terminals 303 according to the present embodiment are provided, but the number of the plurality of terminals 303 provided in the chip body 301 is not limited thereto. That is, the number of the plurality of terminals 303 is arbitrary, and the number of the plurality of terminals 303 provided in the chip body 301 may be two, three, five, or more.

Also, the plurality of terminals 303 include an ion selective electrode (hereinafter referred to as an ISE) that selectively detects an electrolyte included in the sample or the mixture liquid and a reference electrode that generates a constant potential. In the present embodiment, as illustrated in FIG. 3, each of the four terminals which are the plurality of terminals 303 is ISEs 3031 to 3033 and a reference electrode 3034.

The ISE 3031 has a sensitive membrane that selectively detects a sodium ion. The ISE 3031 generates a potential proportional to a logarithm of a concentration of sodium ions with respect to the reference electrode 3034 under the condition that the activity coefficient and the solution temperature of the sample or the mixture liquid aspirated from the aspiration port 302 are constant.

The ISE 3032 has a sensitive membrane that selectively detects a potassium ion. The ISE 3032 generates a potential proportional to a logarithm of a concentration of potassium ions with respect to the reference electrode 3034 under the condition that the activity coefficient and the solution temperature of the sample or the mixture liquid aspirated from the aspiration port 302 are constant.

The ISE 3033 has a sensitive membrane that selectively detects a chlorine ion. The ISE 3033 generates a potential proportional to a logarithm of a concentration of chlorine ions with respect to the reference electrode 3034 under the condition that the activity coefficient and the solution temperature of the sample or the mixture liquid aspirated from the aspiration port 302 are constant.

The reference electrode 3034 includes a solution junction portion that generates a constant potential.

Note that, although the ISEs 3031 to 3033 included in the plurality of terminals 303 according to the present embodiment selectively detect sodium ions, potassium ions, and chlorine ions, the substances selectively detected by the ISEs 3031 to 3033 are not limited to sodium ions, potassium ions, and chlorine ions. That is, substances selectively detected by the ISEs 3031 to 3033 are arbitrary, and for example, the ISEs 3031 to 3033 may selectively detect magnesium ions, iron ions, zinc ions, and the like. Furthermore, in the example illustrated in FIG. 3, the ISEs 3031 to 3033 and the reference electrodes 3034 are arranged in this order from the left, but the arrangement order of the ISEs 3031 to 3033 and the reference electrodes 3034 is arbitrary.

The attaching portion 304 is a portion for attaching the chip body 301 to the transportation mechanism 219 of the automatic analyzing apparatus 1. The attaching portion 304 according to the present embodiment is an opening for inserting a measuring chip attached portion of the transportation mechanism 219 of the automatic analyzing apparatus 1 described below in detail. The inner peripheral diameter of the attaching portion 304 according to the present embodiment is substantially equal to the outer peripheral diameter of the attached portion of the transportation mechanism 219. Therefore, the measuring chip 300 according to the present embodiment is attached to the transportation mechanism 219 of the automatic analyzing apparatus 1 by fitting the attaching portion 304 to the measuring chip attached portion of the transportation mechanism 219.

The first detector 217 detects the remaining amount of the measuring chips 300 stored in the storage container 216. The first detector 217 is provided in the storage container 216 or in the vicinity of the storage container 216. The first detector 217 is, for example, an optical sensor, a weight sensor, an optical camera, or the like. The detection result of the first detector 217 is output to the control circuitry 9.

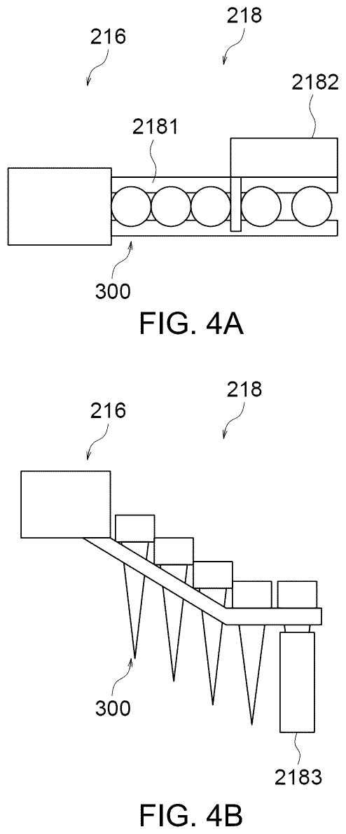

The supplier 218 supplies the measuring chip 300 stored in the storage container 216 at a supply position which is a position where the measuring chip 300 is supplied. The supplier 218 is configured with, for example, a belt, a slider, and a supply rail. The configuration of the supplier 218 is described in more detail with reference to FIGS. 4A and 4B. FIGS. 4A and 4B are diagrams illustrating an example of a configuration of the supplier 218 included in the analysis mechanism 2 according to the present embodiment. In the example illustrated in FIGS. 4A and 4B, the supplier 218 according to the present embodiment includes a supply rail 2181, a measuring chip feeding mechanism 2182, and a positioning mechanism 2183.

The supply rail 2181 discharges the measuring chip 300 stored in the storage container 216 to the outside and supplies the measuring chip to the supply position. In the example illustrated in FIGS. 4A and 4B, the supply rail 2181 is provided, for example, to be inclined toward the supply position. Therefore, the measuring chip 300 slides on the supply rail 2181 by gravity and moves toward the supply position. The supply position is, for example, a position where a rotating track which is a transportation path of the transportation mechanism 219 and a moving track of the measuring chip 300 on the supply rail 2181 intersect.

The measuring chip feeding mechanism 2182 is a mechanism that feeds the measuring chip 300 on the supply rail 2181 to the supply position under the control of the control circuitry 9. The measuring chip feeding mechanism 2182 is provided in the vicinity of the supply position.

The positioning mechanism 2183 is a mechanism that rotates the measuring chip 300 so that the plurality of terminals 303 of the measuring chip 300 are positioned at predetermined positions with respect to the transportation mechanism 219. Specifically, under the control of the control circuitry 9, the positioning mechanism 2183 rotates the measuring chip 300 supplied to the supply position so that the plurality of terminals 303 of the measuring chip 300 are positioned at positions corresponding to connectors of the transportation mechanism 219 described below. Also, the positioning mechanism 2183 is provided in the vicinity of the supply position. Note that the positioning mechanism 2183 may be retracted to a retracting position when positioning is not performed or may move from below or side of the measuring chip 300 when positioning is necessary.

Note that the supplier 218 according to the present embodiment includes the supply rail 2181, the measuring chip feeding mechanism 2182, and the positioning mechanism 2183 but may not include the measuring chip feeding mechanism 2182 and the positioning mechanism 2183. That is, the supplier 218 only needs to include at least the supply rail 2181.

The transportation mechanism 219 enables the attachment of the measuring chip 300 for measuring the concentration of the target substance in the sample or the mixture liquid and transports the measuring chip 300. The transportation mechanism 219 according to the present embodiment transports the measuring chip 300 supplied to the supply position to a reaction cuvette position described below under the control of the control circuitry 9. In addition, the transportation mechanism 219 according to the present embodiment transports the measuring chip 300 for which measurement is completed to a disposal position described below. The transportation mechanism 219 corresponds to a transporter in the present embodiment.

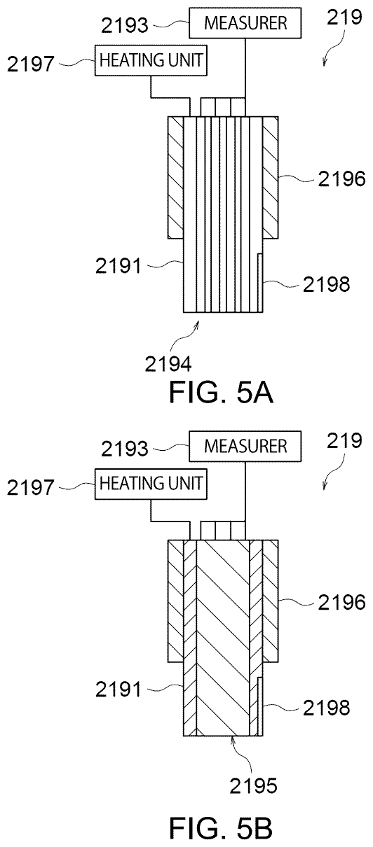

A configuration of the transportation mechanism 219 according to the present embodiment is described with reference to FIGS. 2, 5A, and 5B. FIGS. 5A and 5B are diagrams illustrating an example of a configuration of the transportation mechanism 219 according to the present embodiment. As illustrated in FIGS. 2, 5A, and 5B, the transportation mechanism 219 according to the present embodiment includes a measuring chip attached portion 2191, a transportation arm 2192, a measurer 2193, a connector 2194, an aspiration mechanism 2195, a measuring chip removing mechanism 2196, a heating unit 2197, and a temperature sensor 2198.

The measuring chip 300 is attached to the measuring chip attached portion 2191. The outer peripheral diameter of the measuring chip attached portion 2191 according to the present embodiment is substantially equal to the inner peripheral diameter of the attaching portion 304. Therefore, the measuring chip 300 is externally fitted to the measuring chip attached portion 2191 according to the present embodiment by inserting the measuring chip attached portion 2191 into the attaching portion 304 of the measuring chip 300. As a result, the measuring chip 300 is attached to the measuring chip attached portion 2191 according to the present embodiment.

The transportation arm 2192 is provided between the reaction disk 201 and the storage container 216. The transportation arm 2192 is provided to be movable up and down in the vertical direction and to be rotatable in the horizontal direction by the drive mechanism 4. Note that the transportation arm 2192 illustrated in FIG. 2 is configured with one transportation arm but the number of transportation arms 2192 is not limited thereto. That is, the number of the transportation arms 2192 is arbitrary. For example, the transportation arm 2192 may be configured with a plurality of (two or more) arms.

In addition, the transportation arm 2192 transports the measuring chip 300 attached to the measuring chip attached portion 2191 along a predetermined transportation path. Specifically, the transportation arm 2192 according to the present embodiment transports the measuring chip 300 from the supplier 218 to the disposal container 220 so that the measuring chip attached portion 2191 of the transportation mechanism 219 and the measuring chip 300 attached to the measuring chip attached portion 2191 pass through the transportation path. The transportation path of the measuring chip 300 attached to the measuring chip attached portion 2191 is formed, for example, on an arc-shaped rotating track accompanied by the rotation about one end of the transportation arm 2192. Note that the transportation path of the measuring chip 300 in the transportation mechanism 219 is arbitrary. For example, the transportation path of the measuring chip 300 in the transportation mechanism 219 may be formed on an elliptical track or may be a transportation path having no specific shape.

The measurer 2193 measures the potentials of the plurality of terminals 303 provided on the measuring chip 300 transported by the transportation mechanism 219. Specifically, the potential between the ISEs 3031 to 3033 and the reference electrode 3034 is measured for the sample or the mixture liquid. The measurer 2193 outputs data obtained by measuring the potential to the analysis circuitry 3 as standard data or test data. The measurer 2193 according to the present embodiment measures the potentials of the plurality of terminals 303 via the connector 2194 provided in the transportation mechanism 219. The measurer 2193 according to the present embodiment is provided, for example, in the transportation mechanism 219.

The connector 2194 is a connection terminal provided in the transportation mechanism 219 and electrically connected to the measurer 2193. Specifically, one end of the connector 2194 is electrically connected to the measurer 2193, and the other end of the connector 2194 can be connected to a plurality of terminals 303 provided on the measuring chip 300. The connector 2194 includes a plurality of connection terminals to measure the potential between the ISE and the reference electrode. The number of connection terminals included in the connector 2194 corresponds to the number of the plurality of terminals 303 of the measuring chip 300. The connector 2194 according to the present embodiment includes four connection terminals to be connected with the ISEs 3031 to 3033 and the reference electrode 3034.

The aspiration mechanism 2195 is a mechanism which is provided in the transportation mechanism 219 and aspirates the sample or the mixture liquid to the measuring chip 300 attached to the measuring chip attached portion 2191 of the transportation mechanism 219. The aspiration mechanism 2195 is, for example, a syringe pump including a cylinder including a hollow portion and a plunger communicating with the hollow portion, or a cylinder. In the example illustrated in FIG. 2, the aspiration mechanism 2195 is a syringe pump. The aspiration mechanism 2195 according to the present embodiment aspirates the sample or the mixture liquid by operating the plunger up and down in the hollow portion of the measuring chip attached portion 2191 as a cylinder. For example, a mechanism (not illustrated) that operates the hollow portion of the measuring chip attached portion 2191 up and down is connected to the plunger. Note that the configuration of the aspiration mechanism 2195 is not limited thereto. That is, the configuration of the aspiration mechanism 2195 is arbitrary, and for example, the aspiration mechanism 2195 may be configured by a tube in which a syringe pump or a vacuum pump is connected to one end, and the other end is attached to the distal end of the transportation mechanism 219. The aspiration mechanism 2195 corresponds to an aspirator in the present embodiment.

The measuring chip removing mechanism 2196 is a mechanism for removing the measuring chip 300 attached to the measuring chip attached portion 2191 from the measuring chip attached portion 2191. The measuring chip removing mechanism 2196 is connected to a mechanism (not illustrated) that operates the measuring chip removing mechanism 2196 up and down. Therefore, in the example illustrated in FIGS. 5A and 5B, the measuring chip removing mechanism 2196 can move up and down with respect to the measuring chip attached portion 2191.

The heating unit 2197 heats the sample or the mixture liquid accommodated in the measuring chip 300. The heating unit 2197 is controlled by the control circuitry 9 based on the measurement result of the temperature sensor 2198. In the example illustrated in FIG. 2, the heating unit 2197 is attached to the measuring chip attached portion 2191 and heats the sample or the mixture liquid of the measuring chip 300 attached to the measuring chip attached portion 2191 via the measuring chip attached portion 2191. In the present embodiment, the heating unit 2197 is, for example, a heater.

The temperature sensor 2198 is a sensor for measuring the temperature of the sample or the mixture liquid accommodated in the measuring chip 300. As illustrated in FIG. 2, the temperature sensor 2198 according to the present embodiment is attached to the distal end of the measuring chip attached portion 2191. The measurement result of the temperature sensor 2198 is output to the control circuitry 9.

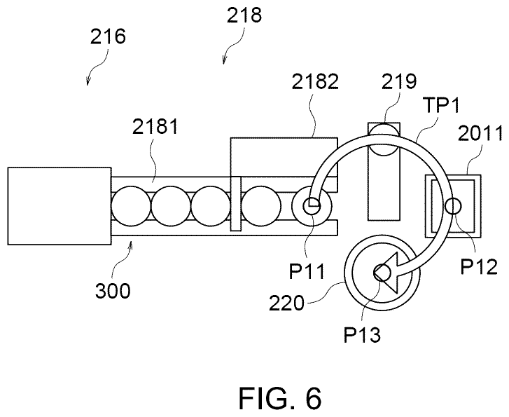

FIG. 6 is an explanatory view for explaining a transportation path of the measuring chip 300 and each position on the transportation path in the transportation mechanism 219 according to the embodiment. As illustrated in FIG. 6, at each position on a transportation path TP1 of the transportation mechanism 219 according to the present embodiment, a supply position P11, a reaction cuvette position P12, and a disposal position P13 are provided. Under the control of the control circuitry 9, the transportation mechanism 219 according to the present embodiment transports the measuring chip 300 to each position on the rotating track which is the transportation path TP1 in the order of the supply position P11, the reaction cuvette position P12, and the disposal position P13.

As described above, the supply position P11 is a position to which the measuring chip 300 is supplied. The supply position P11 according to the present embodiment is provided, for example, at a position where a rotating track which is the transportation path TP1 of the transportation mechanism 219 and a moving track of the measuring chip 300 on the supply rail 2181 intersect.

The reaction cuvette position P12 is a position where the sample or the mixture liquid accommodated in the reaction cuvette 2011 is aspirated to the measuring chip 300. The reaction cuvette position P12 according to the present embodiment is provided, for example, at a position where the rotating track which is the transportation path TP1 of the transportation mechanism 219 and a moving track of the reaction cuvette 2011 held on the reaction disk 201 intersect.

The disposal position P13 is a position where the measuring chip 300 is disposed of in the disposal container 220. The disposal position P13 according to the present embodiment is provided, for example, at a position where the rotating track which is the transportation path TP1 of the transportation mechanism 219 and a line segment extending upward from the center of the disposal container 220 intersect.

Referring back to FIG. 2, the measuring chip 300 for which measurement is completed is disposed of in the disposal container 220. In the present embodiment, the disposal container 220 includes a disposed measuring chip accommodating portion 2201. In the present embodiment, the measuring chip 300 for which measurement is completed and which is to be disposed of are accommodated in the disposed measuring chip accommodating portion 2201. The disposed measuring chip accommodating portion 2201 according to the present embodiment is provided immediately below the disposal position P13 so that the measuring chip 300 attached to the transportation mechanism 219 can be disposed of.

The second detector 221 detects the amount of the measuring chips 300 disposed of in the disposal container 220. Specifically, the second detector 221 detects the amount of the measuring chips 300 accommodated in the disposed measuring chip accommodating portion 2201. The second detector 221 is provided in the vicinity of the disposed measuring chip accommodating portion 2201 or in the disposed measuring chip accommodating portion 2201 in the disposal container. The second detector 221 is, for example, an optical sensor, a weight sensor, an optical camera, or the like. The detection result of the second detector 221 is output to the control circuitry 9.

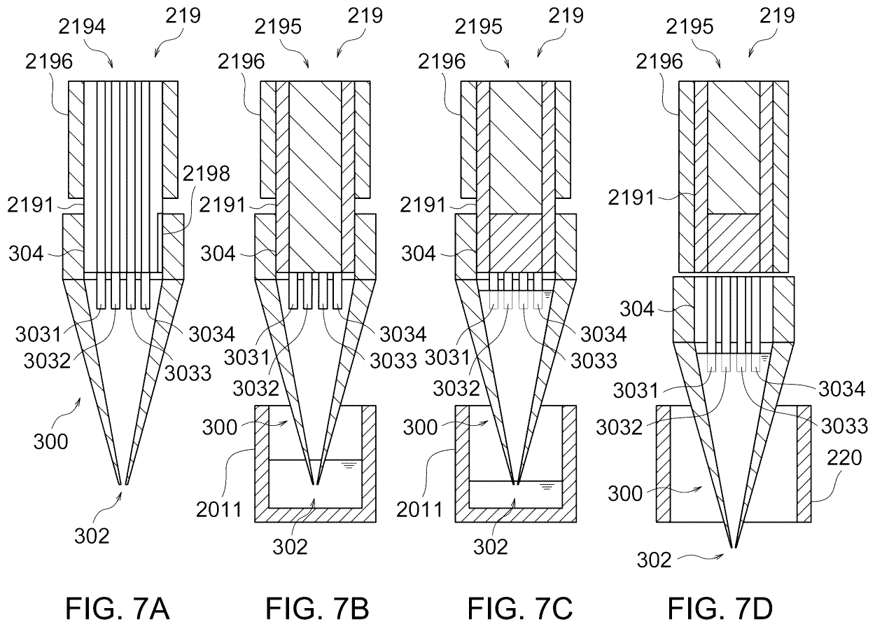

FIGS. 7A to 7D are explanatory views for explaining a series of flow from attachment of the measuring chip 300 to the transportation mechanism 219 to disposal of the measuring chip 300 in the analysis mechanism 2 according to the present embodiment. First, as illustrated in FIG. 7A, the measuring chip 300 is attached to the measuring chip attached portion 2191 of the transportation mechanism 219 at the supply position P11. When the measuring chip 300 is attached to the measuring chip attached portion 2191 of the transportation mechanism 219, the plurality of terminals 303 of the measuring chip 300 according to the present embodiment are connected to the connector 2194. Next, as illustrated in FIG. 7B, at the reaction cuvette position P12, the aspiration port 302 of the measuring chip 300 comes into contact with the sample or the mixture liquid accommodated in the reaction cuvette 2011. Then, the measuring chip 300 aspirates the sample or the mixture liquid from the aspiration port 302 by the aspiration mechanism 2195. Next, as illustrated in FIG. 7C, in the measuring chip 300, the sample or the mixture liquid aspirated from the aspiration port 302 comes into contact with the plurality of terminals 303. As a result, the measurer 2193 measures the potentials of the plurality of terminals 303 via the connector 2194 provided in the transportation mechanism 219. Then, as illustrated in FIG. 7D, at the disposal position P13, the measuring chip 300, for which the measurement by the measurer 2193 is completed, is removed by the measuring chip removing mechanism 2196 and is disposed of in the disposal container 220.

Referring back to FIG. 1, the control circuitry 9 illustrated in FIG. 1 executes the control program stored in the storage circuitry 8 and realizes a function corresponding to the program. For example, the control circuitry 9 has a system control function 91, a temperature control function 92, a transportation control function 93, a first reporting function 94, and a second reporting function 95 by executing the control program. Note that in the present embodiment, a case where the system control function 91, the system control function 91, the temperature control function 92, the transportation control function 93, the first reporting function 94, and the second reporting function 95 are realized by a single processor is described, but the present invention is not limited thereto. For example, the various functions may be realized by configuring a control circuitry by combining a plurality of independent processors and executing the control program by each processor.

Note that the system control function 91, the temperature control function 92, the transportation control function 93, the first reporting function 94, and the second reporting function 95 illustrated in FIG. 1 correspond to a system control unit, a temperature control unit, a transportation control unit, a first reporting unit, and a second reporting unit, respectively, in the present embodiment.

The system control function 91 is a function of integrally controlling each unit in the automatic analyzing apparatus 1 based on input information input from the input interface 5. For example, in the system control function 91, the control circuitry 9 controls the sample dispensing arm 206 or the first reagent dispensing arm 208 by controlling the drive mechanism 4 and the analysis mechanism 2, to dispense the sample, the reagent, or the diluent to the reaction cuvette 2011 or aspirate the sample or the mixture liquid to the measuring chip 300. In addition, the system control function 91 according to the present embodiment controls the measuring chip feeding mechanism 2182 or the positioning mechanism 2183. In addition, the system control function 91 controls the analysis circuitry 3 to perform analysis according to the test item.

The temperature control function 92 controls the temperature of at least one of the measuring chip 300, the sample accommodated in the measuring chip 300, and the mixture liquid accommodated in the measuring chip 300. The temperature control function 92 according to the present embodiment controls the temperature of the measuring chip 300 attached to the measuring chip attached portion 2191 by controlling the heating unit 2197 based on the measurement result of the temperature sensor 2198. As a result, the temperature control function 92 causes the temperature of the sample or the mixture liquid accommodated in the measuring chip 300 to be a predetermined temperature. Here, the predetermined temperature is, for example, 37° C. Note that the predetermined temperature is not limited to 37° C. That is, the predetermined temperature is arbitrary, and may be 37° C. or higher, or may be 37° C. or lower.

The transportation control function 93 controls the transportation mechanism 219 by controlling the drive mechanism 4. The transportation control function 93 according to the present embodiment controls up-down movement in the vertical direction and rotation in the horizontal direction of the transportation arm 2192 in the transportation mechanism 219. Specifically, the transportation control function 93 controls the transportation mechanism 219 to transport the measuring chip 300 to each position of the transportation path TP1.

Based on the detection result of the first detector 217, when the remaining amount of the measuring chips 300 stored in the storage container 216 is a predetermined remaining amount or less, the first reporting function 94 reports to the user. When the remaining amount of the measuring chips 300 stored in the storage container 216 is a predetermined remaining amount or less, the first reporting function 94 according to the present embodiment reports, to the user via the output interface 6 or the communication interface 7, that the remaining amount of the measuring chips 300 stored in the storage container 216 is the predetermined remaining amount or less.

Based on the detection result of the second detector 221, when the amount of the measuring chips 300 disposed of in the disposal container 220 is a predetermined amount or more, the second reporting function 95 reports to the user. Specifically, based on the detection result of the second detector 221, when the amount of the measuring chips 300 accommodated in the disposed measuring chip accommodating portion 2201 is a predetermined amount or more, the second reporting function 95 reports to the user. When the amount of the measuring chips 300 accommodated in the disposed measuring chip accommodating portion 2201 is a predetermined amount or more, the second reporting function 95 according to the present embodiment reports, to the user via the output interface 6 or the communication interface 7, that the amount of the measuring chips 300 accommodated in the disposed measuring chip accommodating portion 2201 is the predetermined amount or more.

Also, the analysis circuitry 3 illustrated in FIG. 1 executes the operation program stored in the storage circuitry 8 and realizes a function corresponding to the program. For example, the analysis circuitry 3 realizes a calibration data generating function 31 and an analysis data generating function 32 by executing the operation program. Note that in the present embodiment, a case where the calibration data generating function 31 and the analysis data generating function 32 are realized by a single processor is described, but the present invention is not limited thereto. For example, the calibration data generating function 31 and the analysis data generating function 32 may be realized by configuring an analysis circuitry by combining a plurality of independent processors and executing the operation program by each processor.

The calibration data generating function 31 is a function of generating calibration data based on the standard data generated by the analysis mechanism 2. Specifically, when receiving the standard data generated by the analysis mechanism 2, the analysis circuitry 3 executes the calibration data generating function 31. When the calibration data generating function 31 is executed, the analysis circuitry 3 generates a calibration curve based on standard data which is measurement data including absorbances related to standard samples having a plurality of different concentrations. The generated calibration curve is stored in the storage circuitry 8 as calibration data.

The analysis data generating function 32 is a function of generating analysis data by analyzing the test data generated by the analysis mechanism 2. Specifically, when receiving the test data generated by the analysis mechanism 2, the analysis circuitry 3 executes the analysis data generating function 32. When the analysis data generating function 32 is executed, the analysis circuitry 3 reads calibration data including information on the calibration curve from the storage circuitry 8. The analysis circuitry 3 generates analysis data including information on the concentration of the detection target of the test sample based on the test data and the calibration data.

When data of the potential measured by the measurer 2193 is acquired from the measurer 2193 as the test data, the analysis data generating function 32 according to the present embodiment calculates the concentration of the target substance in the sample or the mixture liquid accommodated in the measuring chip 300 based on the potential measured by the measurer 2193. Specifically, the analysis data generating function 32 calculates the concentration of the target substance in the sample or the mixture liquid accommodated in the measuring chip 300 as the analysis data based on the potential measured by the measurer 2193 and the calibration data. Then, the analysis data generating function 32 outputs the calculation result to the control circuitry 9. That is, it can be seen that the analysis data generating function 32 of the analysis circuitry 3 functions as a calculator when calculating the concentration of the target substance in the sample or the mixture liquid.

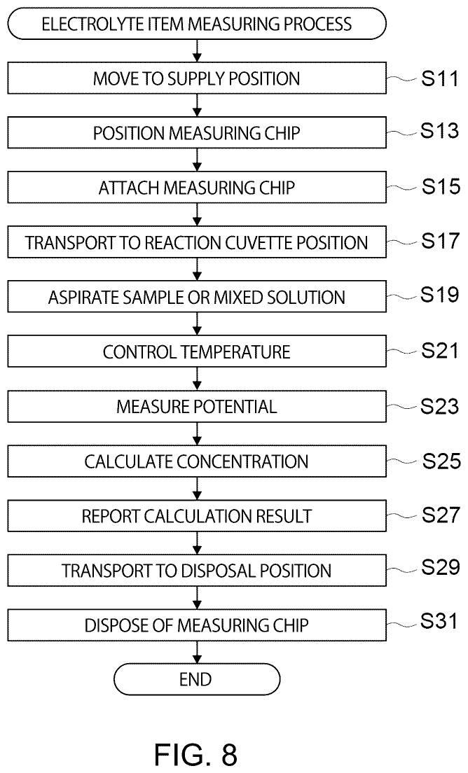

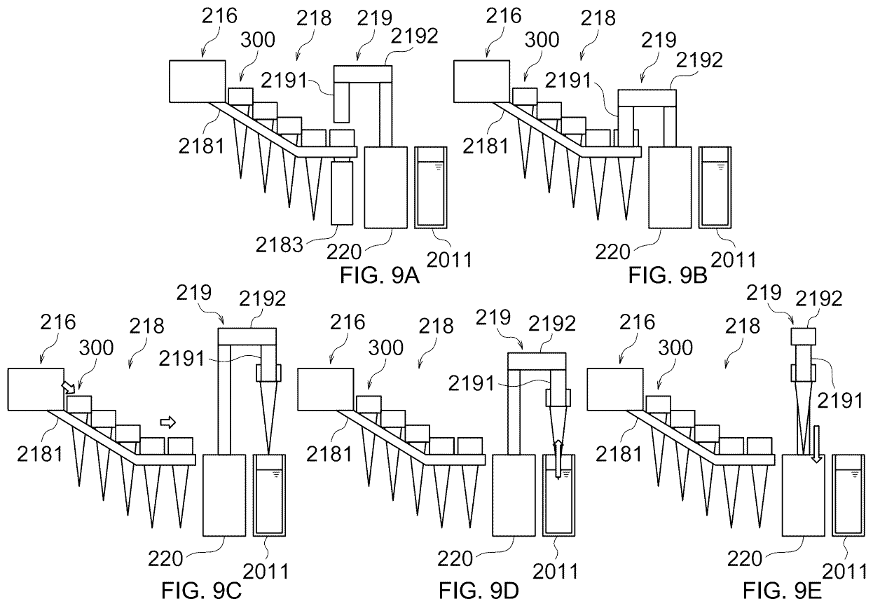

Next, an electrolyte item measuring process is described with reference to FIGS. 8 to 9E. FIG. 8 is a flowchart showing contents of the electrolyte item measuring process executed by the automatic analyzing apparatus 1 according to the present embodiment. FIGS. 9A to 9E are explanatory views for explaining an operation example of the transportation mechanism 219 in the electrolyte item measuring process according to the present embodiment. In the electrolyte item measuring process, the electrolyte item is measured by using the measuring chip 300 or the measuring chip 300 for which measurement is completed is disposed of. For example, the electrolyte item measuring process is a process executed at a timing when the measurement of the electrolyte item is started.

First, as shown in FIG. 8, in the electrolyte item measuring process executed by the automatic analyzing apparatus 1 according to the present embodiment, the automatic analyzing apparatus 1 moves the measuring chip attached portion 2191 of the transportation mechanism 219 to the supply position P11 (step S11). Specifically, the transportation control function 93 in the control circuitry 9 of the automatic analyzing apparatus 1 controls the drive mechanism 4 to move the measuring chip attached portion 2191 of the transportation mechanism 219 to the supply position P11.

Next, as illustrated in FIG. 8, the automatic analyzing apparatus 1 positions the measuring chip 300 (step S13). Specifically, as illustrated in FIG. 9A, the system control function 91 in the control circuitry 9 of the automatic analyzing apparatus 1 sets the positioning mechanism 2183 on the measuring chip 300 supplied to the supply position P11. Then, the system control function 91 controls the positioning mechanism 2183 so that the plurality of terminals 303 of the measuring chip 300 are at predetermined positions based on a photographed image of an optical camera (not illustrated) that photographs the measuring chip 300 supplied to the supply position P11.

Next, as illustrated in FIG. 8, the automatic analyzing apparatus 1 attaches the measuring chip 300 (step S15). Specifically, as illustrated in FIG. 9B, the transportation control function 93 in the control circuitry 9 of the automatic analyzing apparatus 1 controls the drive mechanism 4 to lower the measuring chip attached portion 2191 and attach the measuring chip attached portion 2191 to the attaching portion 304 of the measuring chip 300.

Next, as illustrated in FIG. 8, the automatic analyzing apparatus 1 transports the measuring chip 300 to the reaction cuvette position P12 (step S17). Specifically, as illustrated in FIG. 9C, the transportation control function 93 in the control circuitry 9 of the automatic analyzing apparatus 1 controls the drive mechanism 4 to transport the measuring chip 300 attached to the measuring chip attached portion 2191 to the reaction cuvette position P12.

Next, as illustrated in FIG. 8, the automatic analyzing apparatus 1 aspirates the sample or the mixture liquid (step S19). Specifically, as illustrated in FIG. 9D, the transportation control function 93 in the control circuitry 9 of the automatic analyzing apparatus 1 controls the drive mechanism 4 to lower the measuring chip 300. Then, the system control function 91 controls the aspiration mechanism 2195 to aspirate the sample or the mixture liquid to the measuring chip 300.

Next, as illustrated in FIG. 8, the automatic analyzing apparatus 1 controls the temperature (step S21). The temperature control function 92 in the control circuitry 9 of the automatic analyzing apparatus 1 controls the heating unit 2197 so that the temperature of the sample or the mixture liquid becomes a predetermined temperature based on the measurement result of the temperature sensor 2198. When the sample or the mixture liquid aspirated in step S19 is a predetermined temperature, the process of step S21 is omitted.

Next, as illustrated in FIG. 8, the automatic analyzing apparatus 1 measures the potential (step S23). Specifically, the system control function 91 in the control circuitry 9 of the automatic analyzing apparatus 1 causes the measurer 2193 to measure the potential of each of the plurality of terminals 303 of the measuring chip 300 via the connector 2194.

Next, as illustrated in FIG. 8, the automatic analyzing apparatus 1 calculates the concentration of the target substance (step S25). Specifically, the system control function 91 in the control circuitry 9 of the automatic analyzing apparatus 1 controls the analysis data generating function 32 in the analysis circuitry 3 to calculate the concentration of the target substance based on the potential measured in step S23. In the present embodiment, the analysis data generating function 32 calculates the concentrations of sodium ions, potassium ions, and chlorine ions based on the potential measured by the measurer 2193. Then, the analysis data generating function 32 outputs the calculation result to the control circuitry 9.

Next, as illustrated in FIG. 8, the automatic analyzing apparatus 1 outputs the calculation result (step S27). Specifically, the system control function 91 in the control circuitry 9 of the automatic analyzing apparatus 1 outputs the calculation result of the concentration of the target substance via the output interface 6 or the communication interface 7.

Next, as illustrated in FIG. 8, the automatic analyzing apparatus 1 transports the measuring chip 300 to the disposal position P13 (step S29). Specifically, as illustrated in FIG. 9E, the transportation control function 93 in the control circuitry 9 of the automatic analyzing apparatus 1 controls the drive mechanism 4 to transport the measuring chip 300 for which measurement is completed to the disposal position P13.

Next, as illustrated in FIG. 8, the automatic analyzing apparatus 1 disposes of the measuring chip 300 (step S31). Specifically, the transportation control function 93 in the control circuitry 9 of the automatic analyzing apparatus 1 disposes of the measuring chip 300 in the disposal container 220. More specifically, the transportation control function 93 controls the transportation arm 2192 at the disposal position P13 to lower the measuring chip attached portion 2191. Then, the transportation control function 93 controls the measuring chip removing mechanism 2196 to remove the measuring chip 300 from the measuring chip attached portion 2191, thereby disposing of the measuring chip 300 in the disposed measuring chip accommodating portion 2201. Note that, in step S31, the transportation control function 93 controls the transportation arm 2192 at the disposal position P13 to lower the measuring chip attached portion 2191, but the transportation control function 93 may not lower the measuring chip attached portion 2191. That is, the transportation control function 93 may control the measuring chip removing mechanism 2196 without lowering measuring chip attached portion 2191 at disposal position P13 to remove the measuring chip 300 from the measuring chip attached portion 2191, thereby disposing of the measuring chip 300 in the disposed measuring chip accommodating portion 2201.

By executing step S31, the electrolyte item measuring process according to the present embodiment is ended.

Note that in the electrolyte item measuring process according to the present embodiment described above, the automatic analyzing apparatus 1 calculates the concentration of the target substance in step S25 and outputs the calculation result in step S27, and then transports the measuring chip 300 to the disposal position P13 in step S29 and disposes of the measuring chip 300 in step S31, but the timing of performing the disposal operation of the measuring chip 300 in steps S29 and S31 is not limited thereto. That is, the timing of performing the disposal operation of the measuring chip 300 in steps S29 and S31 is arbitrary, and for example, the disposal operation of the measuring chip 300 in steps S29 and S31 may be performed after the potential is measured in step S23. Then, the calculation of the concentration of the target substance in step S25 and the output of the calculation result in step S27 may be performed in parallel with the disposal operation of the measuring chip 300 in steps S29 and S31 or may be performed after the disposal operation of the measuring chip 300 in steps S29 and S31 is completed.

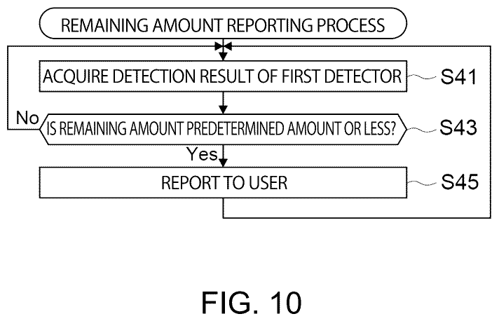

FIG. 10 is a flowchart showing contents of a remaining amount reporting process executed by the automatic analyzing apparatus 1 according to the present embodiment. In the remaining amount report process, when the remaining amount of the measuring chips 300 stored in the storage container 216 is the predetermined remaining amount or less, report to the user is performed. For example, the remaining amount reporting process is a process executed while the power of the automatic analyzing apparatus 1 is turned on.

As illustrated in FIG. 10, first, in the remaining amount reporting process executed by the automatic analyzing apparatus 1 according to the present embodiment, the automatic analyzing apparatus 1 acquires the detection result of the first detector 217 (step S41). Specifically, the first reporting function 94 in the control circuitry 9 of the automatic analyzing apparatus 1 acquires the detection result of the remaining amount of the measuring chips 300 stored in the storage container 216.

Next, as illustrated in FIG. 10, the automatic analyzing apparatus 1 determines whether the remaining amount is the predetermined amount or less (step S43). Specifically, the first reporting function 94 in the control circuitry 9 of the automatic analyzing apparatus 1 determines whether the remaining amount of the measuring chips 300 stored in the storage container 216 is the predetermined remaining amount or less based on the detection result of the first detector 217 in step S41.

Then, in step S43, when the remaining amount of the measuring chips 300 is not the predetermined remaining amount or less (step S43: No), the automatic analyzing apparatus 1 acquires the detection result of the first detector 217, repeats steps S41 and S43 until the remaining amount of the measuring chips 300 becomes the predetermined remaining amount or less, and stands by.

Meanwhile, in step S43, when the remaining amount of the measuring chips 300 is the predetermined remaining amount or less (step S43: Yes), the automatic analyzing apparatus 1 reports to the user (step S45). Specifically, the first reporting function 94 of the control circuitry 9 of the automatic analyzing apparatus 1 reports, to the user via the output interface 6 or the communication interface 7, that the remaining amount of the measuring chips 300 stored in the storage container 216 is the predetermined remaining amount or less. By executing step S45, the remaining amount reporting process according to the present embodiment is ended.

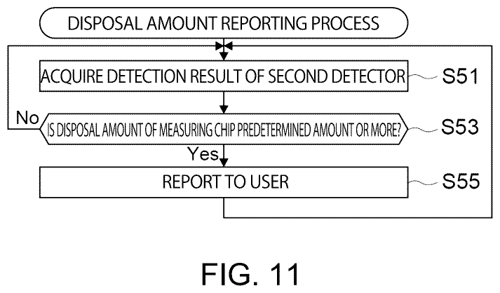

FIG. 11 is a flowchart showing contents of a disposal amount reporting process executed by the automatic analyzing apparatus 1 according to the present embodiment. In the disposal amount reporting process, when the amount of the measuring chips 300 disposed of in the disposal container 220 is the predetermined amount or more, report to the user is performed. For example, the disposal amount reporting process is a process executed while the power of the automatic analyzing apparatus 1 is turned on.

As illustrated in FIG. 11, first, in the disposal amount reporting process executed by the automatic analyzing apparatus 1 according to the present embodiment, the automatic analyzing apparatus 1 acquires the detection result of the second detector 221 (step S51). Specifically, the second reporting function 95 in the control circuitry 9 of the automatic analyzing apparatus 1 acquires the detection result of the amount of the measuring chips 300 disposed of in the disposal container 220.

Next, as illustrated in FIG. 11, the automatic analyzing apparatus 1 determines whether the disposal amount of the measuring chips 300 is the predetermined amount or more (step S53). Specifically, the second reporting function 95 in the control circuitry 9 of the automatic analyzing apparatus 1 determines whether the amount of the measuring chips 300 disposed of in the disposal container 220 is the predetermined amount or more based on the detection result of the second detector 221 in step S51.

Then, in step S53, when the disposal amount of the measuring chips 300 is not the predetermined amount or more (step S53: No), the automatic analyzing apparatus 1 acquires the detection result of the second detector 221, repeats steps S51 and S53 until the amount of the measuring chips 300 disposed of in the disposal container 220 becomes the predetermined amount or more, and stands by.

Meanwhile, in step S53, when the disposal amount of the measuring chips 300 is the predetermined amount or more (step S53: Yes), the automatic analyzing apparatus 1 reports to the user (step S55). Specifically, the second reporting function 95 in the control circuitry 9 of the automatic analyzing apparatus 1 reports, to the user, that the amount of the measuring chips 300 disposed of in the disposal container 220 is the predetermined amount or more. By executing step S55, the disposal amount reporting process according to the present embodiment is ended.

As described above, according to the automatic analyzing apparatus 1 according to the present embodiment, when the electrolyte item is measured, the disposable measuring chip 300 is transported by the transportation mechanism 219, the sample or the mixture liquid is aspirated into the measuring chip 300, the potential of the sample or the mixture liquid aspirated by the plurality of terminals 303 provided in the measuring chip 300 is measured, and the concentration of the target substance is calculated based on the measured potential, and thus cleaning of the transportation mechanism 219 every time the electrolyte item is measured is unnecessary. As a result, the throughput can be improved when the electrolyte item is measured.

In addition, in the automatic analyzing apparatus 1 according to the present embodiment, since the measurer 2193 measures the potentials of the plurality of terminals 303 while the sample or the mixture liquid is accommodated in the measuring chip 300, the sample or the mixture liquid does not come into contact with the transportation mechanism 219. As a result, the occurrence of carryover can be reduced.

Furthermore, in the automatic analyzing apparatus 1 according to the present embodiment, since the sample or the mixture liquid does not come into contact with the transportation mechanism 219, a cleaning unit for cleaning the transportation mechanism 219 becomes unnecessary. As a result, the automatic analyzing apparatus 1 can be miniaturized.

### Second Embodiment

In the measuring chip 300 according to the first embodiment described above, it is also possible to include a holder that holds a sample or a mixture liquid in the measuring chip 300. Hereinafter, portions different from those of the first embodiment described above are described using a case where the present modification is applied to the first embodiment described above as an example of a second embodiment.

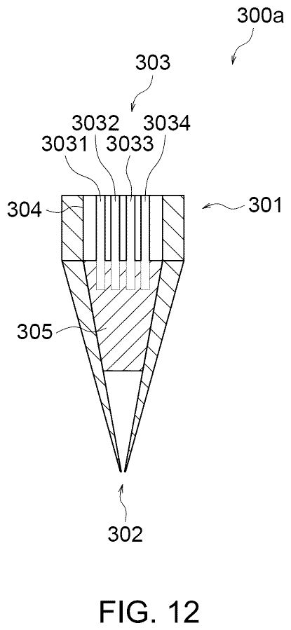

FIG. 12 is a diagram illustrating an example of a configuration of a measuring chip according to the second embodiment and is a diagram corresponding to FIG. 3 in the first embodiment described above. As illustrated in FIG. 12, a measuring chip 300a according to the present embodiment includes a holder 305 in addition to the chip body 301, the aspiration port 302, the plurality of terminals 303, and the attaching portion 304. Since the configurations other than the holder 305 are equivalent to those of the first embodiment described above, the description thereof is omitted. The measuring chip 300a according to the present embodiment and the automatic analyzing apparatus 1 that analyzes the sample by using the sample or the mixture liquid accommodated in the measuring chip 300a configure an automatic analyzing system according to the present embodiment.

The holder 305 is provided in the chip body 301 and holds the sample or the mixture liquid aspirated from the aspiration port 302. The holder 305 is made of, for example, a spongy body such as paper or sponge. Also, at least a part of the holder 305 is in contact with the plurality of terminals 303. Note that the material of the holder 305 is not limited to paper or sponge. That is, the material of the holder 305 is arbitrary, and any member may be used as long as the member can hold the sample or the mixture liquid.

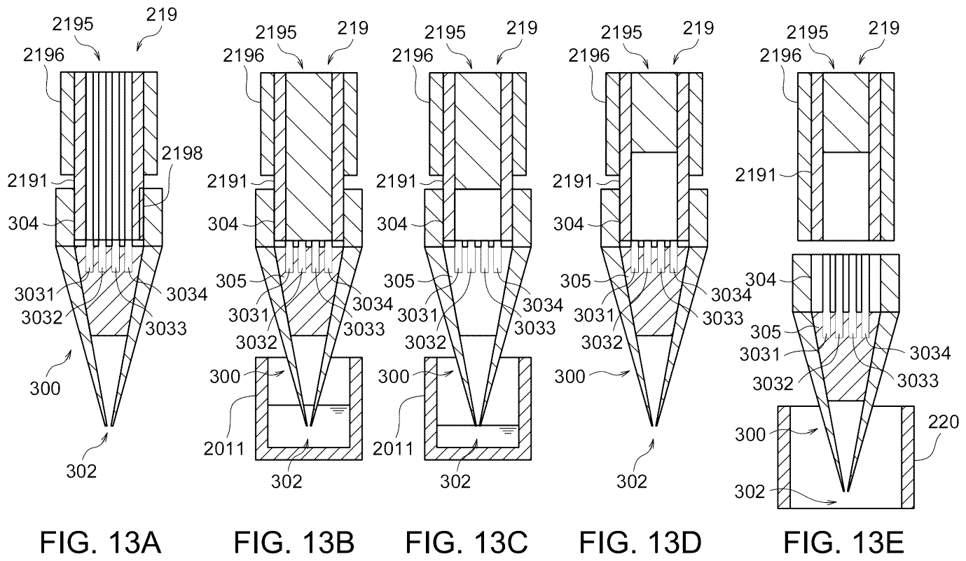

FIGS. 13A to 13E are explanatory views for explaining a series of flow from attachment of the measuring chip 300a to the transportation mechanism 219 to disposal of the measuring chip 300a in the analysis mechanism 2 according to the present embodiment and are diagrams corresponding to FIGS. 7A to 7D in the first embodiment described above. First, as illustrated in FIG. 13A, the measuring chip 300a is attached to the measuring chip attached portion 2191 of the transportation mechanism 219 at the supply position P11. When the measuring chip 300a is attached to the measuring chip attached portion 2191 of the transportation mechanism 219, the plurality of terminals 303 of the measuring chip 300a according to the present embodiment are connected to the connector 2194. Next, as illustrated in FIG. 13B, at the reaction cuvette position P12, the aspiration port 302 of the measuring chip 300a comes into contact with the sample or the mixture liquid accommodated in the reaction cuvette 2011. Then, the measuring chip 300a aspirates the sample or the mixture liquid from the aspiration port 302 by the aspiration mechanism 2195. Next, as illustrated in FIG. 13C, in the measuring chip 300a, the sample or the mixture liquid aspirated from the aspiration port 302 is held in the holder 305 of the measuring chip 300a. Next, as illustrated in FIG. 13D, in the measuring chip 300a, the sample or the mixture liquid held in the holder 305 comes into contact with the plurality of terminals 303. As a result, the measurer 2193 measures the potentials of the plurality of terminals 303 via the connector 2194 provided in the transportation mechanism 219. Then, as illustrated in FIG. 13E, at the disposal position P13, the measuring chip 300a, for which the measurement by the measurer 2193 is completed, is removed by the measuring chip removing mechanism 2196 and is disposed of in the disposal container 220.

As described above, according to the automatic analyzing apparatus 1 of the present embodiment, since the holder 305 is additionally provided in the measuring chip 300a, the likelihood that the sample or the mixture liquid leaks from the measuring chip 300a can be reduced.

In addition, according to the automatic analyzing apparatus 1 according to the present embodiment, since the holder 305 of the measuring chip 300a holds the sample or the mixture liquid, it is possible to reduce a risk of the disposal container 220 being contaminated by the sample or the mixture liquid and a risk of the user being infected when the user disposes of the measuring chip 300a accommodated in the disposal container 220.

Note that in the second embodiment described above, the holder 305 of the measuring chip 300a is provided at a position separated from the aspiration port 302, but the holder 305 may be provided in the vicinity of the aspiration port 302. As described above, by providing the holder 305 in the vicinity of the aspiration port 302, the automatic analyzing apparatus 1 can aspirate the sample or the mixture liquid by bringing the holder 305 into contact with the sample or the mixture liquid. Therefore, since the aspiration mechanism 2195 is unnecessary in the automatic analyzing apparatus 1, the automatic analyzing apparatus 1 can be miniaturized.

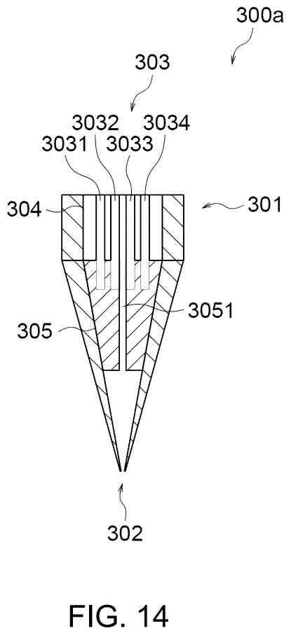

In addition, in the second embodiment described above, as illustrated in FIG. 14, a communication port 3051 may be provided in the holder 305 of the measuring chip 300. As such, by providing the communication port 3051, it is possible to facilitate aspiration of the sample or the mixture liquid by the aspiration mechanism 2195.

### Third Embodiment

In the measuring chip according to the first embodiment described above, the aspiration mechanism 2195 of the automatic analyzing apparatus 1 can become unnecessary by allowing the measuring chip itself to aspirate the sample or the mixture liquid. Hereinafter, portions different from those of the first embodiment described above are described using a case where the present modification is applied to the first embodiment described above as an example of a third embodiment.

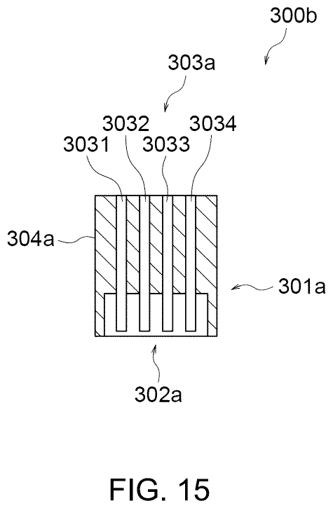

FIG. 15 is a diagram illustrating an example of a configuration of a measuring chip according to the third embodiment and is a diagram corresponding to FIG. 3 in the first embodiment described above. As illustrated in FIG. 15, a measuring chip 300b according to the present embodiment includes a chip body 301a, an aspiration port 302a, a plurality of terminals 303a, and an attaching portion 304a. The measuring chip 300b according to the present embodiment and the automatic analyzing apparatus 1 that analyzes the sample by using the sample or the mixture liquid accommodated in the measuring chip 300b configure an automatic analyzing system according to the present embodiment.

The chip body 301a accommodates a sample, or a mixture liquid obtained by mixing a sample with a reagent to react with the sample or a diluent for diluting the sample. In addition, the chip body 301a according to the present embodiment aspirates the sample or the mixture liquid through the aspiration port 302a by the capillary phenomenon. Then, the chip body 301a accommodates the sample or the mixture liquid aspirated by the capillary phenomenon.

The aspiration port 302a is an opening provided in the chip body 301a for aspirating the sample or the mixture liquid. A width and a diameter of the opening of the aspiration port 302a according to the present embodiment are determined so that the capillary phenomenon occurs.

The plurality of terminals 303a are provided on the chip body 301a so that an axial direction of the plurality of terminals 303a is perpendicular to a radial direction of the aspiration port 302a. The plurality of terminals 303a according to the present embodiment are provided inside the chip body 301a. Since the other configurations of the plurality of terminals 303a are equivalent to those of the plurality of terminals 303 according to the first embodiment described above, the description thereof is omitted.

The attaching portion 304a is a portion for attaching the chip body 301a to the transportation mechanism 219 of the analysis mechanism 2. The attaching portion 304a according to the present embodiment is specifically an outer wall of the chip body 301a to be inserted to the measuring chip attached portion related to the present embodiment described below. Therefore, the diameter of the outer periphery of the outer wall of the attaching portion 304a according to the present embodiment is substantially equal to the diameter of the inner periphery of the measuring chip attached portion according to the present embodiment. Therefore, the measuring chip 300b according to the present embodiment is attached to the transportation mechanism 219 of the automatic analyzing apparatus 1 by inserting and fitting the attaching portion 304a into the measuring chip attached portion.

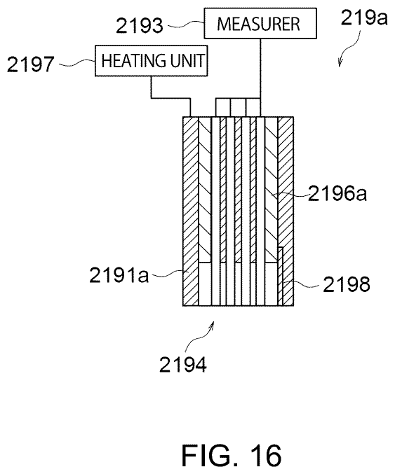

FIG. 16 is a diagram illustrating an example of a configuration of a transportation mechanism according to the third embodiment and is a diagram corresponding to FIGS. 5A and 5B in the first embodiment described above. As illustrated in FIG. 16, the measuring chip attached portion and the measuring chip removing mechanism of a transportation mechanism 219a according to the present embodiment is different from those of the first embodiment and thus are referred to as a measuring chip attached portion 2191a and a measuring chip removing mechanism 2196a in the present embodiment. In addition, in the transportation mechanism 219a according to the present embodiment, the measuring chip 300b aspirates the sample or the mixture liquid by the capillary phenomenon, and thus the aspiration mechanism 2195 is not provided. Note that since the configuration and function other than the measuring chip attached portion 2191a, the measuring chip removing mechanism 2196a, and the aspiration mechanism 2195 are equivalent to those in FIGS. 5A and 5B in the first embodiment described above, the description thereof is omitted.

The measuring chip 300b is attached to the measuring chip attached portion 2191a. Therefore, the inner diameter of the measuring chip attached portion according to the present embodiment is substantially equal to the outer diameter of the outer wall of the attaching portion 304a according to the present embodiment. The measuring chip 300b according to the present embodiment is externally fitted to the measuring chip attached portion 2191a by inserting the measuring chip attached portion 2191a into the attaching portion 304a of the measuring chip 300b. As a result, the measuring chip 300b is attached to the measuring chip attached portion 2191a according to the present embodiment.

The measuring chip removing mechanism 2196a is a mechanism for removing the measuring chip 300b attached to the measuring chip attached portion 2191a. The measuring chip removing mechanism 2196a according to the present embodiment is provided inside the measuring chip attached portion 2191a.

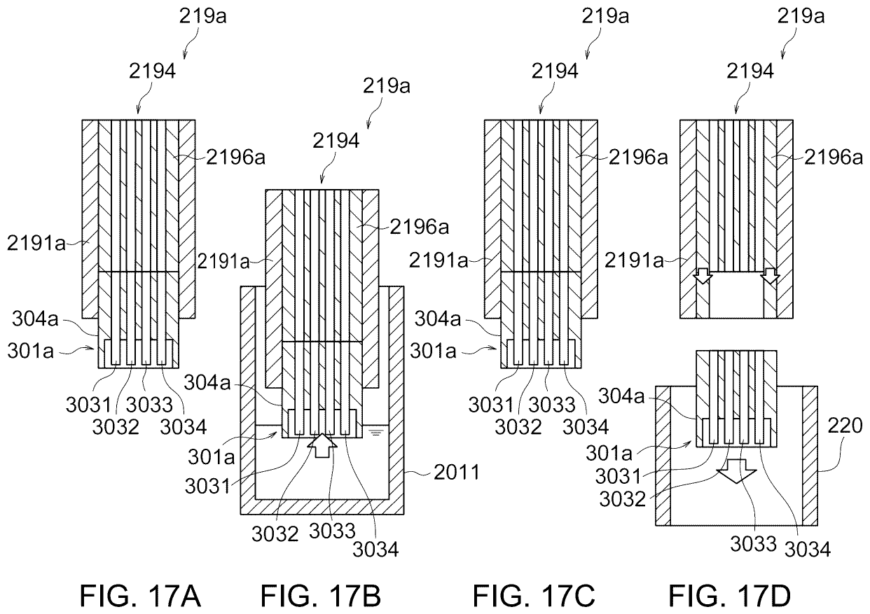

FIGS. 17A to 17D are diagrams illustrating a series of flow from attachment of the measuring chip 300b to the transportation mechanism 219 to disposal of the measuring chip 300b in the analysis mechanism 2 according to the third embodiment and are diagrams corresponding to FIGS. 7A to 7D in the first embodiment described above. First, as illustrated in FIG. 17A, the measuring chip 300b is attached to the measuring chip attached portion 2191a of the transportation mechanism 219a at the supply position P11. When the measuring chip 300b is attached to the measuring chip attached portion 2191a of the transportation mechanism 219a, the plurality of terminals 303a of the measuring chip 300b according to the present embodiment are connected to the connector 2194. Next, as illustrated in FIG. 17B, at the reaction cuvette position P12, the aspiration port 302a of the measuring chip 300b comes into contact with the sample or the mixture liquid accommodated in the reaction cuvette 2011. Here, the chip body 301a of the measuring chip 300b aspirates the sample or the mixture liquid through the aspiration port 302a by the capillary phenomenon. Next, as illustrated in FIG. 17C, in the measuring chip 300b, the sample or the mixture liquid aspirated from the aspiration port 302a comes into contact with the plurality of terminals 303a. As a result, the measurer 2193 measures the potentials of the plurality of terminals 303a via the connector 2194 provided in the transportation mechanism 219a. Then, as illustrated in FIG. 17D, at the disposal position P13, the measuring chip 300b, for which the measurement by the measurer 2193 is completed is removed by the measuring chip removing mechanism 2196a and is disposed of in the disposal container 220.

As described above, according to the automatic analyzing apparatus 1 of the present embodiment, since the measuring chip 300b can aspirate the sample or the mixture liquid by the capillary phenomenon, the aspiration mechanism 2195 of the transportation mechanism 219a becomes unnecessary. Therefore, the automatic analyzing apparatus 1 can be miniaturized.

[First Modification]

In the automatic analyzing apparatus 1 according to the second and third embodiments described above, the connector 2194 is provided in the transportation mechanism 219 to connect the plurality of terminals 303a and the measurer 2193, but the plurality of terminals and the measurer may be connected without providing the connector in the transportation mechanism 219. Hereinafter, portions different from those of the second embodiment described above are described using a case where the present modification is applied to the second embodiment described above as an example of a first modification.

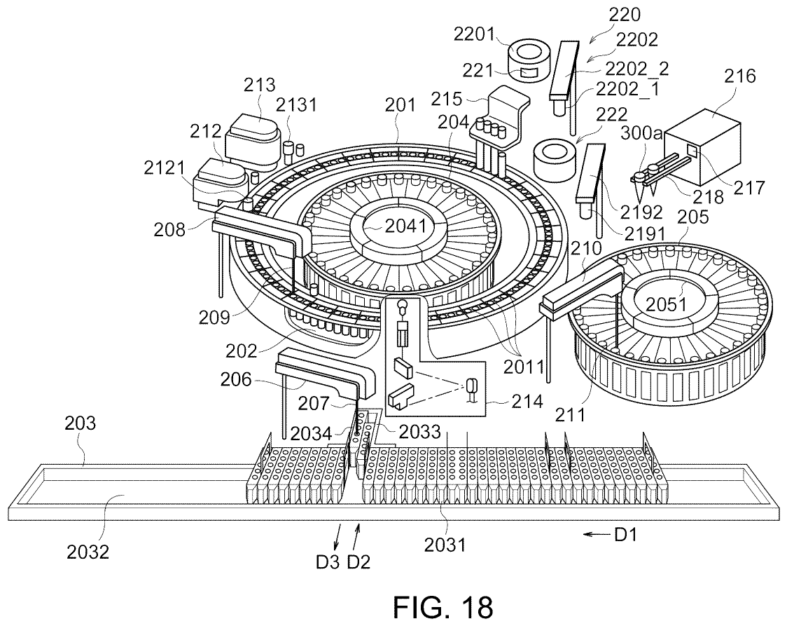

FIG. 18 is a diagram illustrating an example of a configuration of the analysis mechanism 2 according to the first modification and is a diagram corresponding to FIG. 2 illustrating the configuration of the analysis mechanism 2 of the first embodiment equivalent to the analysis mechanism 2 of the second embodiment described above. As illustrated in FIG. 18, the analysis mechanism 2 according to the first modification is configured by adding a placing base 222 to the analysis mechanism 2 according to the second embodiment described above. In addition, the transportation mechanism and the disposal container are different from those of the second embodiment and thus are referred to as a transportation mechanism 219b and a disposal container 220a in the present modification. Configurations and functions other than the placing base 222, the transportation mechanism 219b, and the disposal container 220a are equivalent to those in FIG. 2 in the analysis mechanism 2 of the first embodiment which is equivalent to the analysis mechanism 2 of the second embodiment described above, and thus the description thereof is omitted.

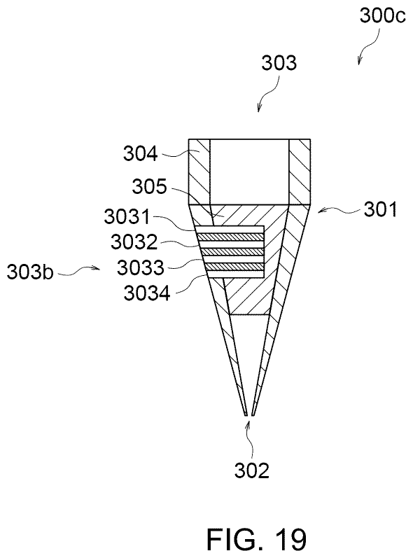

FIG. 19 is a diagram illustrating an example of a configuration of the measuring chip according to the present modification and is a diagram corresponding to FIG. 12 in the second embodiment described above. As illustrated in FIG. 19, the plurality of terminals of a measuring chip 300c according to the present first modification is different from those of the second embodiment and thus are referred to as a plurality of terminals 303b in the present modification. Since the other configurations and functions of the plurality of terminals 303b are equivalent to those in FIG. 12 according to the second embodiment described above, the description thereof is omitted. The measuring chip 300c according to the present modification and the automatic analyzing apparatus 1 that analyzes the sample by using the sample or the mixture liquid accommodated in the measuring chip 300c configure an automatic analyzing system according to the present modification.

The plurality of terminals 303b are provided in the chip body 301 and measure the target substance in the sample or the mixture liquid aspirated from the aspiration port 302. The plurality of terminals 303b according to the present modification are provided on the chip body 301 so that one end of each of the plurality of terminals 303b is exposed to the outside from the outer wall of the chip body 301, and an axial direction of each of the plurality of terminals 303b is parallel to the radial direction of the aspiration port 302. Also, the plurality of terminals 303b according to the present modification are provided so that each of the plurality of terminals 303b is in contact with the holder 305. Specifically, the plurality of terminals 303b is provided on the inner wall of the chip body 301. Since the other configurations of the plurality of terminals 303b are equivalent to the plurality of terminals 303 according to the first embodiment which are equivalent to the plurality of terminals according to the second embodiment described above, the description thereof is omitted.

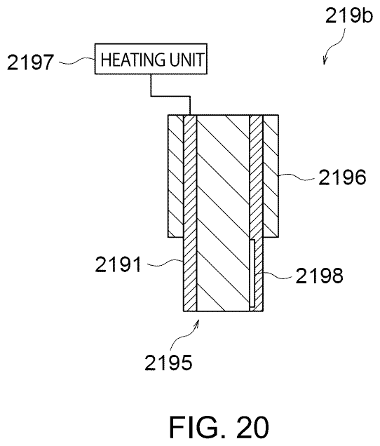

FIG. 20 is a diagram illustrating an example of a configuration of the transportation mechanism according to the present modification and is a diagram corresponding to FIGS. 5A and 5B illustrating the aspiration mechanism 2195 of the first embodiment equivalent to the aspiration mechanism 2195 of the second embodiment described above. As illustrated in FIG. 20, the transportation mechanism 219b according to the present modification is different from that of the second embodiment in that the measurer 2193 and the connector 2194 are not provided. Configurations and functions other than the measurer 2193 and the connector 2194 are equivalent to those in FIGS. 5A and 5B illustrating the aspiration mechanism of the first embodiment which is equivalent to the aspiration mechanism 2195 of the second embodiment described above, and thus the description thereof is omitted.

The transportation mechanism 219b according to the present modification transports the measuring chip 300c from the supplier 218 to the placing base 222 so that the measuring chip attached portion 2191 of the transportation mechanism 219b and the measuring chip 300c attached to the measuring chip attached portion 2191 pass through the transportation path. The transportation path of the measuring chip 300c attached to the measuring chip attached portion 2191 is formed, for example, on an arc-shaped rotating track accompanied by the rotation about one end of the transportation arm 2192. Note that the transportation path of the measuring chip 300c in the transportation mechanism 219b is arbitrary. For example, the transportation path of the measuring chip 300c in the transportation mechanism 219b may be formed on an elliptical track or may be a transportation path having no specific shape. The transportation mechanism 219b corresponds to a transporter in the present modification.

The measuring chip 300c for which measurement is completed is disposed of in the disposal container 220a. In the present modification, the disposal container 220a includes the disposed measuring chip accommodating portion 2201 and a disposed measuring chip transportation mechanism 2202. Since the configuration of the disposed measuring chip accommodating portion 2201 is equivalent to that of the disposed measuring chip accommodating portion 2201 of the first embodiment which is equivalent to the disposed measuring chip accommodating portion 2201 of the second embodiment described above, the description thereof is omitted.

The disposed measuring chip transportation mechanism 2202 transports the measuring chip 300c for which measurement is completed from the placing base 222 to the disposed measuring chip accommodating portion 2201. The disposed measuring chip transportation mechanism 2202 according to the present modification includes a disposed measuring chip attached portion 2202_1, a disposed measuring chip transportation arm 2202_2, and a disposed measuring chip removing mechanism 2202_3.

The measuring chip 300c for which measurement is completed is attached to the disposed measuring chip attached portion 2202_1. The disposed measuring chip transportation arm 2202_2 is provided to be movable up and down in the vertical direction and to be rotatable in the horizontal direction by the drive mechanism 4. The disposed measuring chip removing mechanism 2202_3 is a mechanism for removing the measuring chip 300c attached to the disposed measuring chip attached portion 2202_1. The disposed measuring chip removing mechanism 2202_3 is connected to a mechanism (not illustrated) that operates the disposed measuring chip removing mechanism 2202_3 up and down. In the example illustrated in FIG. 18, the disposed measuring chip removing mechanism 2202_3 is provided to be movable up and down with respect to the disposed measuring chip attached portion 2202_1.

Note that the configuration of the disposed measuring chip transportation mechanism 2202 is not limited to a case of including the disposed measuring chip attached portion 2202_1, the disposed measuring chip transportation arm 2202_2, and the disposed measuring chip removing mechanism 2202_3. That is, the configuration of the disposed measuring chip transportation mechanism 2202 is arbitrary, and may be a configuration, for example, in which the measuring chip 300c is gripped and transported from the placing base 222 to the disposed measuring chip accommodating portion 2201.

The placing base 222 is a base provided on the transportation path of the transportation mechanism 219b for placing the measuring chip 300c provided with a connector described below for connection to the plurality of terminals 303b of the measuring chip 300c.

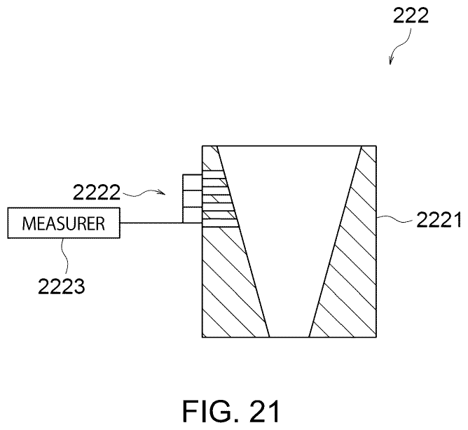

FIG. 21 is a diagram illustrating an example of a configuration of the placing base 222 included in the analysis mechanism 2 according to the present modification. As illustrated in FIG. 21, the placing base 222 includes a measuring chip mounting portion 2221, a connector 2222, and a measurer 2223. The measuring chip mounting portion 2221 mounts the measuring chip 300c transported by the transportation mechanism 219b.

The connector 2222 is a connection terminal provided in the placing base 222 and electrically connected to the measurer 2223. Specifically, one end of the connector 2222 is electrically connected to the measurer 2223, and the other end of the connector 2222 can be connected to the plurality of terminals 303b provided on the measuring chip 300c. The connector 2222 includes a plurality of connection terminals to measure the potential between the ISE and the reference electrode. The number of connection terminals included in the connector 2222 corresponds to the number of the plurality of terminals 303b of the measuring chip 300c. The connector 2222 according to the present modification includes four connection terminals to be connected with the ISEs 3031 to 3033 and the reference electrode 3034.

The measurer 2223 measures the potentials of the plurality of terminals 303b provided on the measuring chip 300c transported by the transportation mechanism 219b. The measurer 2223 according to the present modification measures the potentials of the plurality of terminals 303b via the connector 2222 provided in the placing base 222.

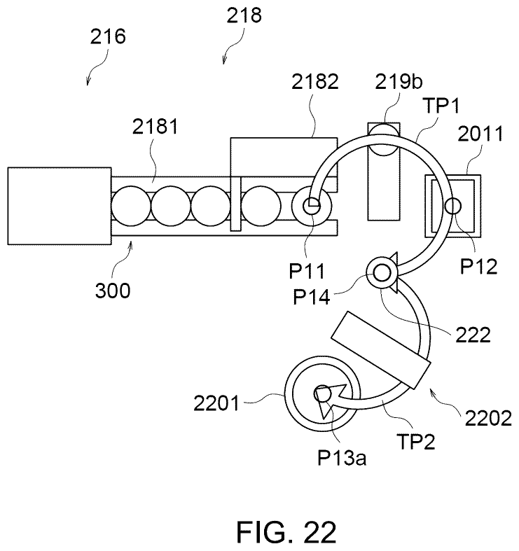

FIG. 22 is an explanatory diagram illustrating an example of the transportation path of the measuring chip 300c and each position on the transportation path in the transportation mechanism 219b and the disposed measuring chip transportation mechanism 2202 according to the present modification and is a diagram corresponding to FIG. 6 illustrating the transportation path of the first embodiment equivalent to the transportation path of the second embodiment described above. As illustrated in FIG. 22, each position on the transportation path according to the present modification is configured by adding a measuring chip placing position P14 to each position on the transportation path according to the first embodiment described above. In addition, since the disposal position is different from that of the first embodiment, the disposal position is referred to as a disposal position P13a in the present modification. In the present modification, since the configuration other than the disposal position P13a and the measuring chip placing position P14 is equivalent to that in FIG. 6 in the first embodiment described above, the description thereof is omitted.

The disposal position P13a is a position where the measuring chip 300c is disposed of. The disposal position P13a according to the present modification is provided, for example, at a position where a rotating track which is a transportation path TP2 of the disposed measuring chip transportation mechanism 2202 and a line segment extending upward from the center of the disposed measuring chip accommodating portion intersect. That is, the disposed measuring chip accommodating portion 2201 is provided immediately below the disposal position P13a.

The measuring chip placing position P14 is a position where the measuring chip 300c is placed in the placing base 222. The measuring chip placing position P14 according to the present modification is provided, for example, at a position where a rotating track which is a transportation path TP1a of the transportation mechanism 219b and the transportation path TP2 of the disposed measuring chip transportation mechanism 2202 intersect.

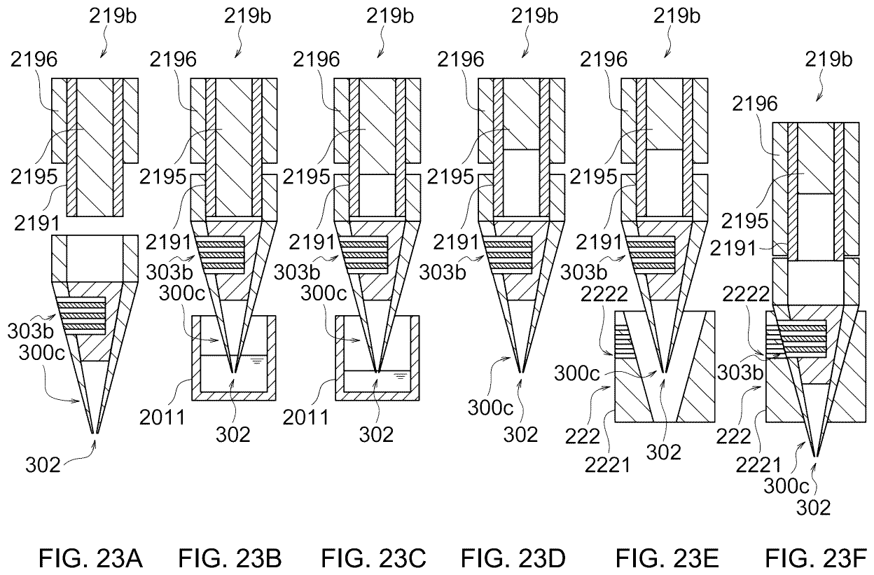

FIGS. 23A to 23F are explanatory views for explaining a series of flow from attachment of the measuring chip 300c to the transportation mechanism 219b to disposal of the measuring chip 300c in the analysis mechanism 2 according to the present modification and are diagrams corresponding to FIGS. 7A to 7D of the first embodiment which is equivalent to the second embodiment described above. First, as illustrated in FIG. 23A, the measuring chip 300c is attached to the measuring chip attached portion 2191 of the transportation mechanism 219b at the supply position P11. Next, as illustrated in FIG. 23B, at the reaction cuvette position P12, the aspiration port 302 of the measuring chip 300c comes into contact with the sample or the mixture liquid accommodated in the reaction cuvette 2011. Then, the measuring chip 300c aspirates the sample or the mixture liquid from the aspiration port 302 by the aspiration mechanism 2195. Next, as illustrated in FIG. 23C, in the measuring chip 300c, the sample or the mixture liquid aspirated from the aspiration port 302 is held in the holder 305 of the measuring chip 300c. Next, as illustrated in FIG. 23D, in the measuring chip 300c, the sample or the mixture liquid held in the holder 305 comes into contact with the plurality of terminals 303b. Next, as illustrated in FIG. 23E, the measuring chip 300c is transported to the measuring chip placing position P14. Then, as illustrated in FIG. 23F, at the measuring chip placing position P14, the measuring chip 300c is removed by the measuring chip removing mechanism 2196 and is placed in the placing base 222. As a result, since the plurality of terminals 303b of the measuring chip 300c are connected to the connector 2222, the measurer 2223 measures the potentials of the plurality of terminals 303b via the connector 2222 provided in the placing base 222. Then, the measuring chip 300a, for which the measurement by the measurer 2223 is completed, is transported to the disposal position P13a by the disposed measuring chip transportation mechanism 2202 and accommodated in the disposed measuring chip accommodating portion 2201.

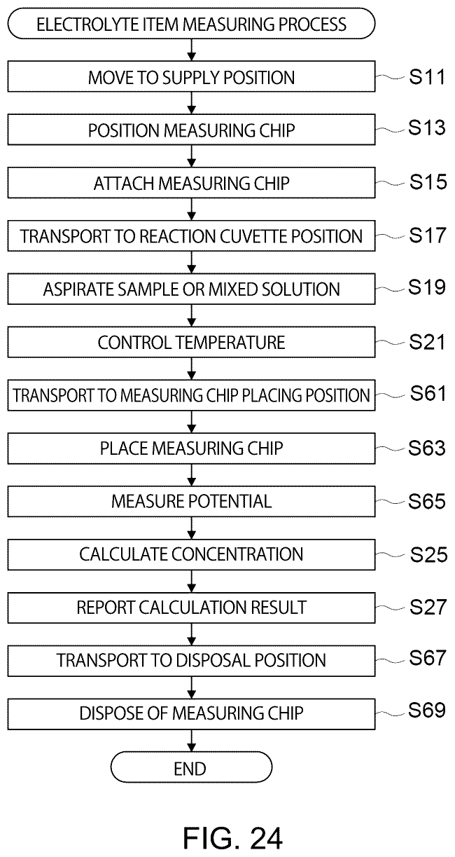

FIG. 24 is a flowchart showing contents of an electrolyte item measuring process executed by the automatic analyzing apparatus 1 according to the present modification and is a diagram corresponding to FIG. 8 according to the first embodiment equivalent to the second embodiment. In the electrolyte item measuring process, the electrolyte item is measured by using the measuring chip 300c or the measuring chip 300c for which measurement is completed is disposed of. For example, the electrolyte item measuring process is a process executed at a timing when the measurement of the electrolyte item is started. Since the processes to step S21 are equivalent to those in the first embodiment described above, the description thereof is omitted.

Next, as illustrated in FIG. 24, the automatic analyzing apparatus 1 transports the measuring chip 300c to the measuring chip placing position P14 (step S61). Specifically, the transportation control function 93 in the control circuitry 9 of the automatic analyzing apparatus 1 controls the drive mechanism 4 to transport the measuring chip 300c to the measuring chip placing position P14.

Next, as illustrated in FIG. 24, the automatic analyzing apparatus 1 places the measuring chip 300c (step S63). Specifically, the transportation control function 93 in the control circuitry 9 of the automatic analyzing apparatus 1 controls the drive mechanism 4 to place the measuring chip 300c in the placing base 222. More specifically, the transportation control function 93 lowers the transportation arm 2192 at the measuring chip placing position P14 to mount the measuring chip 300c in the placing base 222. Then, the transportation control function 93 controls the measuring chip removing mechanism 2196 to remove the measuring chip 300c from the measuring chip attached portion 2191.

Next, as illustrated in FIG. 24, the automatic analyzing apparatus 1 measures the potential (step S65). Specifically, the system control function 91 in the control circuitry 9 of the automatic analyzing apparatus 1 causes the measurer 2223 to measure the potential of each of the plurality of terminals 303b of the measuring chip 300c via the connector 2222. Note that the measurement of the potential in step S65 is not limited to the case of being performed at the timing when the measuring chip 300c is placed in the placing base 222. For example, the measurement of the potential in step S65 may be performed by placing the measuring chip 300c in the placing base 222 and then electrically connecting the connector 2222 provided in the placing base 222 and the plurality of terminals 303b at a predetermined timing. In addition, since the processes in steps S25 and S27 after step S65 are equivalent to that in FIG. 8 of the first embodiment described above, the description thereof is omitted.

Next, after step S25, as illustrated in FIG. 24, the automatic analyzing apparatus 1 transports the measuring chip 300c to the disposal position P13a (step S67). Specifically, the transportation control function 93 in the control circuitry 9 of the automatic analyzing apparatus 1 controls the disposed measuring chip transportation mechanism 2202 after the measurement is completed and transports the measuring chip 300c placed in the placing base 222 to the disposal position P13a.

Next, as illustrated in FIG. 24, the automatic analyzing apparatus 1 disposes of the measuring chip 300c (step S69). Specifically, the transportation control function 93 in the control circuitry 9 of the automatic analyzing apparatus 1 disposes of the measuring chip 300c in the disposal container 220a. More specifically, at the disposal position P13a, the transportation control function 93 controls the disposed measuring chip transportation mechanism 2202 and disposes of the measuring chip 300c in the disposed measuring chip accommodating portion 2201. By executing step S69, the electrolyte item measuring process according to the present modification is ended.

Note that in the electrolyte item measuring process according to the present modification described above, the automatic analyzing apparatus 1 calculates the concentration of the target substance in step S25 and outputs the calculation result in step S27, and then transports the measuring chip 300c to the disposal position P13a in step S67 and disposes of the measuring chip 300c in step S69, but the timing of performing the disposal operation of the measuring chip 300c in steps S67 and step S69 is not limited thereto. That is, the timing of performing the disposal operation of the measuring chip 300c in steps S67 and S69 is arbitrary, and for example, the disposal operation of the measuring chip 300c in steps S67 and S69 may be performed after the potential is measured in step S65. Then, the calculation of the concentration of the target substance in step S25 and the output of the calculation result in step S27 may be performed in parallel with the disposal operation of the measuring chip 300c in steps S67 and S69 or may be performed after the disposal operation of the measuring chip 300c in steps S67 and S69 is completed.

As described above, according to the automatic analyzing apparatus 1 of the present modification, since the transportation of the measuring chip 300c and the measurement of the sample or the mixture liquid can be performed by different mechanisms, the transportation mechanism 219b can transport the next measuring chip 300c without waiting for the completion of the measurement of the sample or the mixture liquid accommodated in the measuring chip 300c. As a result, the throughput can be improved in the measurement of the electrolyte item.

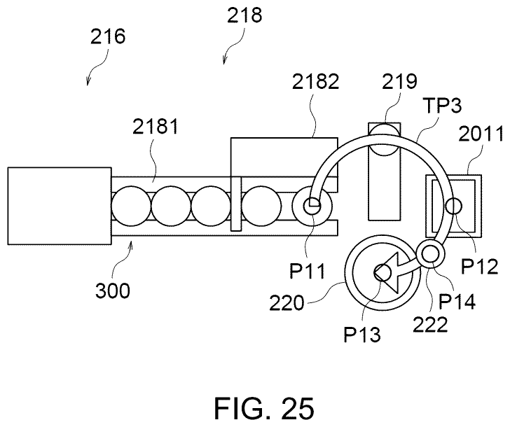

The first modification can also be applied to the third embodiment. Further, the first modification in which the potential is measured by using the placing base 222 may be applied to the first embodiment. When the first modification is applied to the first embodiment, it is necessary to place the measuring chip 300 in the placing base 222 without removing the measuring chip 300 from the measuring chip attached portion 2191, measure the potential, and transport the measuring chip 300 to the disposal container 220. Therefore, when the first modification is applied to the first embodiment, as illustrated in FIG. 25, by providing the measuring chip placing position P14 and the disposal position P13 on the transportation path of the transportation mechanism 219, the electrolyte item measuring process is performed so that the measuring chip 300 is placed in the placing base 222 without removing the measuring chip 300 from the measuring chip attached portion 2191, the potential is measured, and the measuring chip 300 for which measurement is completed is transported to the disposal position P13.

Note that, in the first modification described above, as in the second embodiment, the transportation mechanism 219 includes the heating unit 2197 and the temperature sensor 2198, and the heating unit 2197 is controlled based on the measurement result of the temperature sensor 2198 to control the temperature of the sample or the mixture liquid of the measuring chip 300c attached to the transportation mechanism 219, but the modification is not limited thereto. That is, the portion including the heating unit 2197 and the temperature sensor 2198 is arbitrary, and for example, the placing base 222 may include the heating unit and the temperature sensor, or the supplier 218 may include the heating unit and the temperature sensor. In addition, the sample or the mixture liquid in the predetermined temperature may be aspirated by causing the transportation mechanism 219 not to include the heating unit 2197 and the temperature sensor 2198 and causing the temperature control function 92 to control the temperature of the sample or the mixture liquid accommodated in the reaction cuvette 2011 by controlling the thermostatic unit 202.

[Second Modification]

In the automatic analyzing apparatus 1 according to the second and third embodiments described above, the measuring chip is transported by the transportation mechanism 219 including the transportation arm 2192, but the measuring chip can be transported by a transportation mechanism including a rotating table that enables the attachment of the measuring chip. Hereinafter, a case where the modification is applied to the second embodiment described above is described as an example of a second modification.

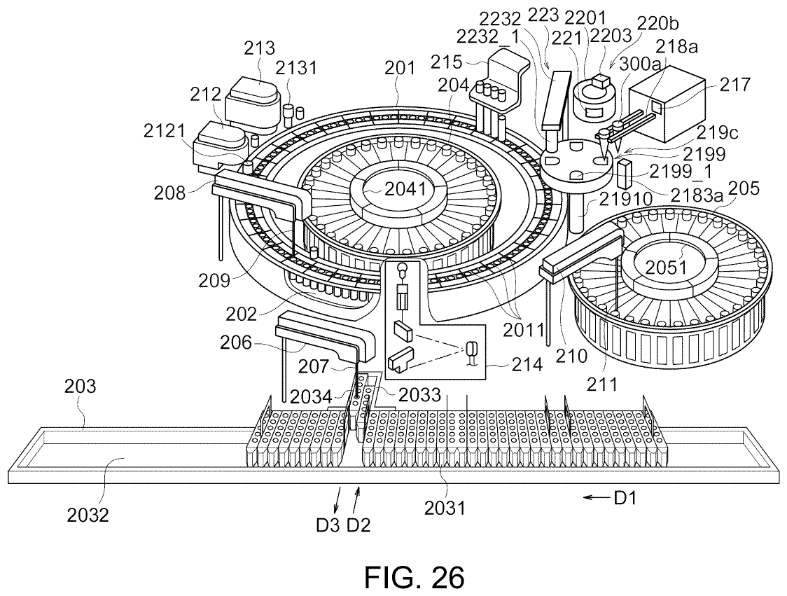

FIG. 26 is a diagram illustrating an example of a configuration of the analysis mechanism 2 according to the present modification and is a diagram corresponding to FIG. 2 illustrating the analysis mechanism of the first embodiment equivalent to the analysis mechanism of the second embodiment described above. As illustrated in FIG. 26, the analysis mechanism 2 according to the second modification is configured by adding an aspiration unit 223 to the analysis mechanism 2 according to the second embodiment described above. In addition, the supplier, the transportation mechanism, and the disposal container are different from those of the second embodiment and thus are referred to as a supplier 218a, transportation mechanism 219c, and a disposal container 220b in the present modification. Configurations and functions other than the supplier 218a, the transportation mechanism 219c, the disposal container 220b, and the aspiration unit 223 are equivalent to those in FIG. 2 in the analysis mechanism of the first embodiment which is equivalent to the analysis mechanism of the second embodiment, and thus the description thereof is omitted.

The supplier 218a supplies the measuring chip 300a stored in the storage container 216 at a supply position which is a position where the measuring chip 300a is supplied. The supplier 218a is configured with, for example, a belt, a slider, and a supply rail. The supplier 218a according to the present modification includes the supply rail 2181, the measuring chip feeding mechanism 2182, and a positioning mechanism 2183a. Note that the configurations of the supply rail 2181 and the measuring chip feeding mechanism 2182 are equivalent to the supply rail 2181 and the measuring chip feeding mechanism 2182 according to the first embodiment which are equivalent to the supply rail 2181 and the measuring chip feeding mechanism 2182 according to the second embodiment described above, and thus the description thereof is omitted.

The positioning mechanism 2183a is a mechanism that rotates the measuring chip 300a so that the plurality of terminals 303 of the measuring chip 300a are positioned at predetermined positions with respect to the aspiration unit 223. Specifically, under the control of the control circuitry 9, the positioning mechanism 2183a rotates the measuring chip 300a transported to the positioning position described below so that the plurality of terminals 303 of the measuring chip 300a are positioned at positions corresponding to the connectors of the aspiration unit 223 described below. Also, the positioning mechanism 2183a is provided in the vicinity of the positioning position. Note that the positioning mechanism 2183a may be retracted to the retracting position when positioning is not performed or may move from below or side of the measuring chip 300a when positioning is necessary.

The transportation mechanism 219c enables the attachment of the measuring chip 300a for measuring the sample or the mixture liquid and transports the measuring chip 300a. As illustrated in FIG. 26, the transportation mechanism 219c according to the present modification includes a rotating table 2199 and a supporter 21910. The transportation mechanism 219c corresponds to a transporter in the present modification.

The rotating table 2199 enables the attachment of the measuring chip 300a and rotates to transport the measuring chip 300a along the predetermined transportation path. As illustrated in FIG. 26, the rotating table 2199 according to the present modification is provided with a measuring chip attached hole 2199_1 to which the measuring chip 300a is to be attached. The outer wall of the measuring chip 300a is attached to the measuring chip attached hole 2199_1. That is, the attaching portion 304 of the measuring chip 300a according to the present modification is an outer wall of the chip body 301. In the example illustrated in FIG. 26, four measuring chip attached holes 2199_1 are provided, but the number of measuring chip attached holes 2199_1 is not limited thereto. That is, the number of the measuring chip attached holes 2199_1 is arbitrary.

The supporter 21910 supports the rotating table 2199. Specifically, the supporter 21910 supports the rotating table 2199 rotatably and movably up and down. Further, one end of the supporter 21910 is attached to the rotating table 2199, and the other end is connected to the drive mechanism 4.

The transportation mechanism 219c according to the present modification transports the measuring chip 300a from the supplier 218 to the disposal container 220b so that the measuring chip attached hole 2199_1 of the rotating table and the measuring chip 300a attached to the measuring chip attached hole 2199_1 pass through the transportation path. The transportation path of the measuring chip 300a attached to the measuring chip attached hole 2199_1 is formed on the rotating track accompanied by the rotation of the rotating table 2199 about the supporter 21910.

The measuring chip 300a for which measurement is completed is disposed of in the disposal container 220b. As illustrated in FIG. 2, in the present modification, the disposal container 220b includes the disposed measuring chip accommodating portion 2201 and a disposal guide 2203. Since the configuration of the disposed measuring chip accommodating portion 2201 is equivalent to that of the disposed measuring chip accommodating portion 2201 of the first embodiment which is equivalent to the disposed measuring chip accommodating portion 2201 of the second embodiment described above, the description thereof is omitted.

The disposal guide 2203 is a guide member for removing the measuring chip 300a, which is transported to the disposal position P13, from the measuring chip attached hole 2199_1 and accommodating the measuring chip 300a to the disposed measuring chip accommodating portion 2201. The disposal guide 2203 is provided above the disposed measuring chip accommodating portion 2201.

The aspiration unit 223 is provided separately from the transportation mechanism 219c and aspirates the sample or the mixture liquid to the measuring chip 300a attached to the rotating table 2199. The aspiration unit 223 according to the present modification is provided in the vicinity of the transportation mechanism 219c and the reaction disk 201 and aspirates the sample or the mixture liquid to the measuring chip 300a transported to the reaction cuvette position P12. The aspiration unit 223 corresponds to an aspirator in the present modification.

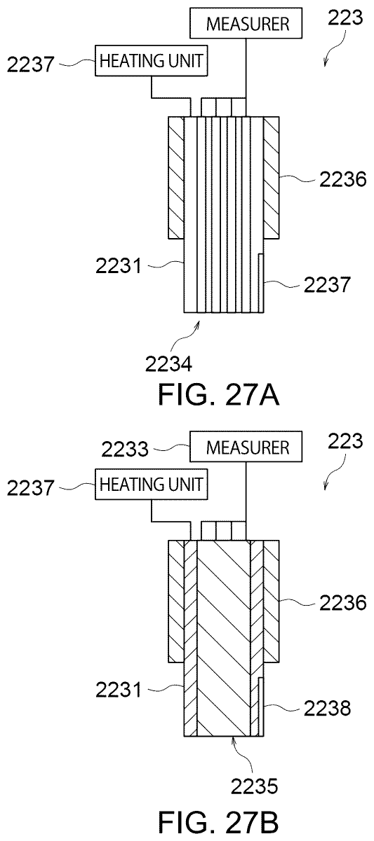

A configuration of the aspiration unit 223 according to the present modification is described with reference to FIGS. 26 to 27B. FIGS. 27A and 27B are diagrams illustrating an example of a configuration of the aspiration unit 223 according to the present modification. As illustrated in FIGS. 26 to 27B, the aspiration unit 223 includes a measuring chip attached portion 2231, an aspiration arm 2232, a measurer 2233, a connector 2234, a plunger 2235, a measuring chip removing mechanism 2236, a heating unit 2237, and a temperature sensor 2238.

The measuring chip attached portion 2231 is attached to the measuring chip 300a when the sample or the mixture liquid is aspirated into the measuring chip 300a. The measuring chip attached portion 2231 is provided at one end of the aspiration arm 2232. In addition, a hollow portion 2231_1 for attaching the plunger 2235 is provided inside the measuring chip attached portion 2231.

The aspiration arm 2232 is provided to be movable up and down in the vertical direction by the drive mechanism 4. Note that the aspiration arm 2232 illustrated in FIG. 26 is configured with one aspiration arm but the number of aspiration arms 2232 is not limited thereto. That is, the number of the aspiration arms 2232 is arbitrary. For example, the aspiration arm 2232 may be configured with a plurality of (two or more) arms.

The measurer 2233 measures the potentials of the plurality of terminals 303 provided on the measuring chip 300a transported by the transportation mechanism 219c. Specifically, the measurer 2233 measures the potential between the ISEs 3031 to 3033 and the reference electrode 3034 for the sample or the mixture liquid. The measurer 2233 outputs data obtained by measuring the potential to the analysis circuitry 3 as standard data or test data. The measurer 2233 according to the present modification measures the potentials of the plurality of terminals 303 via the connector 2234 provided in the aspiration unit 223. The measurer 2233 according to the present modification is provided, for example, in the aspiration unit 223.

The connector 2234 is a connection terminal provided in the aspiration unit 223 and electrically connected to the measurer 2233. Specifically, one end of the connector 2234 is electrically connected to the measurer 2233, and the other end of the connector 2234 can be connected to a plurality of terminals 303 provided on the measuring chip 300a. The connector 2234 includes a plurality of connection terminals to measure the potential between the ISE and the reference electrode. The number of connection terminals included in the connector 2234 corresponds to the number of the plurality of terminals 303 of the measuring chip 300a. The connector 2234 according to the present modification includes four connection terminals to be connected with the ISEs 3031 to 3033 and the reference electrode 3034.

The plunger 2235 is attached to the hollow portion 2231_1 of the measuring chip attached portion 2231. The plunger 2235 operates up and down in the hollow portion 2231_1, so that the sample or the mixture liquid can be aspirated to the measuring chip 300a.

The measuring chip removing mechanism 2236 is a mechanism for removing the measuring chip 300a attached to the measuring chip attached portion 2231. In the example illustrated in FIGS. 27A and 27B, the measuring chip removing mechanism 2236 is connected to a mechanism (not illustrated) that operates the measuring chip removing mechanism 2236 up and down. Therefore, in the example illustrated in FIGS. 27A and 27B, the measuring chip removing mechanism 2236 can move up and down with respect to the measuring chip attached portion 2231.

The heating unit 2237 heats the sample or the mixture liquid accommodated in the measuring chip 300a. The heating unit 2237 is controlled by the control circuitry 9 based on the measurement result of the temperature sensor 2238. In the example illustrated in FIGS. 27A and 27B, the heating unit 2237 is attached to the measuring chip attached portion 2231 and heats the sample or the mixture liquid of the measuring chip 300a attached to the measuring chip attached portion 2231 via the measuring chip attached portion 2231. In the present modification, the heating unit 2237 is, for example, a heater.

The temperature sensor 2238 is a sensor for measuring the temperature of the sample or the mixture liquid accommodated in the measuring chip 300a. In the example illustrated in FIGS. 27A and 27B, the temperature sensor 2238 is attached to the distal end of the measuring chip attached portion 2231. The measurement result of the temperature sensor 2238 is output to the control circuitry 9.

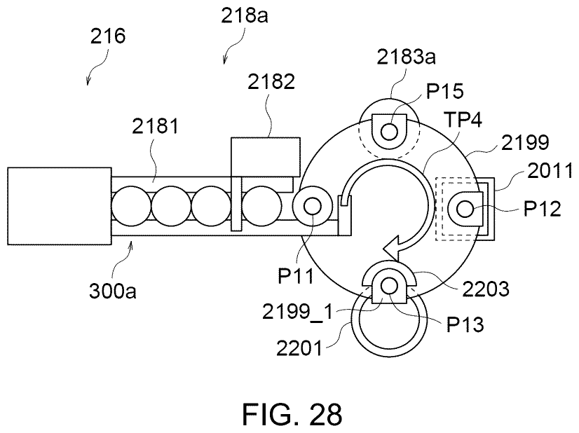

FIG. 28 is a diagram illustrating an example of a transportation path of the measuring chip 300a and each position on the transportation path in the transportation mechanism 219c according to the present modification and is a diagram corresponding to FIG. 6 illustrating the transportation path of the first embodiment equivalent to the transportation path of the second embodiment described above. As illustrated in FIG. 28, each position on a transportation path TP4 according to the present modification is configured by adding a positioning position P15 to each position on the transportation path according to the first embodiment described above. According to the present modification, configurations and functions other than the positioning position P15 are equivalent to those in FIG. 6 illustrating the transportation path of the first embodiment which is equivalent to the transportation path of the second embodiment described above, and thus the description thereof is omitted.

The positioning position P15 is a position where the measuring chip 300a is positioned by the positioning mechanism 2183a. The positioning position P15 according to the present modification is provided at a position where the rotating track of the transportation mechanism 219c and a line segment extending in the vertical direction from the center of the positioning mechanism 2183a intersect.

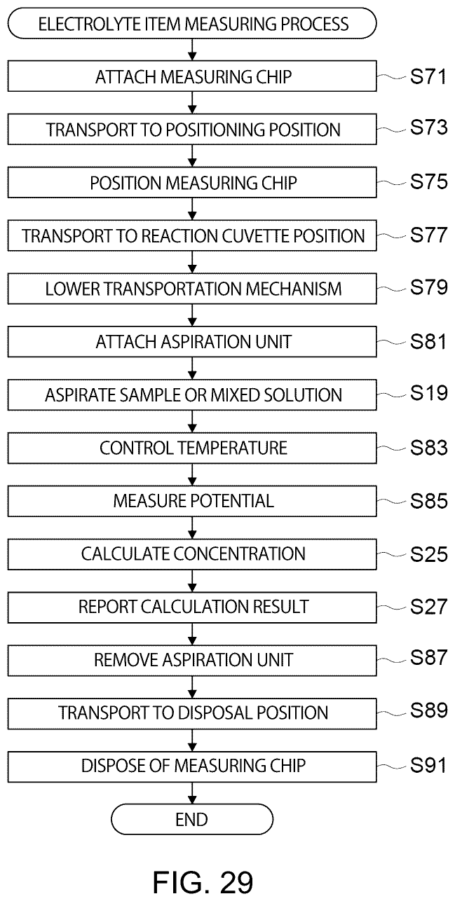

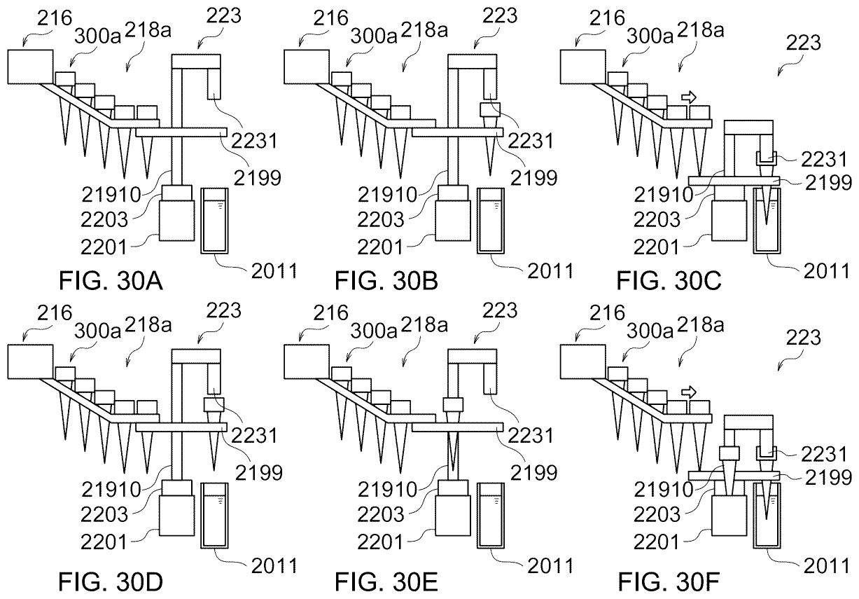

Next, an electrolyte item measuring process according to the present modification is described with reference to FIGS. 29 to 30F. FIG. 29 is a flowchart showing contents of an electrolyte item measuring process executed by the automatic analyzing apparatus 1 according to the present modification and is a diagram corresponding to FIG. 8 according to the first embodiment equivalent to the second embodiment. FIGS. 30A to 30F are diagrams illustrating an operation example of the transportation mechanism 219c according to the present modification and are diagrams corresponding to FIGS. 9A to 9E according to the first embodiment equivalent to the second embodiment. In the electrolyte item measuring process, the electrolyte item is measured by using the measuring chip 300a or the measuring chip 300a for which measurement is completed is disposed of. For example, the electrolyte item measuring process is a process executed at a timing when the measurement of the electrolyte item is started.

First, as shown in FIG. 29, in the electrolyte item measuring process executed by the automatic analyzing apparatus 1 according to the present modification, the automatic analyzing apparatus 1 attaches the measuring chip 300a (Step S71). Specifically, the transportation control function 93 in the control circuitry 9 of the automatic analyzing apparatus 1 controls the drive mechanism 4 to attach the measuring chip 300a to the measuring chip attached hole 2199_1 of the rotating table 2199. More specifically, the transportation control function 93 lowers the rotating table 2199, supplies the measuring chip 300a to the supply position P11, raises the rotating table 2199, and inserts the measuring chip 300a into the measuring chip attached hole 2199_1 from below the measuring chip 300a. As a result, as illustrated in FIG. 30A, the transportation control function 93 attaches the measuring chip 300a to the measuring chip attached hole 2199_1.

Next, as illustrated in FIG. 29, the automatic analyzing apparatus 1 transports the measuring chip 300a to the positioning position P15 (step S73). Specifically, the transportation control function 93 in the control circuitry 9 of the automatic analyzing apparatus 1 controls the drive mechanism 4 to transport the measuring chip 300a attached to the measuring chip attached hole 2199_1 of the rotating table 2199 to the positioning position P15.

Next, as illustrated in FIG. 29, the automatic analyzing apparatus 1 positions the measuring chip 300a (step S75). Specifically, the system control function 91 in the control circuitry 9 of the automatic analyzing apparatus 1 lowers the rotating table 2199 at the positioning position P15, sets the measuring chip 300a in the positioning mechanism, and controls the positioning mechanism 2183a so that the plurality of terminals 303 of the measuring chip 300a are at predetermined positions based on a photographed image of an optical camera (not illustrated) that photographs the measuring chip 300a.

Next, as illustrated in FIG. 29, the automatic analyzing apparatus 1 transports the measuring chip 300a to the reaction cuvette position P12 (step S77). Specifically, the transportation control function 93 in the control circuitry 9 of the automatic analyzing apparatus 1 controls the drive mechanism 4 to transport the measuring chip 300a attached to the measuring chip attached hole 2199_1 to the reaction cuvette position P12. More specifically, the transportation control function 93 controls the drive mechanism 4 to rotate the rotating table 2199. As a result, as illustrated in FIG. 30B, the transportation control function 93 transports the measuring chip 300a attached to the measuring chip attached hole 2199_1 to the reaction cuvette position P12.

Next, as illustrated in FIG. 29, the automatic analyzing apparatus 1 lowers the transportation mechanism 219c (step S79). At the reaction cuvette position P12, the transportation control function 93 in the control circuitry 9 of the automatic analyzing apparatus 1 controls the drive mechanism 4 to lower the rotating table 2199 of the transportation mechanism 219c so that the measuring chip 300a attached to the measuring chip attached hole 2199_1 comes into contact with the sample or the mixture liquid accommodated in the reaction cuvette 2011.

Next, as illustrated in FIG. 29, the automatic analyzing apparatus 1 attaches the aspiration unit 223 (step S81). At the reaction cuvette position P12, the system control function 91 in the control circuitry 9 of the automatic analyzing apparatus 1 controls the drive mechanism 4 to lower the aspiration unit 223 and attach the measuring chip attached portion 2231 to the measuring chip 300a as illustrated in FIG. 30C. Here, the connector 2234 of the aspiration unit 223 and the plurality of terminals 303 of the measuring chip 300a are electrically connected. In addition, since the process in step S19 after step S81 is equivalent to the process in the first embodiment equivalent to the process according to the second embodiment described above, the description thereof is omitted.

Next, as illustrated in FIG. 29, the automatic analyzing apparatus 1 controls the temperature (step S83). The temperature control function 92 in the control circuitry 9 of the automatic analyzing apparatus 1 controls the heating unit 2237 so that the temperature of the sample or the mixture liquid becomes a predetermined temperature based on the measurement result of the temperature sensor 2238. When the sample or the mixture liquid aspirated in step S81 is a predetermined temperature, the process of step S83 is omitted.

Next, as illustrated in FIG. 29, the automatic analyzing apparatus 1 measures the potential (step S85). Specifically, the system control function 91 in the control circuitry 9 of the automatic analyzing apparatus 1 causes the measurer 2233 to measure the potential of each of the plurality of terminals 303 of the measuring chip 300a via the connector 2234. In addition, since the processes in steps S25 and S27 after step S85 are equivalent to the processes according to the first embodiment described above, the description thereof is omitted.

Next, as illustrated in FIG. 29, the automatic analyzing apparatus 1 removes the aspiration unit 223 (step S87). At the reaction cuvette position P12, the system control function 91 in the control circuitry 9 of the automatic analyzing apparatus 1 controls the drive mechanism 4 to raise the rotating table 2199 of the transportation mechanism 219c and the aspiration unit 223 and controls the measuring chip removing mechanism 2236 of the aspiration unit 223 to remove the measuring chip attached portion 2231 from the measuring chip 300a as illustrated in FIG. 30D.

Next, as illustrated in FIG. 29, the automatic analyzing apparatus 1 transports the measuring chip 300a to the disposal position P13 (step S89). Specifically, the transportation control function 93 in the control circuitry 9 of the automatic analyzing apparatus 1 controls the drive mechanism 4 to rotate the rotating table 2199 of the transportation mechanism 219c and transport the measuring chip 300a for which measurement is completed to the disposal position P13 as illustrated in FIG. 30E.

Next, as illustrated in FIG. 29, the automatic analyzing apparatus 1 disposes of the measuring chip 300a (step S91). Specifically, the transportation control function 93 in the control circuitry 9 of the automatic analyzing apparatus 1 controls the drive mechanism 4 to dispose of the measuring chip 300a in the disposal container 220. More specifically, the transportation control function 93 lowers the rotating table 2199, brings the measuring chip 300a attached to the measuring chip attached hole 2199_1 into contact with the disposal guide 2203, and removes the measuring chip 300a from the measuring chip attached hole 2199_1, to dispose of the measuring chip 300a in the disposed measuring chip accommodating portion 2201 as illustrated in FIG. 30F. By executing step S91, the electrolyte item measuring process according to the present modification is ended.

Note that in the electrolyte item measuring process according to the present modification described above, the automatic analyzing apparatus 1 calculates the concentration of the target substance in step S25 and outputs the calculation result in step S27, and then removes the aspiration unit 223 in step S87, transports the measuring chip 300a to the disposal position P13 in step S89, and disposes of the measuring chip 300a in step S91, but the timing of performing the disposal operation of the measuring chip 300a in steps S87, S89, and S91 is not limited thereto. That is, the timing of performing the disposal operation of the measuring chip 300a in steps S87, S89, and S91 is arbitrary, and for example, the disposal operation of the measuring chip 300a in steps S87, S89, and S91 may be performed after the potential is measured in step S85. Then, the calculation of the concentration of the target substance in step S25 and the output of the calculation result in step S27 may be performed in parallel with the disposal operation of the measuring chip 300a in steps S87, S89, and S91 or may be performed after the disposal operation of the measuring chip 300a in steps S87, S89, and S91 is completed.

As described above, according to the automatic analyzing apparatus 1 according to the present modification, when the electrolyte item is measured, the disposable measuring chip 300a is transported by the rotating table 2199, which is the transportation mechanism 219c, provided with the measuring chip attached hole 2199_1, the sample or the mixture liquid is aspirated into the measuring chip 300a by the aspiration unit 223, the potential of the sample or the mixture liquid is measured by the plurality of terminals 303 provided in the measuring chip 300a, and the concentration of the target substance is calculated based on the measured potential, and thus cleaning of the transportation mechanism 219c every time the electrolyte item is measured is unnecessary. As a result, even when the rotating table 2199 provided with the measuring chip attached hole 2199_1 is used as the transportation mechanism 219c in the measurement of the electrolyte item, the throughput can be improved.

In addition, in the automatic analyzing apparatus 1 according to the present modification, since the measurer 2233 measures the potentials of the plurality of terminals 303 while the sample or the mixture liquid is accommodated in the measuring chip 300a, the sample or the mixture liquid does not come into contact with the transportation mechanism 219. As a result, the occurrence of carryover can be reduced.

In addition, in the automatic analyzing apparatus 1 according to the present modification, the plurality of measuring chips 300a can be transported and the preparation of the measurement of another measuring chip 300a is performed before measurement of one measuring chip 300a is completed, and thus the throughput can be improved.

Note that, in the second modification described above, in the lowering operation of the transportation mechanism 219c, the measuring chip 300a is brought into contact with the disposal guide 2203, and the measuring chip 300a is disposed of in the disposed measuring chip accommodating portion 2201, but the method of disposing of the measuring chip 300a is not limited to a case of using the disposal guide 2203. A mechanism for transporting the measuring chip 300a to be disposed of from the transportation mechanism 219c to the disposed measuring chip accommodating portion 2201 may be provided.

Also, the second modification described above is also applicable to the third embodiment and the first modification. When the present modification is applied to the third embodiment, the automatic analyzing apparatus 1 according to the second modification does not need the aspiration unit 223 and thus may include a mechanism for electrically connecting the connector electrically connected to the measurer to the plurality of terminals 303 of the measuring chip 300a instead of the aspiration unit 223.

Note that, in the second modification described above, the aspiration unit 223 includes the heating unit 2237 and the temperature sensor 2238, and the heating unit 2237 is controlled based on the measurement result of the temperature sensor 2238 to control the temperature of the sample or the mixture liquid of the measuring chip 300a attached to the aspiration unit 223, but the configuration is not limited thereto. That is, the portion including the heating unit 2237 and the temperature sensor 2238 is arbitrary, and for example, the rotating table 2199 may include the heating unit 2237 and the temperature sensor 2238, or the supplier 218a may include the heating unit 2237 and the temperature sensor 2238. In addition, the temperature control function 92 may not include the heating unit 2237 and the temperature sensor 2238 and may control the temperature of the sample or the mixture liquid accommodated in the reaction cuvette 2011 by controlling the thermostatic unit 202, and the sample or the mixture liquid in the predetermined temperature may be aspirated.

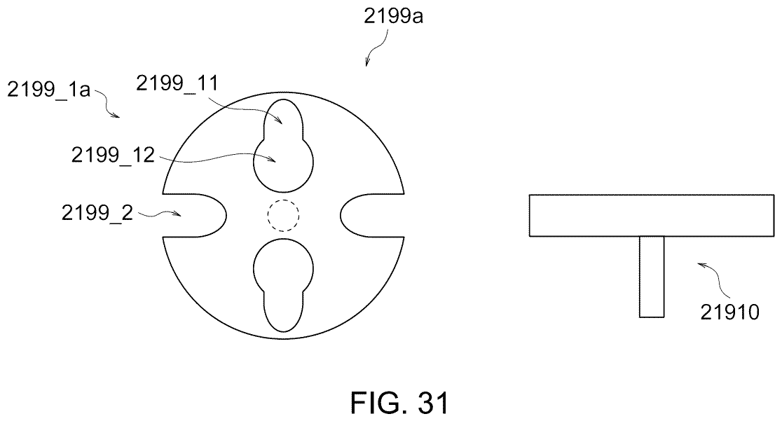

In the second modification described above, the rotating table 2199 includes only the measuring chip attached hole 2199_1 but may be a rotating table including a measuring chip attached hole and a measuring chip attached groove. FIG. 31 is a diagram illustrating another example of the configuration of the transportation mechanism 219c included in the analysis mechanism 2 according to the second modification. In the example illustrated in FIG. 31, a rotating table 2199a is provided with a measuring chip attached hole 2199_1a and a measuring chip attached groove 2199_2.

The measuring chip attached hole 2199_1a is formed with an attached hole 2199_11 and a disposal hole 2199_12. The size of the disposal hole 2199_12 is formed to be larger than the size of the attached hole 2199_11. The measuring chip attached groove 2199_2 is formed so that the measuring chip 300a supplied to the supply position P11 can be attached.

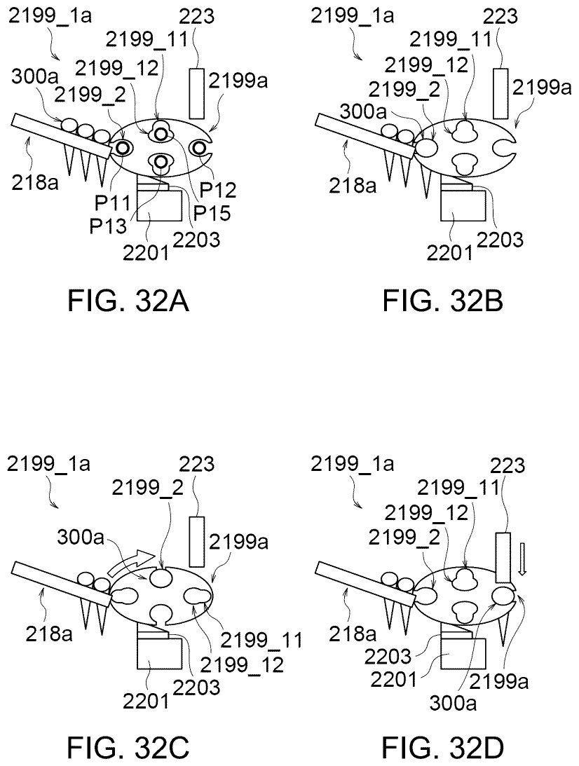

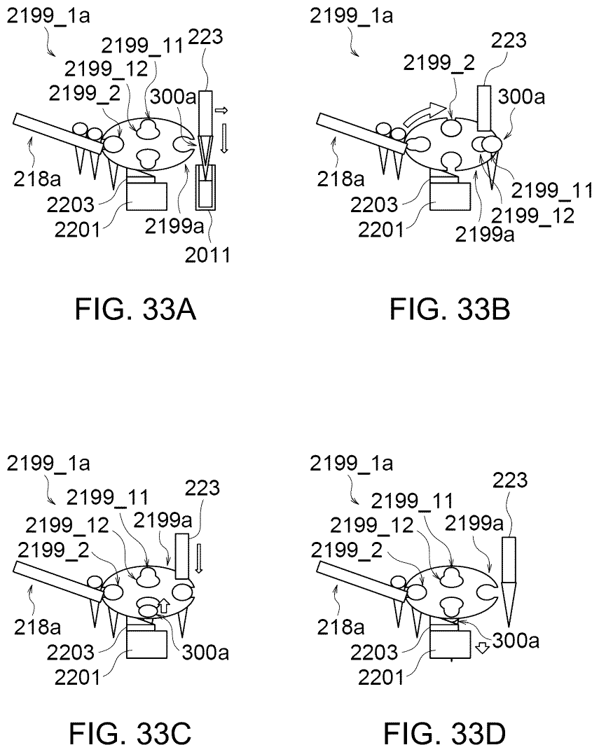

An operation example of the transportation mechanism 219c including the rotating table 2199a is described with reference to FIGS. 32A to 33D. FIGS. 32A to 33D are diagrams illustrating the transportation path of the measuring chip 300a, each position on the transportation path, and an operation example of the transportation mechanism 219c in another example of the configuration of the transportation mechanism 219c according to the present modification. As illustrated in FIGS. 32A and 32B, the rotating table 2199a moves the measuring chip attached groove 2199_2 to the supply position P11 and attaches the measuring chip 300a to the measuring chip attached groove 2199_2. Then, as illustrated in FIG. 32C, the rotating table 2199a transports the measuring chip 300a attached to the measuring chip attached groove 2199_2 to the positioning position P15 and performs positioning by the positioning mechanism 2183a. Next, as illustrated in FIG. 32D, the rotating table 2199a transports the measuring chip 300a to the reaction cuvette position P12. Then, at the reaction cuvette position P12, the aspiration unit 223 is attached to the measuring chip 300a.

Next, as illustrated in FIG. 33A, the aspiration unit 223 moves in the horizontal direction to remove the measuring chip 300a from the measuring chip attached groove 2199_2 of the rotating table 2199a and aspirates the sample or the mixture liquid accommodated in the reaction cuvette 2011 to the measuring chip 300a. Then, as illustrated in FIG. 33B, after the measurement is completed, the aspiration unit 223 attaches the measuring chip 300a for which measurement is completed to the attached hole 2199_11 of the measuring chip attached hole 2199_1a. Then, as illustrated in FIG. 33C, the rotating table 2199a rotates to transport the measuring chip 300a attached to the attached hole 2199_11 to the disposal position P13. Here, the measuring chip 300a attached to the attached hole 2199_11 moves to the disposal hole 2199_12 by approaching the disposal position P13 and coming into contact with the disposal guide 2203. Then, as illustrated in FIG. 33D, when the measuring chip 300a is transported to the disposal position P13, the measuring chip 300a moves from the attached hole 2199_11 to the disposal hole 2199_12 and is disposed of from the disposal hole 2199_12 into the disposed measuring chip accommodating portion 2201.

As described above, even when the rotating table 2199a including the measuring chip attached hole 2199_1a and the measuring chip attached groove 2199_2 is provided, the throughput can be improved similarly to the second modification.

### [Third Modification]

In the automatic analyzing apparatus 1 according to the first to third embodiments described above, the position of the chip body 301 in the rotation direction may be corrected by providing a correcting portion for correcting the position of the measuring chip 300 in the rotation direction to the measuring chip attached portion 2191 of the transportation mechanism 219 and providing a guiding portion for guiding the correcting portion to the chip body 301 of the measuring chip 300 to position the plurality of terminals 303 of the measuring chip 300 at a predetermined position with respect to the transportation mechanism 219. Hereinafter, portions different from those of the first embodiment described above are described using a case where the present modification is applied to the first embodiment described above as an example of a third modification.

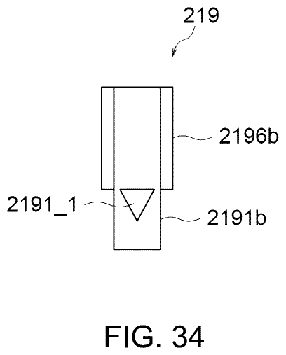

FIG. 34 is a diagram illustrating an example of a configuration of the transportation mechanism 219 according to the third modification and is a diagram corresponding to FIGS. 5A and 5B in the first embodiment described above. As illustrated in FIG. 34, the measuring chip attached portion and the measuring chip removing mechanism of the transportation mechanism 219 according to the present embodiment are different from those of the transportation mechanism 219 according to the first embodiment described above and thus are referred to as a measuring chip attached portion 2191b and a measuring chip removing mechanism 2196b in the present embodiment. Note that since the configuration and function other than the measuring chip attached portion 2191b and the measuring chip removing mechanism 2196b are equivalent to those in FIGS. 5A and 5B in the first embodiment described above, the description thereof is omitted.

As illustrated in FIG. 34, the measuring chip attached portion 2191b according to the present embodiment includes a correcting portion 2191_1 for correcting the position of the measuring chip 300 in the rotation direction. The correcting portion 2191_1 is inserted into a guide portion of the measuring chip 300 described below, thereby correcting the position of the measuring chip 300 attached to the measuring chip attached portion 2191 of the transportation mechanism 219 in the rotation direction. The correcting portion 2191_1 is formed on the outer periphery of the measuring chip attached portion 2191b. As illustrated in FIG. 34, the correcting portion 2191_1 according to the present embodiment is a protrusion formed in an inverted triangular shape.

As illustrated in FIG. 34, the measuring chip removing mechanism 2196b according to the present embodiment is formed not to interfere with the correcting portion 2191_1 when the measuring chip 300 is removed from the measuring chip attached portion 2191b. For example, the measuring chip removing mechanism 2196b is formed in a C-like shape when viewed from the attachment direction (vertically downward) of the measuring chip 300. Note that since the other configurations of the measuring chip removing mechanism 2196b according to the present embodiment are equivalent to the measuring chip removing mechanism 2196 according to the first embodiment described above, the description thereof is omitted.

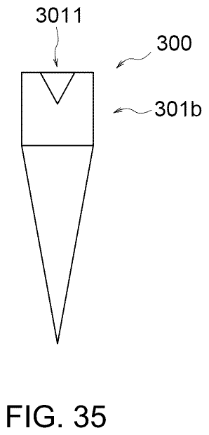

FIG. 35 is a diagram illustrating an example of a configuration of the measuring chip 300 according to the third modification and is a diagram corresponding to FIG. 3 in the first embodiment described above. As illustrated in FIG. 35, the chip body of the measuring chip 300 according to the present embodiment is different from that of the measuring chip 300 according to the first embodiment described above and thus is referred to as a chip body 301b in the present embodiment. Since the configurations other than the chip body 301b are equivalent to that in FIG. 3 according to the first embodiment described above, the description thereof is omitted.

In the chip body 301b according to the present embodiment, a guiding portion 3011 for guiding the correcting portion 2191_1 is formed. The guiding portion 3011 is a notch formed in a shape corresponding to the correcting portion 2191_1. As illustrated in FIG. 35, the guiding portion 3011 according to the present embodiment is a notch formed in an inverted triangle shape to correspond to the correcting portion 2191_1 having an inverted triangle shape. The guiding portion 3011 is formed at a predetermined position of the chip body 301b.

Then, in the electrolyte item measuring process of FIG. 8 described above, in step S13, the system control function 91 controls the positioning mechanism 2183 based on the photographed image of the optical camera and performs positioning so that the plurality of terminals 303 of the measuring chip 300 are at predetermined positions. Then, in step S15, the transportation control function 93 controls the drive mechanism 4 to lower the measuring chip attached portion 2191b. Then, the transportation control function 93 attaches the measuring chip attached portion 2191b to the attaching portion 304 of the measuring chip 300 while inserting the correcting portion 2191_1 of the measuring chip 300 into the guiding portion 3011.

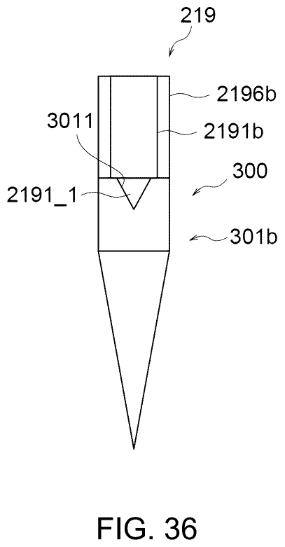

FIG. 36 is a diagram illustrating a state in which the measuring chip 300 according to the present modification is attached to the transportation mechanism 219. As illustrated in FIG. 36, when the measuring chip attached portion 2191b is attached to the attaching portion 304 of the measuring chip 300, the correcting portion 2191_1 of the transportation mechanism 219 is inserted into the guiding portion 3011 of the measuring chip 300, whereby the position of the measuring chip 300 in the rotation direction with respect to the transportation mechanism 219 is corrected. Then, the plurality of terminals 303 of the measuring chip 300 and the connector 2194 of the transportation mechanism 219 are connected.

As described above, according to the automatic analyzing apparatus 1 according to the present modification, the measuring chip attached portion 2191 of the transportation mechanism 219 is provided with the correcting portion 2191_1 for correcting the position of the measuring chip 300 in the rotation direction, the chip body 301 of the measuring chip 300 is provided with the guiding portion 3011 for guiding the correcting portion 2191_1, and the correcting portion 2191_1 is inserted into the guiding portion 3011, whereby the position of the measuring chip 300 in the rotation direction with respect to the transportation mechanism 219 is corrected, and the connector 2194 is connected to the plurality of terminals 303, and thus it is possible to position the plurality of terminals 303 at positions corresponding to the connector 2194 with higher accuracy than in a case of positioning the plurality of terminals 303 at positions corresponding to the connector 2194 only based on the photographed image of the optical camera.

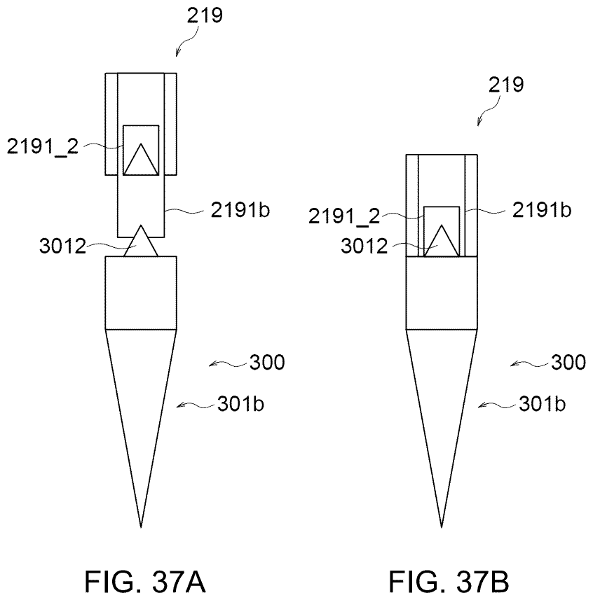

Note that, in the third modification described above, the measuring chip attached portion 2191b may be provided with a correcting portion, and the chip body 301 may be provided with a guiding portion. FIGS. 37A and 37B are diagrams illustrating another example of the transportation mechanism 219 and the measuring chip 300 according to the third modification. FIG. 37A is a diagram illustrating a configuration of each of the guiding portion and the correcting portion and is a diagram corresponding to FIGS. 34 and 35 according to the third modification described above. Also, FIG. 37B is a diagram illustrating a state in which the measuring chip 300 illustrated in FIG. 37A is attached to the transportation mechanism 219 and is a diagram corresponding to FIG. 36 according to the third modification described above.

As illustrated in FIG. 37A, the chip body 301 is provided with a correcting portion 3012, and the measuring chip attached portion 2191b is provided with a guiding portion 2191_2. Note that, since the correcting portion 3012 and the guiding portion 2191_2 respectively correspond to the correcting portion 2191_1 and the guiding portion 3011 and have substantially equivalent functions, the description thereof is omitted. As illustrated in FIG. 37B, the measuring chip attached portion 2191b is attached to the attaching portion 304, and the correcting portion 3012 of the measuring chip 300 is inserted into the guiding portion 2191_2 of the measuring chip attached portion 2191b, whereby the position of the measuring chip 300 in the rotation direction with respect to the transportation mechanism 219 is corrected. Then, the plurality of terminals 303 of the measuring chip 300 and the connector 2194 of the transportation mechanism 219 are connected. That is, as in the case illustrated in FIGS. 34 to 36, the position of the measuring chip 300 in the rotation direction with respect to the transportation mechanism 219 is corrected, and thus the plurality of terminals 303 can be positioned at positions corresponding to the connector 2194 with higher accuracy.

Furthermore, in the third modification described above, the guiding portion 3011 and the correcting portion 2191_1 are formed in an inverted triangular shape, but the shapes of the guiding portion 3011 and the correcting portion 2191_1 are not limited thereto. That is, the shapes of the guiding portion 3011 and the correcting portion 2191_1 are arbitrary. Further, the guiding portion 3011 and the correcting portion 2191_1 may not have the same shape. Further, the guiding portion 3011 and the correcting portion 2191_1 may have different shapes.

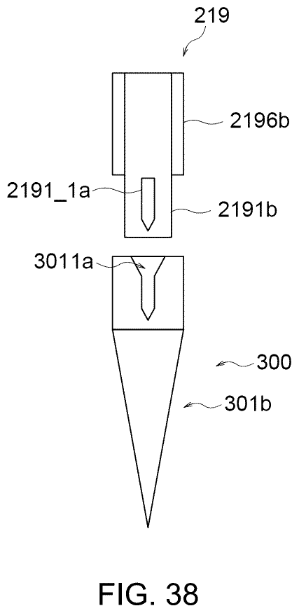

FIG. 38 is a diagram illustrating another example of the transportation mechanism 219 and the measuring chip 300 according to the third modification. In the example illustrated in FIG. 38, a correcting portion 2191_1a is a protrusion formed in a rectangular shape with an acute distal end on the insertion side into a guiding portion 3011a. Furthermore, in the example illustrated in FIG. 38, the guiding portion 3011a has a notch shape formed in a rectangular shape with an acute bottom portion to correspond to the shape of the correcting portion 2191_1a. Furthermore, in the example illustrated in FIG. 38, the guiding portion 3011a has a shape in which an insertion port into which the correcting portion 2191_1a is inserted is inclined toward the center of the guiding portion 3011a.

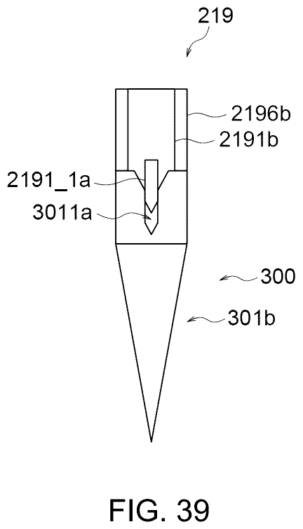

FIG. 39 is a diagram illustrating another example of the state in which the measuring chip 300 according to the present modification is attached to the transportation mechanism 219. As illustrated in FIG. 39, the measuring chip attached portion 2191b is attached to the attaching portion 304 of the measuring chip 300, and the correcting portion 2191_1a of the transportation mechanism 219 is inserted into the guiding portion 3011a of the measuring chip 300. Accordingly, as in the example illustrated in FIG. 36, the plurality of terminals 303 of the measuring chip 300 and the connector 2194 of the transportation mechanism 219 are connected. Note that, as illustrated in FIG. 39, a space may be provided between the correcting portion 2191_1a and the guiding portion 3011a while the correcting portion 2191_1a is inserted into the guiding portion 3011a.

As described above, also in the examples illustrated in FIGS. 38 and 39, it is possible to position the plurality of terminals 303 at positions corresponding to the connector 2194 with higher accuracy than in the case of positioning the plurality of terminals 303 at positions corresponding to the connector 2194 only based on the photographed image of the optical camera. In addition, since the guiding portion 3011a has a shape inclined toward the center of the guiding portion 3011a, even when an error in positioning of the measuring chip 300 by the positioning mechanism 2183 is large, when the measuring chip attached portion 2191b is lowered and the correcting portion 2191_1a is inserted into the guiding portion 3011a, the position of the measuring chip 300 in the rotation direction with respect to the transportation mechanism 219 is corrected by rotating the measuring chip 300 along the shape in which the correcting portion 2191_1a is inclined toward the center of the guiding portion 3011a, whereby the plurality of terminals 303 can be positioned at positions corresponding to the connector 2194.

Note that, also in the example illustrated in FIGS. 38 and 39, the measuring chip attached portion 2191b may be provided with a guiding portion, and the chip body 301b may be provided with a correcting portion.

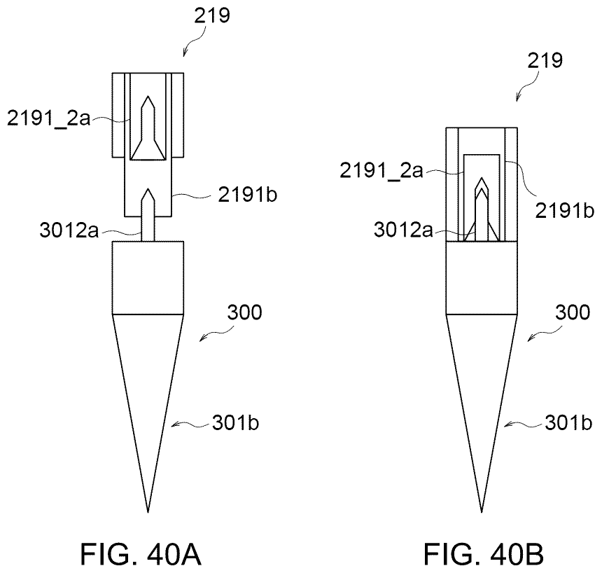

FIGS. 40A and 40B are diagrams illustrating another example of the guiding portion and the correcting portion illustrated in FIGS. 38 and 39. FIG. 40A is a diagram illustrating a configuration of each of the guiding portion and the correcting portion and is a diagram corresponding to FIG. 38 described above. Also, FIG. 40B is a diagram illustrating a state in which the measuring chip 300 illustrated in FIG. 40A is attached to the transportation mechanism 219 and is a diagram corresponding to FIG. 39 described above.

As illustrated in FIG. 40A, the chip body 301 is provided with a correcting portion 3012a, and the measuring chip attached portion 2191b is provided with a guiding portion 2191_2a. Note that, since the correcting portion 3012a and the guiding portion 2191_2a respectively correspond to the correcting portion 2191_1a and the guiding portion 3011a and have substantially equivalent functions, the description thereof is omitted. As illustrated in FIG. 40B, when the measuring chip attached portion 2191b is attached to the attaching portion 304, and the correcting portion 3012a of the measuring chip 300 is inserted into the guiding portion 2191_2a of the measuring chip attached portion 2191b, whereby the position of the measuring chip 300 in the rotation direction with respect to the transportation mechanism 219 is corrected. Then, the plurality of terminals 303 of the measuring chip 300 and the connector 2194 of the transportation mechanism 219 are connected. That is, as in the case illustrated in FIGS. 38 to 39, the position of the measuring chip 300 in the rotation direction with respect to the transportation mechanism 219 is corrected, and thus the plurality of terminals 303 can be positioned at positions corresponding to the connector 2194.

In addition, in the third modification described above, the measuring chip removing mechanism 2196b is formed in the C-shaped when viewed from the attachment direction (vertically downward) of the measuring chip 300, but the shape of the measuring chip removing mechanism 2196b is not limited thereto. That is, the shape of the measuring chip removing mechanism 2196b is arbitrary, and may be, for example, a cylindrical shape or the like or may be a rectangular shape as long as the measuring chip removing mechanism 2196b and the correcting portion 2191_1 do not interfere with each other when the measuring chip 300 is removed from the measuring chip attached portion 2191b.

Further, the third modification is described as a modification of the first embodiment described above, but can also be applied to the second embodiment, the third embodiment, the first modification, and the second modification. Note that, when the third modification is applied to the first modification, in addition to the correcting portion and the guiding portion provided to the measuring chip 300c and the transportation mechanism 219b or instead of the correcting portion and the guiding portion provided to the measuring chip 300c and the transportation mechanism 219b, one of the correcting portion or the guiding portion may be provided on the outer periphery of the chip body 301 of the measuring chip 300c, and the other one of the correcting portion or the guiding portion may be provided on the measuring chip mounting portion 2221 of the placing base 222. Note that, when the third modification is applied to the second modification, in addition to the correcting portion and the guiding portion provided to the measuring chip 300a and the transportation mechanism 219c or instead of the correcting portion and the guiding portion provided to the measuring chip 300a and the transportation mechanism 219c, one of the correcting portion or the guiding portion may be provided on the outer periphery of the chip body 301 of the measuring chip 300c, and the other one of the correcting portion or the guiding portion may be provided to the measuring chip attached hole 2199_1 of the rotating table 2199.

### Fourth Embodiment

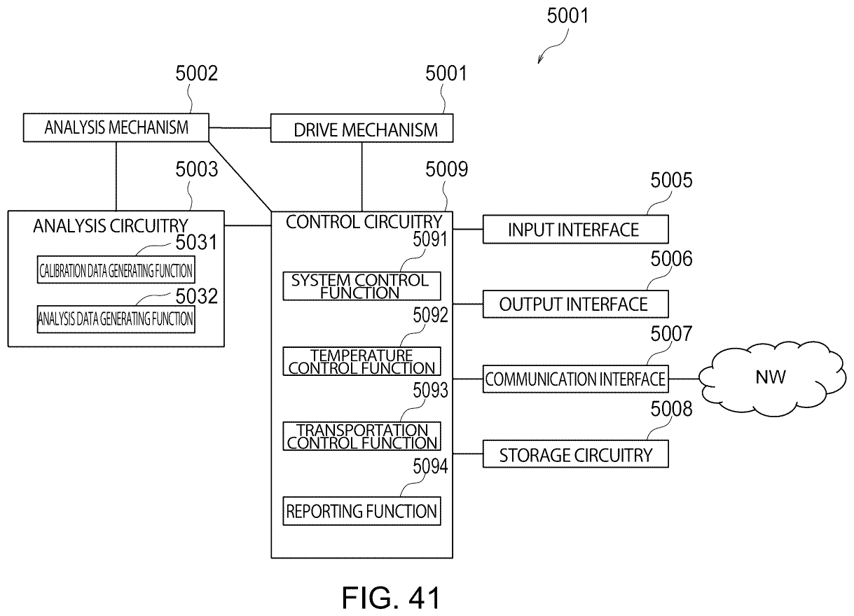

FIG. 41 is a block diagram illustrating an example of a functional configuration of an automatic analyzing apparatus according to a fourth embodiment. In the present embodiment, an automatic analyzing apparatus 5001 is, for example, a blood coagulation analyzing apparatus. In the following description, the present embodiment is described by using a case where a sample collected from a subject is blood, and the automatic analyzing apparatus 5001 is a blood coagulation analyzing apparatus as an example, but the present embodiment is also applicable to other types of automatic analyzing apparatuses.

As illustrated in FIG. 41, the automatic analyzing apparatus 5001 according to the present embodiment includes, for example, an analysis mechanism 5002, an analysis circuitry 5003, a drive mechanism 5004, an input interface 5005, an output interface 5006, a communication interface 5007, a storage circuitry 5008, and a control circuitry 5009.

The analysis mechanism 5002 generates a mixture liquid obtained by mixing a blood specimen which is a sample of a subject with a coagulation reagent which is a reagent used for each test item. In addition, depending on the test item, the analysis mechanism 5002 mixes a standard solution diluted at a predetermined magnification with the reagent used in the test item. Further, depending on the test item, the analysis mechanism 5002 generates a mixture liquid obtained by mixing a diluent for diluting a sample with the sample. The analysis mechanism 5002 continuously measures optical physical property values of a mixture liquid of a blood specimen and a reagent, a mixture liquid of a standard solution and a reagent, and a mixture liquid of a sample and a diluent. By the measurement, for example, standard data represented by transmitted light intensity, absorbance, scattered light intensity, and the like, and test data are generated. Also, the analysis mechanism 5002 according to the present embodiment measures, for example, potentials of a blood specimen, a mixture liquid of a blood specimen and a reagent, a mixture liquid of a standard solution and a reagent, or a mixture liquid of a sample and a diluent and generates standard data and test data associated with potentials.

The analysis circuitry 5003 is a processor that generates calibration data, analysis data, and the like by analyzing the standard data and the test data generated by the analysis mechanism 5002. The analysis circuitry 5003 reads an analysis program from the storage circuitry 5008 and generates calibration data, analysis data, and the like according to the read analysis program. The analysis circuitry 5003 according to the present embodiment generates calibration data and analysis data regarding coagulation of a blood specimen based on, for example, standard data and test data. Also, for example, the analysis circuitry 5003 according to the present embodiment generates, based on the standard data, calibration data indicating a relationship between the standard data and a standard value set in advance for the standard sample. In addition, the analysis circuitry 5003 generates analysis data represented as a concentration value and an enzyme activity value based on the test data and the calibration data of the test item corresponding to the test data. Examples of the analysis data include data in which a concentration value is associated with an enzyme activity value, and data in which a concentration of a desired ion in a sample is recorded in time series. The analysis circuitry 5003 outputs the generated calibration data, analysis data, and the like to the control circuitry 5009.

The drive mechanism 5004 drives the analysis mechanism 5002 under control of the control circuitry 5009. For example, the drive mechanism 5004 is realized by a gear, a stepping motor, a belt conveyor, a lead screw, and the like.

The input interface 5005 receives setting of an analysis parameter or the like of each test item related to a blood specimen requested to be measured, for example, from a user or via an in-hospital network NW. The input interface 5005 is realized by, for example, a mouse, a keyboard, a touch pad to which an instruction is input by touching an operation surface, and the like. The input interface 5005 is connected to the control circuitry 5009, converts an operation instruction input from the user into an electric signal, and outputs the electric signal to the control circuitry 5009. Note that, in the present embodiment, the input interface 5005 is not limited to an interface including physical operation components such as a mouse and a keyboard. For example, an electric signal processing circuitry that receives an electric signal corresponding to an operation instruction input from an external input device provided separately from the automatic analyzing apparatus 5001 and outputs the electric signal to the control circuitry 5009 is also included in the example of the input interface 5005.

The output interface 5006 is connected to the control circuitry 5009 and outputs a signal supplied from the control circuitry 5009. The output interface 5006 is realized by, for example, a display circuitry, a print circuitry, an audio device, and the like. Examples of the display circuitry include a CRT display, a liquid crystal display, an organic EL display, an LED display, and a plasma display. Note that the display circuitry also includes a processing circuitry that converts data representing a display target into a video signal and outputs the video signal to the outside. The print circuitry includes, for example, a printer. Note that an output circuitry that outputs data representing the printing target to the outside is also included in the print circuitry. The audio device includes, for example, a speaker. Note that an output circuitry that outputs an audio signal to the outside is also included in the audio device.

The communication interface 5007 is connected to, for example, the in-hospital network NW and connects the automatic analyzing apparatus 5001 to the in-hospital network NW. The communication interface 5007 performs data communication with a hospital information system (HIS) via the in-hospital network NW. Note that the communication interface 5007 may perform data communication with the HIS via a laboratory information system (LIS) connected to the in-hospital network NW.

The storage circuitry 5008 is configured with a recording medium readable by a processor such as a magnetic or optical recording medium, a semiconductor memory, or the like. Note that the storage circuitry 5008 is not necessarily realized by a single storage device. For example, the storage circuitry 5008 can be realized by a plurality of storage devices.

In addition, the storage circuitry 5008 stores an analysis program executed by the analysis circuitry 5003 and a control program executed by the control circuitry 5009. The storage circuitry 5008 stores the analysis data generated by the analysis circuitry 5003 for each test item. The storage circuitry 5008 stores the analysis data generated by the analysis circuitry 5003 for each blood specimen. The storage circuitry 5008 stores a test order input from the user or a test order received by the communication interface 5007 via the in-hospital network NW. The test order includes information related to a test item such as an electrolyte test performed by the automatic analyzing apparatus 5001, a measurement item such as an electrolyte item in the test item, and the like.

The control circuitry 5009 is a processor that functions as a center of the automatic analyzing apparatus 5001. The control circuitry 5009 is an example of a processing circuitry. For example, the control circuitry 5009 outputs a control signal for driving each unit of the analysis mechanism 5002 to the drive mechanism 5004. In addition, the control circuitry 5009 realizes a function corresponding to an operation program stored in the storage circuitry 5008 by executing the operation program. Note that the control circuitry 5009 may include a storage area that stores at least a part of the data stored in the storage circuitry 5008.

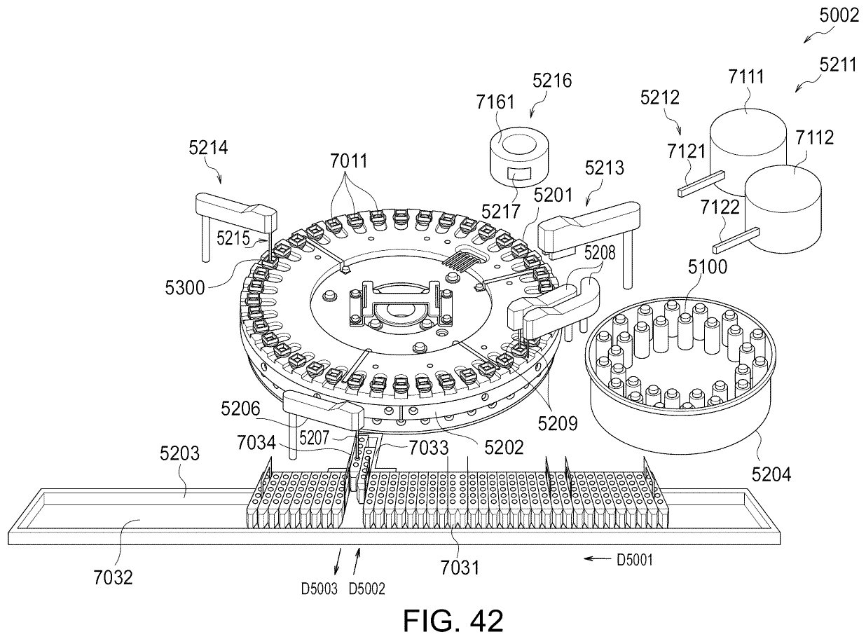

FIG. 42 is a diagram illustrating an example of a configuration of the analysis mechanism 5002 according to the fourth embodiment. As illustrated in FIG. 42, the analysis mechanism 5002 according to the present embodiment includes a reaction disk 5201, a thermostatic unit 5202, a rack sampler 5203, and a reagent storage 5204.

The reaction disk 5201 holds a plurality of measurement cuvettes 7011 arranged in a ring shape. The reaction disk 5201 holds reaction cuvettes 5300. That is, the measurement cuvette 7011 and/or the reaction cuvette 5300 are held by the reaction disk 5201 according to the present embodiment. The reaction disk 5201 transports the measurement cuvette 7011 and/or the reaction cuvette 5300 along a predetermined path. Specifically, during the analysis operation of the specimen, the reaction disk 5201 alternately repeats rotation and stopping at predetermined time intervals by the drive mechanism 5004.

The measurement cuvette 7011 accommodates a blood specimen or a mixture liquid. Also, the measurement cuvette 7011 is formed of, for example, polypropylene (PP), or acryl. The measurement cuvette 7011 according to the present embodiment is a cuvette for measuring an item other than the concentration of the target substance in the blood specimen or the mixture liquid. That is, the measurement cuvette 7011 according to the present embodiment is a cuvette which is not used for measuring the concentration of the electrolyte in the blood specimen or the mixture liquid. Also, the measurement cuvette 7011 according to the present embodiment is a disposable cuvette. Here, the target substance is an electrolyte such as a sodium ion, a potassium ion, or a chlorine ion. Note that the electrolyte may be a magnesium ion, an iron ion, a zinc ion, or the like.

The reaction cuvette 5300 is a cuvette for accommodating the blood specimen or the mixture liquid and for measuring the concentration of the target substance in the blood specimen or the mixture liquid. Also, the reaction cuvette 5300 is formed of, for example, polypropylene (PP), or acryl. The reaction cuvette 5300 according to the present embodiment is a disposable cuvette.

Note that the reaction cuvette 5300 according to the present embodiment is a cuvette for measuring the concentration of the target substance in the blood specimen or the mixture liquid but may be used for measurement of a measurement item other than the measurement of the concentration of the target substance in the blood specimen or the mixture liquid. Specifically, in case of measuring a plurality of test items including the measurement of the concentration of the target substance for one sample or mixture liquid, the automatic analyzing apparatus 5001 may measure other measurement items along with the measurement of the concentration of the target substance by using the reaction cuvette 5300. That is, the reaction cuvette 5300 according to the present embodiment is used when the measurement item in the test item includes the electrolyte item, and the measurement cuvette 7011 according to the present embodiment is used when the measurement item in the test item does not include the electrolyte item.

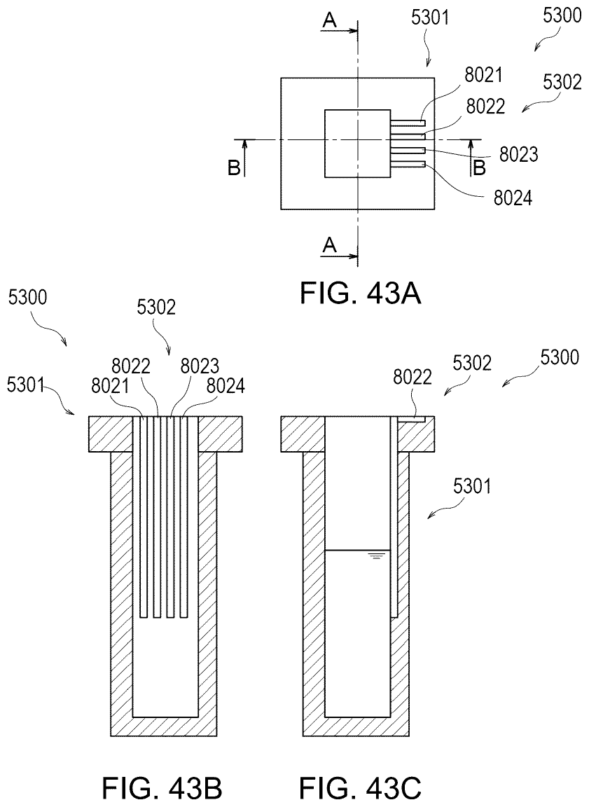

FIGS. 43A to 43C are diagrams illustrating an example of the reaction cuvette 5300 used in the analysis mechanism 5002 illustrated in FIG. 42 in the fourth embodiment. FIG. 43A is a diagram illustrating the reaction cuvette 5300 when viewed from above, FIG. 43B is a cross-sectional view taken along line A-A in FIG. 43A, and FIG. 43C is a cross-sectional view taken along line B-B in FIG. 43A. As illustrated in FIGS. 43A to 43C, the reaction cuvette 5300 according to the present embodiment includes a cuvette body 5301 and a plurality of terminals 5302.

The cuvette body 5301 accommodates a blood specimen, a mixture liquid obtained by mixing a reagent that reacts with a blood specimen with the blood specimen, and a mixture liquid obtained by mixing a diluent that dilutes a blood specimen with the blood specimen. The cuvette body 5301 according to the present embodiment has a straight cylindrical shape in which an opening is formed on an upper surface, and a lower surface is closed. In the present embodiment, the shape of the cuvette body 5301 is not limited to a straight cylindrical shape. That is, the shape of the cuvette body 5301 is arbitrary and is, for example, a cylindrical shape, a square cylindrical shape, or a shape obtained by combining the shapes.

The plurality of terminals 5302 are terminals which are provided in the cuvette body 5301 and measure the concentration of the target substance in the blood specimen or the mixture liquid accommodated in the cuvette body 5301. Further, the plurality of terminals 5302 according to the present embodiment are provided in the cuvette body 5301 by being integrally formed with the cuvette body 5301. As illustrated in FIG. 43C, the plurality of terminals 5302 according to the present embodiment are provided to have an L shape from the upper surface to the inner wall surface of the cuvette body 5301. As illustrated in FIG. 43B, each of the plurality of terminals 5302 is provided so that a longitudinal direction of the plurality of terminals 5302 is perpendicular to the opening of the cuvette body 5301. Also, the plurality of terminals 5302 are provided on one inner wall surface of the cuvette body 5301. In the example illustrated in FIGS. 43A to 43C, the plurality of terminals 5302 are four terminals. As illustrated in FIGS. 43A and 43B, a part of each of the plurality of terminals 5302 is exposed to the outside so that a connector described below can be brought into contact with the terminals.

Note that four terminals 5302 according to the present embodiment are provided, but the number of the plurality of terminals 5302 provided in the cuvette body 5301 is not limited thereto. That is, the number of the plurality of terminals 5302 is arbitrary, and the number of the plurality of terminals 5302 provided in the cuvette body 5301 may be two, three, five, or more.

The plurality of terminals 5302 include an ion selective electrode (hereinafter referred to as an ISE) that selectively detects an electrolyte which is the target substance included in the blood specimen or the mixture liquid and a reference electrode that generates a constant potential. In the present embodiment, as illustrated in FIGS. 43A and 43B, each of the four terminals which are the plurality of terminals 5302 is ISEs 8021 to 8023 and a reference electrode 8024.

The ISE 8021 has a sensitive membrane that selectively detects a sodium ion. The ISE 8021 generates a potential proportional to a logarithm of a concentration of sodium ions with respect to the reference electrode 8024 under the condition that the activity coefficient and the solution temperature of the blood specimen or the mixture liquid accommodated in the reaction cuvette 5300 are constant.

The ISE 8022 has a sensitive membrane that selectively detects a potassium ion. The ISE 8022 generates a potential proportional to a logarithm of a concentration of potassium ions with respect to the reference electrode 8024 under the condition that the activity coefficient and the solution temperature of the blood specimen or the mixture liquid accommodated in the reaction cuvette 5300 are constant.

The ISE 8023 has a sensitive membrane that selectively detects a chlorine ion. The ISE 8023 generates a potential proportional to a logarithm of a concentration of chlorine ions with respect to the reference electrode 8024 under the condition that the activity coefficient and the solution temperature of the blood specimen or the mixture liquid accommodated in the reaction cuvette 5300 are constant.

The reference electrode 8024 includes a solution junction portion that generates a constant potential. Note that, although the ISEs 8021 to 8023 included in the plurality of terminals 5302 according to the present embodiment selectively detect sodium ions, potassium ions, and chlorine ions, the substances selectively detected by the ISEs 8021 to 8023 are not limited to sodium ions, potassium ions, and chlorine ions. That is, substances selectively detected by the ISEs 8021 to 8023 are arbitrary, and for example, the ISEs 8021 to 8023 may selectively detect magnesium ions, iron ions, zinc ions, and the like. Furthermore, in the example illustrated in FIGS. 43A to 43C, the ISEs 8021 to 8023 and the reference electrodes 8024 are arranged from the left, but the arrangement order of the ISEs 8021 to 8023 and the reference electrodes 8024 is arbitrary.

The reaction cuvette 5300 and the automatic analyzing apparatus 5001 that analyzes the sample by using the sample or the mixture liquid accommodated in the reaction cuvette 5300 configure an automatic analyzing system according to the present embodiment.

Referring back to FIG. 42, the thermostatic unit 5202 stores a heating medium set to a predetermined temperature and immerses the reaction cuvette 5300 and the measurement cuvette 7011 in the stored heating medium to raise the temperature of the blood specimen or the mixture liquid accommodated in the reaction cuvette 5300 and the measurement cuvette 7011. The predetermined temperature of the thermostatic unit 5202 is, for example, a temperature set so that the blood specimen or the mixture liquid accommodated in the reaction cuvette 5300 and the measurement cuvette 7011 becomes 37° C. Note that the predetermined temperature is not limited to 37° C. That is, the predetermined temperature is arbitrary, and may be 37° C. or higher, or may be 37° C. or lower.

The rack sampler 5203 movably supports a sample rack 7031 that can hold a plurality of sample cuvettes, and a blood specimen which is a specimen requested to be measured is accommodated in the plurality of sample cuvettes. In the example illustrated in FIG. 42, the sample racks 7031 each capable of holding five sample cuvettes in parallel are illustrated.

The rack sampler 5203 is provided with a transportation area 7032 for transporting the sample rack 7031. That is, the sample rack 7031 is transported from an insertion position where the sample rack 7031 is inserted to a collection position where the sample rack 7031 for which measurement is completed is collected by using the transportation area 7032. In the transportation area 7032, the plurality of sample racks 7031 aligned in a longitudinal direction are moved in a direction D5001 by the drive mechanism 5004.

Also, to move the sample cuvette held by the sample rack 7031 to a predetermined sample aspiration position, the rack sampler 5203 is provided with an attraction area 7033 for attracting the sample rack 7031 from the transportation area 7032. The sample aspiration position is provided, for example, at a position where a rotating track of a sample dispensing probe 5207 and a moving track of the opening of the sample cuvette supported by the rack sampler 5203 and held by the sample rack 7031 intersect. In the attraction area 7033, the transported sample racks 7031 are moved in a direction D5002 by the drive mechanism 5004.

In addition, the rack sampler 5203 is provided with a returning area 7034 for returning the sample rack 7031 holding the sample cuvette in which the sample is aspirated to the transportation area. In the returning area 7034, the sample rack 7031 is moved in a direction D5003 by the drive mechanism 5004.

The reagent storage 5204 holds a plurality of reagent cuvettes 5100 accommodating a standard solution, a diluent, a reagent used in each test item performed on a blood specimen, and the like while refrigerating. In the reagent storage 5204, a rotating table is rotatably provided. The rotating table holds a plurality of reagent cuvettes 5100 to be mounted in an annular shape. In the present embodiment, although not illustrated in FIG. 42, the reagent storage 5204 is covered with a detachable reagent cover.

In addition, the analysis mechanism 5002 according to the present embodiment illustrated in FIG. 42 includes a sample dispensing arm 5206, a sample dispensing probe 5207, a reagent dispensing arm 5208, a reagent dispensing probe 5209, and a photometric unit 5210.

The sample dispensing arm 5206 is provided between the reaction disk 5201 and the rack sampler 5203. The sample dispensing arm 5206 is provided to be movable up and down in a vertical direction and to be rotatable in a horizontal direction by the drive mechanism 5004. The sample dispensing arm 5206 holds the sample dispensing probe 5207 at one end.

The sample dispensing probe 5207 rotates along an arc-shaped rotating track according to the rotation of the sample dispensing arm 5206. A sample aspiration position for aspirating a sample from the sample cuvette held by the sample rack 7031 on the rack sampler 5203 is provided on the rotating track. In addition, a sample dispensing position for dispensing the sample aspirated by the sample dispensing probe 5207 to the reaction cuvette 5300 or the measurement cuvette 7011 is provided on the rotating track of the sample dispensing probe 5207. The sample dispensing position corresponds to, for example, an intersection point of the rotating track of the sample dispensing probe 5207 and the moving track of the reaction cuvette 5300 or the measurement cuvette 7011 held by the reaction disk 5201.

The sample dispensing probe 5207 is driven by the drive mechanism 5004 and moves in the up-down direction at the sample aspiration position or the sample dispensing position. Also, the sample dispensing probe 5207 aspirates the sample from the sample cuvette positioned immediately below the sample aspiration position according to the control of the control circuitry 5009. In addition, the sample dispensing probe 5207 dispenses the aspirated sample to the reaction cuvette 5300 or the measurement cuvette 7011 positioned immediately below the sample dispensing position according to the control of the control circuitry 5009.

The reagent dispensing arm 5208 is provided between the reaction disk 5201 and the reagent storage 5204. The reagent dispensing arm 5208 is provided to be movable up and down in the vertical direction and to be rotatable in the horizontal direction by the drive mechanism 5004. The reagent dispensing arm 5208 holds the reagent dispensing probe 5209 at one end.

The reagent dispensing probe 5209 rotates along an arc-shaped rotating track according to the rotation of the reagent dispensing arm 5208. The reagent aspiration position is provided on the rotating track. The reagent aspiration position is provided, for example, at a position where the rotating track of the reagent dispensing probe 5209 and the moving track of the openings of the reagent cuvettes 5100 annularly mounted in the rotating table of the reagent storage 5204 intersect. In addition, a reagent dispensing position for dispensing the reagent or the diluent aspirated by the reagent dispensing probe 5209 to the reaction cuvette 5300 or the measurement cuvette 7011 is set on the rotating track of the reagent dispensing probe 5209. The reagent dispensing position corresponds to, for example, an intersection point of the rotating track of the reagent dispensing probe 5209 and the moving track of the reaction cuvette 5300 or the measurement cuvette 7011 held by the reaction disk 5201.

The reagent dispensing probe 5209 is driven by the drive mechanism 5004 and moves in the up-down direction at the reagent aspiration position or the reagent dispensing position on the rotating track. Also, the reagent dispensing probe 5209 aspirates the reagent or the diluent from the reagent cuvette stopping at the reagent aspiration position according to the control of the control circuitry 5009. In addition, the reagent dispensing probe 5209 dispenses the aspirated reagent or diluent into the reaction cuvette 5300 or the measurement cuvette 7011 positioned immediately below the reagent dispensing position according to the control of the control circuitry 5009.

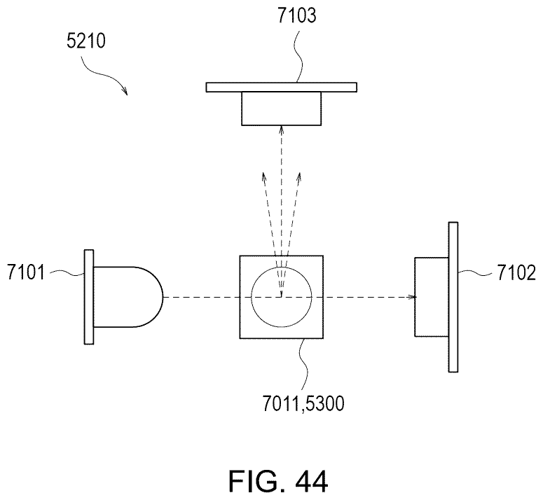

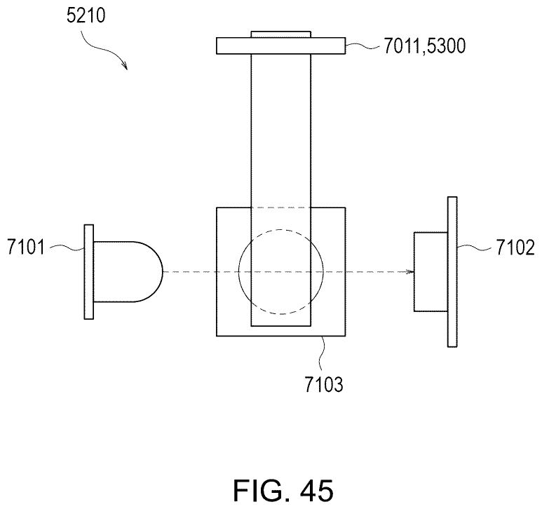

Furthermore, in the analysis mechanism 5002 according to the present embodiment, the same number of photometric units as the number of the reaction cuvettes 5300 and the measurement cuvettes 7011 that can be held on the reaction disk 5201 are provided. FIGS. 44 and 45 are schematic diagrams illustrating a configuration example of the photometric unit. FIG. 44 is a configuration diagram of the photometric unit included in the analysis mechanism illustrated in FIG. 42 as viewed from above. FIG. 45 is a configuration diagram of the photometric unit included in the analysis mechanism illustrated in FIG. 42 as viewed from a side surface.

The photometric unit 5210 continuously measures optical physical property values of a mixture liquid of a blood specimen and a reagent, a mixture liquid of a standard solution and a reagent, and a mixture liquid of a sample and a diluent, which are dispensed into the reaction cuvette 5300 or the measurement cuvette 7011. In the analysis mechanism 5002 according to the present embodiment, the plurality of photometric units 5210 is provided. For example, the photometric units 5210 are provided in the same number as the number of the reaction cuvettes 5300 and the measurement cuvettes 7011 that can be held by the reaction disk 5201. That is, one photometric unit 5210 is provided for one reaction cuvette 5300 or measurement cuvette 7011 held by the reaction disk 5201. Since the configurations of the respective photometric units 5210 are similar, one photometric unit 5210 is illustrated as a representative in FIGS. 44 and 45.

The photometric unit 5210 illustrated in FIGS. 44 and 45 includes, for example, a light source 7101 and photodetectors 7102 and 7103. For example, the photometric unit 5210 includes the light source 7101 on the annular center side of the reaction cuvette 5300 or the measurement cuvette 7011 annularly held by the reaction disk 5201. The light source 7101 is provided to emit light toward the outside of the ring in which the reaction cuvettes 5300 or the measurement cuvettes 7011 are arranged. Note that only one of the photodetectors 7102 and 7103 may be provided.

The light source 7101 generates light of two types of wavelengths. The light source 7101 generates, for example, first light having a long wavelength and second light having a short wavelength. For example, the wavelength of the first light is included in the red wavelength region of 620 to 750 nm, and the wavelength of the second light is included in the violet to blue wavelength region of 380 to 495 nm. The wavelengths of the first and second light may be respectively included in the red wavelength region of 620 to 750 nm. The light source 7101 is realized by, for example, a multi-wavelength LED capable of generating light of a plurality of wavelengths, two LEDs each generating light of a predetermined wavelength, and a light source unit that transmits light of a desired wavelength from light of a wide wavelength range by a filter.

The light source 7101 generates the first and second light under the control of the control circuitry 5009. Specifically, for example, the light source 7101 alternately generates the first and second light at a predetermined cycle. Here, the light source 7101 alternately generates, for example, the first and second light, for example, at a cycle of 0.05 seconds, which is half of 0.1 seconds which is the minimum measurement unit of coagulation. The light emitted from the light source 7101 is incident on the reaction cuvette 5300 or the measurement cuvette 7011.

Note that the light source 7101 may generate light of one wavelength designated by the control circuitry 5009. Furthermore, the light source 7101 may simultaneously generate the first and second light. However, then, it is necessary to provide a filter for excluding light of an unnecessary wavelength in the photodetectors 7102 and 7103.

The photodetector 7102 is disposed at a position facing the light source 7101 with the reaction cuvette 5300 or the measurement cuvette 7011 interposed therebetween. The light emitted from the light source 7101 is incident from a first side wall of the reaction cuvette 5300 or the measurement cuvette 7011 and emitted from a second side wall facing the first side wall. The photodetector 7102 detects the light emitted from the reaction cuvette 5300 or the measurement cuvette 7011. The photodetector 7102 is an example of a transmitted light receiving unit, for example.

Specifically, for example, the photodetector 7102 detects light that passes through a mixture liquid of a standard solution and a reagent in the reaction cuvette 5300 or the measurement cuvette 7011. The photodetector 7102 samples the detected light at predetermined time intervals, for example, at intervals of 0.1 seconds and generates standard data represented by transmitted light intensity, absorbance, or the like. The predetermined time interval is synchronized with, for example, the generation frequency of the first light. Note that, for example, the photodetector 7102 may detect only light having a wavelength corresponding to the wavelength of the first light. Specifically, the photodetector 7102 detects light that passes through a mixture liquid of a blood specimen and a reagent in the reaction cuvette 5300 or the measurement cuvette 7011. The photodetector 7102 samples the detected light at predetermined time intervals and generates test data represented by transmitted light intensity, absorbance, or the like. The photodetector 7102 outputs the generated standard data and test data to the analysis circuitry 5003.

The photodetector 7103 is disposed so that a light irradiation axis of the light source 7101 and a light receiving axis of the photodetector 7103 intersect each other at approximately 90 degrees in the reaction cuvette 5300 or the measurement cuvette 7011. The light emitted from the light source 7101 is incident from the first side wall of the reaction cuvette 5300 or the measurement cuvette 7011, scattered by the particles in the mixture liquid, and then emitted from a third side wall adjacent to the first side wall at 90 degrees. The photodetector 7103 detects the light emitted from the reaction cuvette 5300 or the measurement cuvette 7011. The photodetector 7103 is an example of a scattered light receiving unit, for example.

Specifically, for example, the photodetector 7103 detects light which is scattered by a mixture liquid of a standard solution and a reagent in the reaction cuvette 5300 or the measurement cuvette 7011. The photodetector 7103 samples the detected light at predetermined time intervals, for example, at intervals of 0.1 seconds and generates standard data represented by scattered light intensity or the like. The predetermined time interval is synchronized with, for example, the generation frequency of the second light. Note that, for example, the photodetector 7103 may detect only light having a wavelength corresponding to the wavelength of the second light. Specifically, the photodetector 7103 detects light scattered by a mixture liquid of a blood specimen and a reagent in the reaction cuvette 5300 or the measurement cuvette 7011. The photodetector 7103 samples the detected light at predetermined time intervals and generates test data represented by scattered light intensity or the like. The photodetector 7103 outputs the generated standard data and test data to the analysis circuitry 5003.

Note that the photodetectors 7102 and 7103 may output the intensity of the detected light to the analysis circuitry 5003 as a detection signal. Then, the analysis circuitry 5003 samples the detection signal at predetermined time intervals, for example, at intervals of 0.1 seconds and generates standard data and test data.

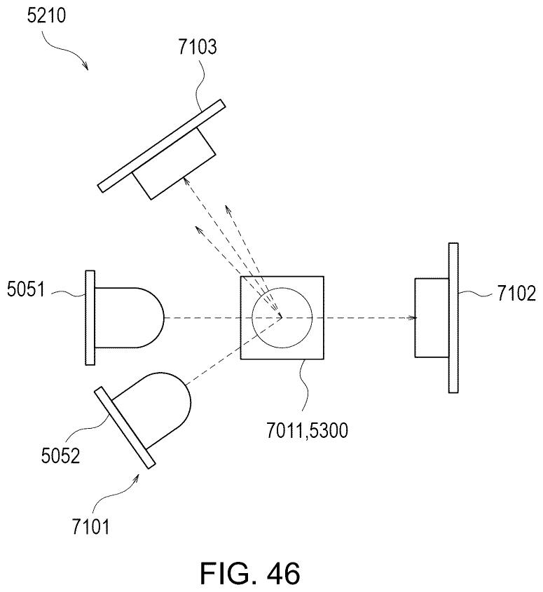

FIG. 46 is a configuration diagram of another example of the photometric unit 5210 included in the analysis mechanism 5002 illustrated in FIG. 42 as viewed from above. Similarly to FIG. 44, FIG. 46 illustrates an example of a positional relationship of each component when the photometric unit 5210 is viewed from above the reaction disk 5201. The photometric unit 5210 illustrated in FIG. 46 includes two LEDs 5051 and 5052 as the light source 7101. In the example illustrated in FIG. 46, a light irradiation axis of the LED 5052 is inclined by a predetermined angle with respect to a light irradiation axis of the LED 5051.

As in the examples of FIGS. 44 and 45, the photodetector 7102 is disposed at a position facing the LED 5051 with the reaction cuvette 5300 or the measurement cuvette 7011 interposed therebetween. Meanwhile, the photodetector 7103 is disposed so that the light irradiation axis of the LED 5052 and a light receiving axis of the photodetector 7103 intersect each other at approximately 90 degrees in the reaction cuvette 5300 or the measurement cuvette 7011.

Further, the analysis mechanism 5002 according to the present embodiment illustrated in FIG. 42 includes a storage container 5211, a supplier 5212, a transportation unit 5213, a measurer 5214, a connector 5215, a disposal unit 5216, and a detector 5217.

The storage container 5211 stores the reaction cuvette 5300 or the measurement cuvette 7011. The storage container 5211 according to the present embodiment stores the reaction cuvette 5300 provided with the plurality of integrally formed terminals 5302, and a measurement cuvette 7011 for accommodating a blood specimen or a mixture liquid and measuring an item other than the concentration of the target substance in the blood specimen or the mixture liquid. The storage container 5211 is provided in the vicinity of the outer periphery of the reaction disk 5201. The storage container 5211 according to the present embodiment includes a reaction cuvette storage container 7111 and a measurement cuvette storage container 7112. The reaction cuvette storage container 7111 stores a plurality of empty reaction cuvettes 5300. The measurement cuvette storage container 7112 stores a plurality of empty measurement cuvettes 7011.

The supplier 5212 supplies the empty reaction cuvette 5300 or the empty measurement cuvette 7011 from the storage container 5211 to the supply position. The supplier 5212 is configured with, for example, a belt, a slider, and a supply rail. The supplier 5212 according to the present embodiment includes a reaction cuvette supplier 7121 and a measurement cuvette supplier 7122.

The reaction cuvette supplier 7121 discharges the empty reaction cuvette 5300 from the reaction cuvette storage container 7111 to the outside and supplies the empty reaction cuvette 5300 to a reaction cuvette supply position. The reaction cuvette supplier 7121 according to the present embodiment is, for example, a reaction cuvette supply rail provided to be inclined toward the reaction cuvette supply position. Therefore, the reaction cuvette 5300 discharged from the reaction cuvette storage container 7111 slides on the reaction cuvette supply rail by gravity and moves toward the reaction cuvette supply position. The reaction cuvette supply position is, for example, a position where a rotating track which is a transportation path of the reaction cuvette 5300 in the transportation unit 5213 and a moving track of the reaction cuvette 5300 on the reaction cuvette supplier 7121 intersect.

The measurement cuvette supplier 7122 discharges the empty measurement cuvette 7011 from the measurement cuvette storage container 7112 to the outside and supplies the empty measurement cuvette 7011 to a measurement cuvette supply position. The measurement cuvette supplier 7122 according to the present embodiment is, for example, a measurement cuvette supply rail provided to be inclined toward the measurement cuvette supply position. Therefore, the measurement cuvette 7011 discharged from the measurement cuvette storage container 7112 slides on the measurement cuvette supply rail by gravity and moves toward the measurement cuvette supply position. The measurement cuvette supply position is, for example, a position where a rotating track which is a transportation path of the measurement cuvette 7011 in the transportation unit 5213 and a moving track of the measurement cuvette 7011 on the measurement cuvette supplier 7122 intersect.

The transportation unit 5213 transports the reaction cuvette 5300. Also, the transportation unit 5213 transports the measurement cuvette 7011. The transportation unit 5213 according to the present embodiment transports the reaction cuvette 5300 supplied to the reaction cuvette supply position or the measurement cuvette 7011 supplied to the measurement cuvette supply position to the reaction disk 5201 under the control of the control circuitry 5009. In addition, the transportation unit 5213 according to the present embodiment transports the reaction cuvette 5300 or the measurement cuvette 7011, which is held on the reaction disk 5201 and for which measurement is ended, to a disposal position which is a position where the reaction cuvette 5300 and the measurement cuvette 7011 are disposed of. The transportation unit 5213 according to the present embodiment includes a transportation arm and a holder. Note that the transportation unit 5213 is an example of a reaction cuvette transportation mechanism.

The transportation arm is provided between the reaction disk 5201 and the storage container. The transportation arm is provided to be movable up and down in the vertical direction and to be rotatable in the horizontal direction by the drive mechanism 5004. The transportation arm according to the present embodiment includes one arm. The transportation arm includes the holder at one end. Note that the number of arms that configure the transportation arm is arbitrary. For example, the transportation unit 5213 may be configured with a plurality of arms.

The holder holds the reaction cuvette 5300 or the measurement cuvette 7011. The holder according to the present embodiment is, for example, a gripper.

The transportation unit 5213 according to the present embodiment transports the reaction cuvette 5300 supplied to the reaction cuvette supply position or the measurement cuvette 7011 supplied to the measurement cuvette supply position to the placing position of the reaction disk 5201 so that the holder of the transportation unit 5213 and the reaction cuvette 5300 or the measurement cuvette 7011 held by the holder pass through the transportation path. The transportation path of the reaction cuvette 5300 or the measurement cuvette 7011 in the transportation unit 5213 is formed, for example, on an arc-shaped rotating track accompanied by the rotation about one end of the transportation arm. Note that the transportation path of the reaction cuvette 5300 or the measurement cuvette 7011 in the transportation unit 5213 is arbitrary. For example, the transportation path of the reaction cuvette 5300 or the measurement cuvette 7011 in the transportation unit 5213 may be formed on an elliptical track or may be a transportation path having no specific shape.

The measurer 5214 measures potentials of the plurality of terminals 5302 provided in the reaction cuvette 5300. Specifically, the measurer 5214 measures the potential between the ISEs 8021 to 8023 and the reference electrode 8024 for the sample or the mixture liquid under the control of the control circuitry 5009. The measurer 5214 outputs data obtained by measuring the potential to the analysis circuitry 5003 as standard data or test data. The measurer 5214 according to the present embodiment is provided in the vicinity of the outer periphery of the reaction disk 5201. In addition, the measurer 5214 according to the present embodiment is provided to be movable up and down in the vertical direction. In addition, the measurer 5214 according to the present embodiment measures the potentials of the plurality of terminals 5302 of the reaction cuvette 5300 when the reaction cuvette 5300 held by the reaction disk 5201 is transported to a potential measuring position. The potential measuring position is a position which is below the measurer 5214 in the vertical direction and intersects the transportation path of the reaction disk 5201.

The connector 5215 is a connection terminal electrically connected to the measurer 5214. Specifically, one end of the connector 5215 is electrically connected to the measurer 5214, and the other end of the connector 5215 can come into contact with the plurality of terminals 5302 provided on the reaction cuvette 5300. The connector 5215 includes a plurality of connection terminals to measure the potential between the ISE and the reference electrode. The connector 5215 according to the present embodiment includes four connection terminals to come into contact with the ISEs 8021 to 8023 and the reference electrode 8024 at once. The number of connection terminals included in the connector 5215 is not limited to four. That is, the number of connection terminals included in the connector 5215 is arbitrary, and for example, two or three connection terminals may be included, or five or more connection terminals may be included. The connector 5215 is an example of a first connector according to the present embodiment.

In addition, the connector 5215 moves in the vertical direction accompanied by up-down movement of the measurer 5214. By the up-down movement of the connector 5215, the connector 5215 comes into contact with the plurality of terminals 5302, or the contact between the connector 5215 and the plurality of terminals 5302 is released.

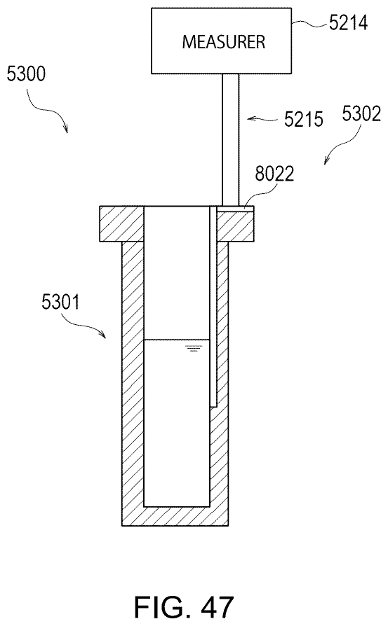

FIG. 47 is a diagram illustrating an example of a method of measuring a potential by the measurer 5214 according to the first embodiment. As illustrated in FIG. 47, when the reaction cuvette 5300 is transported to the potential measuring position, the measurer 5214 is lowered, and the connector 5215 comes into contact with the plurality of terminals 5302 of the reaction cuvette 5300. In the example illustrated in FIG. 47, each of the connection terminals of the connector 5215 comes in contact with each of the plurality of terminals 5302 exposed on the upper surface of the reaction cuvette 5300. As such, when the connector 5215 comes into contact with the plurality of terminals 5302, the plurality of terminals 5302 and the measurer 5214 are brought into a conductive state. The measurer 5214 according to the present embodiment measures the potentials of the plurality of terminals 5302 via the connector 5215. Then, when the measurement is completed, the measurer 5214 is raised, and the contact between the connector 5215 and the plurality of terminals 5302 is released. Hereinafter, a method in which the measurer 5214 measures the potentials of the plurality of terminals 5302 by bringing the connector 5215 into contact with the plurality of terminals 5302 is referred to as a direct contact potential measuring method as necessary.

In the disposal unit 5216, the reaction cuvette 5300 for which measurement is completed is disposed of. Also, in the disposal unit 5216, the measurement cuvette 7011 for which measurement is completed is disposed of. The disposal unit 5216 according to the present embodiment is provided immediately below the disposal position in the transportation path of the transportation unit 5213. As illustrated in FIG. 42, the disposal unit 5216 according to the present embodiment includes a disposal accommodating portion 7161. The disposal accommodating portion 7161 accommodates the reaction cuvette 5300 or the measurement cuvette 7011 for which measurement is completed. That is, the disposal accommodating portion 7161 has a role of a waste box and accumulates the plurality of disposed reaction cuvettes 5300 and/or measurement cuvettes 7011. When a certain amount of the reaction cuvettes 5300 and/or the measurement cuvettes 7011 is accumulated in the disposal accommodating portion 7161, the user takes out the accumulated reaction cuvettes 5300 and/or measurement cuvettes 7011 together with the disposal accommodating portion 7161 and sets the new empty disposal accommodating portion 7161 at the same position. The disposal unit 5216 is an example of a reaction cuvette disposal container in the present embodiment.

The detector 5217 is a sensor that detects the amount of the reaction cuvettes 5300 disposed of in the disposal unit 5216. The detector 5217 according to the present embodiment detects the amount of the reaction cuvettes 5300 and/or the measurement cuvettes 7011 disposed of in the disposal accommodating portion 7161. The detector 5217 is, for example, an optical sensor or a weight sensor. The detector 5217 outputs, to the control circuitry 5009, a detection result of the amount of the reaction cuvettes 5300 and/or the measurement cuvettes 7011 disposed of in the disposal accommodating portion 7161.

The control circuitry 5009 illustrated in FIG. 41 executes the control program stored in the storage circuitry 5008 and realizes a function corresponding to the program. For example, the control circuitry 5009 has a system control function 5091, a temperature control function 5092, a transportation control function 5093, and a reporting function 5094 by executing the control program. Note that in the present embodiment, a case where the system control function 5091, the temperature control function 5092, the transportation control function 5093, and the reporting function 5094 are realized by a single processor is described, but the present invention is not limited thereto. For example, the various functions may be realized by configuring a control circuitry by combining a plurality of independent processors and executing the control program by each processor.

The system control function 5091 is a function of integrally controlling each unit in the automatic analyzing apparatus 5001 based on input information input from the input interface 5005. For example, in the system control function 5091, the control circuitry 5009 controls the drive mechanism 5004 and the analysis mechanism 5002 to control the sample dispensing arm 5206 or the reagent dispensing arm 5208 and dispense a sample, a reagent, a diluent, or the like to the reaction cuvette 5300 or the measurement cuvette 7011, and controls the analysis circuitry 5003 to perform analysis according to the test item.

The temperature control function 5092 controls the temperature of the sample or the mixture liquid accommodated in the reaction cuvette 5300. For example, the temperature control function 5092 controls the thermostatic unit 5202 so that the sample or the mixture liquid accommodated in the reaction cuvette 5300 has a predetermined temperature.

The transportation control function 5093 is a function of controlling the up-down movement in the vertical direction and rotation in the horizontal direction of the transportation unit 5213 by controlling the drive mechanism 5004. Specifically, the transportation control function 5093 controls the transportation unit 5213 to transport the reaction cuvette 5300 to the reaction disk 5201. In addition, the transportation control function 5093 according to the present embodiment controls the transportation unit 5213 to transport the measurement cuvette 7011 to the reaction disk 5201. In addition, the transportation control function 5093 according to the present embodiment controls the transportation unit 5213 to transport the reaction cuvette 5300 or the measurement cuvette 7011 for which measurement is completed from the reaction disk 5201 to the disposal position. Furthermore, the transportation control function 5093 according to the present embodiment selects either the reaction cuvette 5300 or the measurement cuvette 7011 based on the measurement item of the sample and controls the transportation unit 5213 to transport the selected reaction cuvette 5300 or measurement cuvette 7011 to the reaction disk 5201.

Based on the detection result of the detector 5217, when the amount of the reaction cuvettes 5300 disposed of in the disposal unit 5216 is a predetermined amount or more, the reporting function 5094 reports to the user. Since the measurement cuvettes 7011 are also disposed of in the disposal accommodating portion 7161 according to the present embodiment, when the amount of the reaction cuvettes 5300 and/or the measurement cuvettes 7011 disposed of in the disposal accommodating portion 7161 is the predetermined amount or more based on the detection result of the detector 5217, the reporting function 5094 according to the present embodiment reports to the user via the output interface 5006 or the communication interface 5007.

Note that the system control function 5091, the temperature control function 5092, the transportation control function 5093, and the reporting function 5094 illustrated in FIG. 41 configure a system control unit, a temperature control unit, a transportation control unit, and a reporting unit in the present embodiment, respectively.

Also, the analysis circuitry 5003 illustrated in FIG. 41 executes the operation program stored in the storage circuitry 5008 and realizes a function corresponding to the program. For example, the analysis circuitry 5003 realizes a calibration data generating function 5031 and an analysis data generating function 5032 by executing the operation program. Note that in the present embodiment, a case where the calibration data generating function 5031 and the analysis data generating function 5032 are realized by a single processor is described, but the present invention is not limited thereto. For example, the calibration data generating function 5031 and the analysis data generating function 5032 may be realized by configuring an analysis circuitry by combining a plurality of independent processors and executing the operation program by each processor.

The calibration data generating function 5031 is a function of generating calibration data based on the standard data generated by the analysis mechanism 5002. Specifically, when receiving the standard data generated by the analysis mechanism 5002, the analysis circuitry 5003 executes the calibration data generating function 5031. When the calibration data generating function 5031 is executed, the analysis circuitry 5003 generates a calibration curve based on standard data which is measurement data including absorbances related to standard samples having a plurality of different concentrations. The generated calibration curve is stored in the storage circuitry 5008 as calibration data.

The analysis data generating function 5032 is a function of generating analysis data by analyzing the test data generated by the analysis mechanism 5002. Specifically, when receiving the test data generated by the analysis mechanism 5002, the analysis circuitry 5003 executes the analysis data generating function 5032. When the analysis data generating function 5032 is executed, the analysis circuitry 5003 reads calibration data including information on the calibration curve from the storage circuitry 5008. The analysis circuitry 5003 generates analysis data including information on the concentration of the detection target of the test sample based on the test data and the calibration data.

When data of the potential measured by the measurer 5214 is acquired from the measurer 5214 as the test data, the analysis data generating function 5032 according to the present embodiment calculates the concentration of the target substance in the blood specimen or the mixture liquid accommodated in the reaction cuvette 5300 based on the potential measured by the measurer 5214. Specifically, the analysis data generating function 5032 calculates the concentration of the target substance in the blood specimen or the mixture liquid accommodated in the reaction cuvette 5300 as the analysis data based on the potential measured by the measurer 5214 and the calibration data. Then, the analysis data generating function 5032 outputs the calculation result to the control circuitry 5009. That is, it can be seen that the analysis data generating function 5032 of the analysis circuitry 5003 functions as a calculator when calculating the concentration of the target substance in the blood specimen or the mixture liquid.

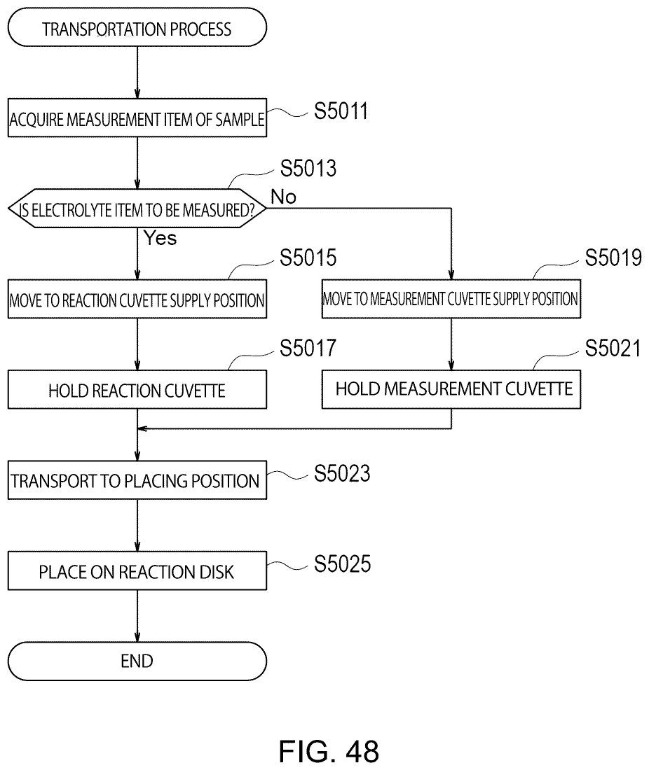

Next, a transportation process according to the present embodiment is described with reference to FIG. 48. FIG. 48 is a flowchart showing contents of a transportation process executed by the automatic analyzing apparatus 5001 according to the present embodiment. In the transportation process, the reaction cuvette 5300 or the measurement cuvette 7011 is transported to the reaction disk 5201. For example, the transportation process is a process executed at a timing when the blood specimen is tested.

As illustrated in FIG. 48, first, the automatic analyzing apparatus 5001 acquires a measurement item of a sample (step S5011). Specifically, the transportation control function 5093 in the control circuitry 5009 of the automatic analyzing apparatus 5001 acquires information on the measurement item from the test order of the sample stored in the storage circuitry 5008.

Next, as illustrated in FIG. 48, the automatic analyzing apparatus 5001 determines whether the electrolyte item is to be measured (step S5013). Specifically, the transportation control function 5093 in the control circuitry 5009 of the automatic analyzing apparatus 5001 determines whether the electrolyte item is to be measured by determining whether the measurement item of the sample acquired in step S5011 includes the electrolyte item. That is, the automatic analyzing apparatus 5001 selects the reaction cuvette 5300 or the measurement cuvette 7011 by determining whether the electrolyte item is included.

Then, when the electrolyte item is to be measured in step S5013 (step S5013: Yes), the automatic analyzing apparatus 5001 moves the transportation unit 5213 to the reaction cuvette supply position (step S5015). Specifically, the transportation control function 5093 in the control circuitry 5009 of the automatic analyzing apparatus 5001 rotates the transportation arm of the transportation unit 5213 by the drive mechanism 5004 to move the holder of the transportation unit 5213 to the reaction cuvette supply position.

Next, as illustrated in FIG. 48, the automatic analyzing apparatus 5001 holds the reaction cuvette 5300 (step S5017). Specifically, the transportation control function 5093 in the control circuitry 5009 of the automatic analyzing apparatus 5001 controls the holder of the transportation unit 5213 at the reaction cuvette supply position to hold the reaction cuvette 5300.

Meanwhile, in step S5013, when the electrolyte item is not to be measured in step S5013 (step S5013: No), the automatic analyzing apparatus 5001 moves the transportation unit 5213 to the measurement cuvette supply position (step S5019). Specifically, the transportation control function 5093 in the control circuitry 5009 of the automatic analyzing apparatus 5001 rotates the transportation arm of the transportation unit 5213 by the drive mechanism 5004 to move the holder of the transportation unit 5213 to the measurement cuvette supply position.

Next, as illustrated in FIG. 48, the automatic analyzing apparatus 5001 causes the holder of the transportation unit 5213 to hold the measurement cuvette 7011 (step S5021). Specifically, the transportation control function 5093 in the control circuitry 5009 of the automatic analyzing apparatus 5001 controls the holder of the transportation unit 5213 at the measurement cuvette supply position to hold the measurement cuvette 7011.

Next, after step S5017 or step S5021, as illustrated in FIG. 48, the automatic analyzing apparatus 5001 transports the reaction cuvette 5300 or the measurement cuvette 7011 to the placing position (step S5023). Specifically, the transportation control function 5093 in the control circuitry 5009 of the automatic analyzing apparatus 5001 rotates the transportation arm of the transportation unit 5213 by the drive mechanism 5004 to transport the reaction cuvette 5300 or the measurement cuvette 7011 held by the holder of the transportation unit 5213 to the placing position on the reaction disk 5201.

Next, the automatic analyzing apparatus 5001 controls the transportation unit 5213 to place the reaction cuvette 5300 or the measurement cuvette 7011 on the reaction disk 5201 (step S5025). Specifically, the transportation control function 5093 in the control circuitry 5009 of the automatic analyzing apparatus 5001 controls the holder of the transportation unit 5213 to release the holding of the reaction cuvette 5300 or the measurement cuvette 7011 and inserts the reaction cuvette 5300 or the measurement cuvette 7011 into the reaction disk 5201, thereby placing the reaction cuvette 5300 or the measurement cuvette 7011 on the reaction disk 5201. In step S5025, the transportation control function 5093 places the reaction cuvette 5300 on the reaction disk 5201 such that the plurality of terminals 5302 provided in the reaction cuvette 5300 are positioned at positions where the plurality of terminals 5302 can come into contact with the connector 5215 when the reaction cuvette 5300 is transported to the potential measuring position. By step S5025, the transportation process according to the present embodiment is ended.

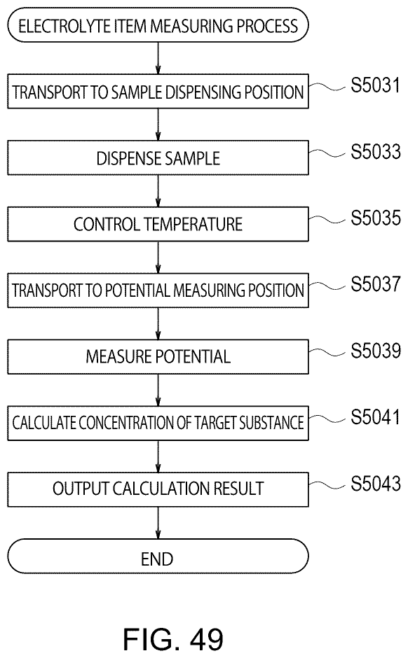

Next, an electrolyte item measuring process executed by the automatic analyzing apparatus 5001 according to the present embodiment is described with reference to FIG. 49. FIG. 49 is a flowchart showing contents of the electrolyte item measuring process executed by the automatic analyzing apparatus 5001 according to the present embodiment. In the electrolyte item measuring process, the potential of the sample or the mixture liquid is measured using the reaction cuvette 5300, and the concentration of the target substance in the sample or the mixture liquid is calculated. For example, the electrolyte item measuring process is a process executed at a timing when the electrolyte item is measured.

As shown in FIG. 49, first, the automatic analyzing apparatus 5001 transports the reaction cuvette 5300 to the sample dispensing position (step S5031). Specifically, the system control function 5091 in the control circuitry 5009 of the automatic analyzing apparatus 5001 controls the reaction disk 5201 to transport the reaction cuvette 5300 to the sample dispensing position.

Next, as illustrated in FIG. 49, the automatic analyzing apparatus 5001 dispenses a sample (step S5033). Specifically, the system control function 5091 in the control circuitry 5009 of the automatic analyzing apparatus 5001 controls the sample dispensing arm 5206 and the sample dispensing probe 5207 to dispense the sample into the reaction cuvette 5300 transported to the sample dispensing position.

Next, as illustrated in FIG. 49, the automatic analyzing apparatus 5001 controls the temperature (step S5035). Specifically, the temperature control function 5092 in the control circuitry 5009 of the automatic analyzing apparatus 5001 controls the thermostatic unit 5202 to control the temperature of the sample dispensed into the reaction cuvette 5300 in step S5033 to a predetermined temperature.

Next, as illustrated in FIG. 49, the automatic analyzing apparatus 5001 transports the reaction cuvette 5300 to the potential measuring position (step S5037). Specifically, the system control function 5091 in the control circuitry 5009 of the automatic analyzing apparatus 5001 controls the reaction disk 5201 to transport the reaction cuvette 5300 to the potential measuring position.

Next, as illustrated in FIG. 49, the automatic analyzing apparatus 5001 measures the potential (step S5039). Specifically, the system control function 5091 in the control circuitry 5009 of the automatic analyzing apparatus 5001 controls the measurer 5214 to lower the measurer 5214 and the connector 5215 and bring the connector 5215 into contact with the plurality of terminals 5302 of the reaction cuvette 5300. As a result, the system control function 5091 causes the measurer 5214 to measure the potentials of the plurality of terminals 5302 via the connector 5215. In the present embodiment, the system control function 5091 measures the plurality of potentials of the ISEs 8021 to 8023 in one contact operation by bringing each of the connection terminals of the connector 5215 into contact with each of the ISEs 8021 to 8023 and the reference electrode 8024, which are the plurality of terminals 5302 provided in the reaction cuvette 5300. Then, the measurer 5214 outputs the measured potential to the analysis circuitry 5003. Note that, in the present embodiment, the measurer 5214 measures the plurality of potentials in one contact operation, but the potential may be measured for each measurement item. For example, after each of the connection terminals of the connectors 5215 is brought into contact with each of the ISE 8021 and the reference electrode 8024 to measure the potential of the ISE 8021, each of the connection terminals of the connectors 5215 is brought into contact with each of the ISE 8022 and the reference electrode 8024 to measure the potential of the ISE 8022.

Next, as illustrated in FIG. 49, the automatic analyzing apparatus 5001 calculates the concentration of the target substance (step S5041). Specifically, the system control function 5091 in the control circuitry 5009 of the automatic analyzing apparatus 5001 controls the analysis data generating function 5032 in the analysis circuitry 5003 to calculate the concentration of the target substance based on the potential measured in step S5039. In the present embodiment, the analysis data generating function 5032 calculates the concentrations of sodium ions, potassium ions, and chlorine ions based on the potential measured by the measurer 5214. Then, the analysis data generating function 5032 outputs the calculation result to the control circuitry 5009.

Next, as illustrated in FIG. 49, the automatic analyzing apparatus 5001 outputs the calculation result (step S5043). Specifically, the system control function 5091 in the control circuitry 5009 of the automatic analyzing apparatus 5001 outputs the calculation result of the concentration of the target substance via the output interface 5006 or the communication interface 5007. By step S5043, the electrolyte item measuring process according to the present embodiment is ended.

After the electrolyte item measuring process is ended, the automatic analyzing apparatus 5001 according to the present embodiment moves the reaction cuvette 5300 or the measurement cuvette 7011 for which measurement is completed to a predetermined position by the reaction disk 5201. Then, the automatic analyzing apparatus 5001 causes the transportation unit 5213 to move the reaction cuvette 5300 or the measurement cuvette 7011 moved to a predetermined position to the disposal position and disposes of the reaction cuvette 5300 or the measurement cuvette 7011 in the disposal unit 5216.

In the example shown in FIG. 49, the automatic analyzing apparatus 5001 measures the electrolyte item using the sample, but the sample and the reagent, or the sample and the diluent may be dispensed into the reaction cuvette 5300 to measure the electrolyte item using the mixture liquid.

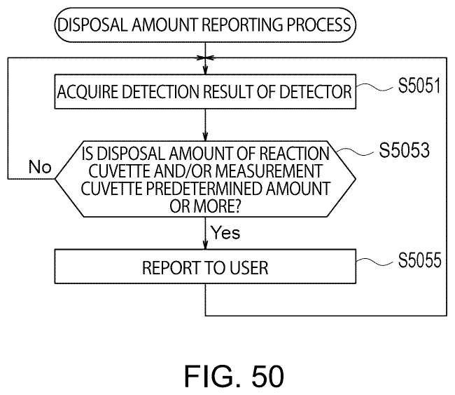

FIG. 50 is a flowchart showing contents of a disposal amount reporting process executed by the automatic analyzing apparatus 5001 according to the present embodiment. In the disposal amount reporting process, when the amount of the reaction cuvette 5300 and/or measurement cuvette 7011 disposed of in the disposal unit 5216 is the predetermined amount or more, report to the user is performed. For example, the disposal amount reporting process is a process executed while the power of the automatic analyzing apparatus 5001 is turned on.

As illustrated in FIG. 50, first, in the disposal amount reporting process executed by the automatic analyzing apparatus 5001 according to the present embodiment, the automatic analyzing apparatus 5001 acquires the detection result of the detector 5217 (step S5051). Specifically, the reporting function 5094 in the control circuitry 5009 of the automatic analyzing apparatus 5001 acquires the detection result of the amount of the reaction cuvettes 5300 and/or the measurement cuvettes 7011 disposed of in the disposal accommodating portion 7161.

Next, as illustrated in FIG. 50, the automatic analyzing apparatus 5001 determines whether the disposal amount of the reaction cuvettes 5300 and/or measurement cuvettes 7011 is the predetermined amount or more (step S5053). Specifically, the reporting function 5094 in the control circuitry 5009 of the automatic analyzing apparatus 5001 determines whether the amount of the reaction cuvettes 5300 and/or the measurement cuvettes 7011 disposed of in the disposal accommodating portion 7161 is the predetermined amount or more based on the detection result of the detector 5217 in step S5051.

Then, in step S5053, when the amount of the reaction cuvette 5300 and/or the measurement cuvette 7011 is not the predetermined amount or more (step S5053: No), the automatic analyzing apparatus 5001 acquires the detection result of the detector 5217, repeats steps S5051 and S5053 until the amount of the reaction cuvettes 5300 and/or the measurement cuvettes 7011 disposed of in the disposal accommodating portion 7161 becomes the predetermined amount or more, and stands by.

Meanwhile, when the amount of the reaction cuvettes 5300 and/or the measurement cuvettes 7011 disposed of in the disposal accommodating portion 7161 is the predetermined amount or more (step S5053: Yes), the automatic analyzing apparatus 5001 reports to the user (step S5055). Specifically, the reporting function 5094 in the control circuitry 5009 of the automatic analyzing apparatus 5001 reports, to the user, that the amount of the reaction cuvettes 5300 and/or the measurement cuvettes 7011 disposed of in the disposal accommodating portion 7161 is the predetermined amount or more. By executing step S5055, the disposal amount reporting process according to the present embodiment is ended.

As described above, according to the automatic analyzing apparatus 5001 of the present embodiment, the plurality of terminals 5302 are provided by being integrally formed with the reaction cuvette 5300, and the measurer 5214 measures the potential of the plurality of terminals 5302 provided by being integrally formed with the reaction cuvette 5300 to measure the electrolyte item of the sample, and thus it is not necessary to provide a mechanism for moving the sample to measure the electrolyte item or a dispensing unit for dispensing the sample. As a result, the number of components of the automatic analyzing apparatus 5001 can be reduced while enabling the measurement of the electrolyte item, so that the automatic analyzing apparatus 5001 can be miniaturized.

In addition, since the reaction cuvette 5300 used in the automatic analyzing apparatus 5001 according to the present embodiment is a disposable reaction cuvette, it is possible to prevent the occurrence of carryover in the measurement of the electrolyte item.

Furthermore, in the automatic analyzing apparatus 5001 according to the present embodiment, since the temperature of the sample or the mixture liquid accommodated in the reaction cuvette 5300 is controlled using the thermostatic unit 5202 included in the automatic analyzing apparatus 5001, it is not necessary to provide a separate thermostatic mechanism for controlling the temperature of the sample or the mixture liquid when measuring the electrolyte item. As a result, the number of components of the automatic analyzing apparatus 5001 can be reduced while enabling the measurement of the electrolyte item, so that the automatic analyzing apparatus 5001 can be miniaturized.

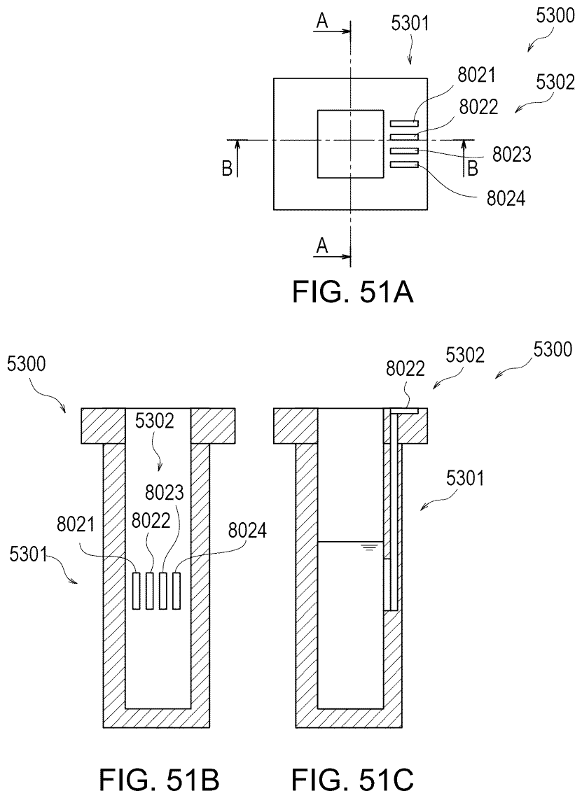

Note that in the fourth embodiment described above, the plurality of terminals 5302 are continuously provided in the cuvette body 5301 to have an L shape from the upper surface to the inner wall surface of the cuvette body 5301, but the configuration of the plurality of terminals 5302 is not limited thereto. FIGS. 51A to 51C are diagrams illustrating another example of the reaction cuvette 5300 used in the analysis mechanism 5002 illustrated in FIG. 42 in the fourth embodiment and are diagrams corresponding to FIGS. 43A to 43C in the fourth embodiment described above. FIG. 51A is a diagram illustrating the reaction cuvette 5300 when viewed from above, FIG. 51B is a cross-sectional view taken along line A-A in FIG. 51A, and FIG. 51C is a cross-sectional view taken along line B-B in FIG. 51A. As illustrated in FIGS. 51A to 51C, also in the example illustrated in FIGS. 51A to 51C, the plurality of terminals 5302 are provided in the cuvette body 5301 by being integrally formed with the cuvette body 5301. In the example illustrated in FIGS. 51A to 51C, one end of each of the plurality of terminals 5302 is exposed on the inner wall surface of the cuvette body 5301, the other end of each of the plurality of terminals 5302 is exposed on the upper surface of the reaction cuvette 5300, and the other portion of each of the plurality of terminals 5302 is provided inside the cuvette body 5301.

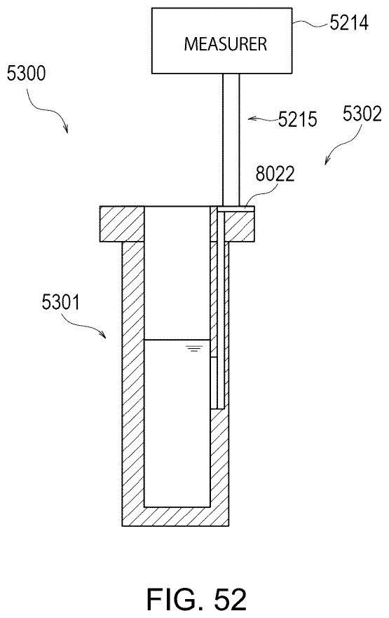

FIG. 52 is a diagram illustrating another example of the method of measuring a potential by the measurer 5214 according to the fourth embodiment and is a diagram corresponding to FIG. 47 in the fourth embodiment described above. As illustrated in FIG. 52, even when the electrolyte item is measured using the reaction cuvette 5300 illustrated in FIGS. 51A to 51C in the analysis mechanism 5002, the connector 5215 comes into contact with each of the plurality of terminals 5302 exposed on the upper surface of the reaction cuvette 5300, so that the plurality of terminals 5302 and the measurer 5214 are brought into a conductive state. As a result, the measurer 5214 can measure the potentials of the plurality of terminals 5302 via the connector 5215.

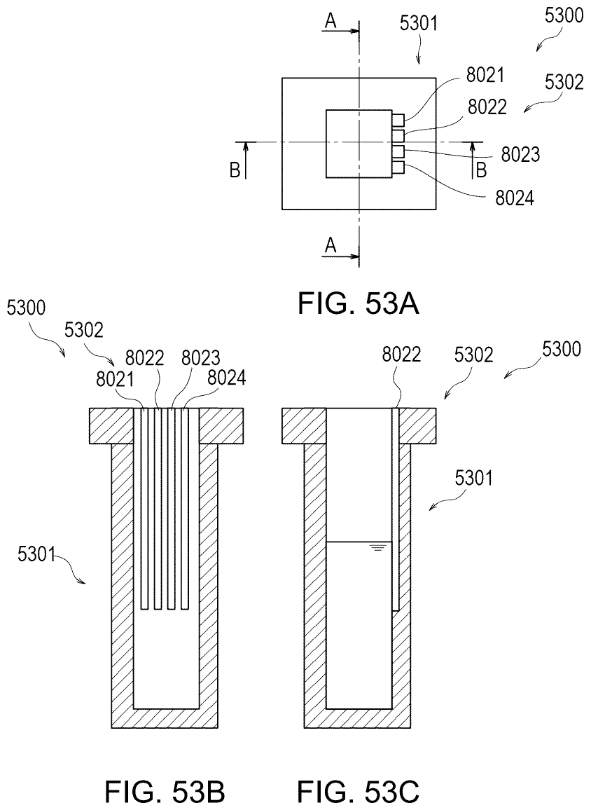

Also, FIGS. 53A to 53C are diagrams illustrating another example of the reaction cuvette 5300 used in the analysis mechanism 5002 illustrated in FIG. 42 in the fourth embodiment and are diagrams corresponding to FIGS. 43A to 43C in the fourth embodiment described above. FIG. 53A is a diagram illustrating the reaction cuvette 5300 when viewed from above, FIG. 53B is a cross-sectional view taken along line A-A in FIG. 53A, and FIG. 53C is a cross-sectional view taken along line B-B in FIG. 53A. As illustrated in FIGS. 53A to 53C, also in the example illustrated in FIGS. 53A to 53C, the plurality of terminals 5302 are provided in the cuvette body 5301 by being integrally formed with the cuvette body 5301. In the example illustrated in FIGS. 53A to 53C, the plurality of terminals 5302 are provided on one inner wall surface of the cuvette body 5301 so that the longitudinal direction of the plurality of terminals 5302 is perpendicular to the opening of the cuvette body 5301.

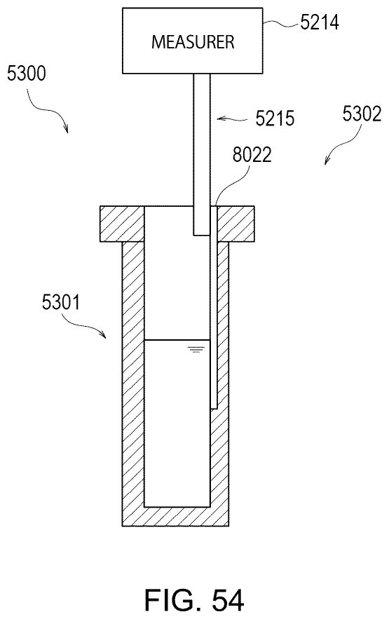

FIG. 54 is a diagram illustrating another example of the method of measuring a potential by the measurer 5214 according to the fourth embodiment and is a diagram corresponding to FIG. 47 in the fourth embodiment described above. As illustrated in FIG. 54, when the electrolyte item is measured using the reaction cuvette 5300 illustrated in FIGS. 53A to 53C in the analysis mechanism 5002, the plurality of terminals 5302 are hardly exposed to the outside on the upper surface of the reaction cuvette 5300. Therefore, in the example illustrated in FIG. 54, to ensure contact between the plurality of terminals 5302 and the connector 5215, the automatic analyzing apparatus 5001 inserts the connector 5215 into the reaction cuvette 5300 and brings the side surface of the connector 5215 into contact with the plurality of terminals 5302. As a result, the plurality of terminals 5302 and the measurer 5214 are brought into a conductive state. As a result, the measurer 5214 can measure the potentials of the plurality of terminals 5302 via the connector 5215.

When the measurement of the electrolyte item is performed using the reaction cuvette 5300 illustrated in FIGS. 53A to 53C, the measurer 5214 may move in the horizontal direction, for example, along with up-down movement in the vertical direction. That is, in the example illustrated in FIG. 54, the measurer 5214 is configured to be movable in the horizontal direction together with the up-down movement in the vertical direction. As a result, the automatic analyzing apparatus 5001 can insert the connector 5215 into the reaction cuvette 5300 and bring the side surface of the connector 5215 into contact with the plurality of terminals 5302.

When the measurement of the electrolyte item is performed using the reaction cuvette 5300 illustrated in FIGS. 53A to 53C, the measurer 5214 moves up and down in the vertical direction and moves in the horizontal direction, but when the measurement of the electrolyte item is performed using the reaction cuvette 5300 illustrated in FIGS. 53A to 53C, the movement of the measurer 5214 is not limited to the up-down movement in the vertical direction and the movement in the horizontal direction.

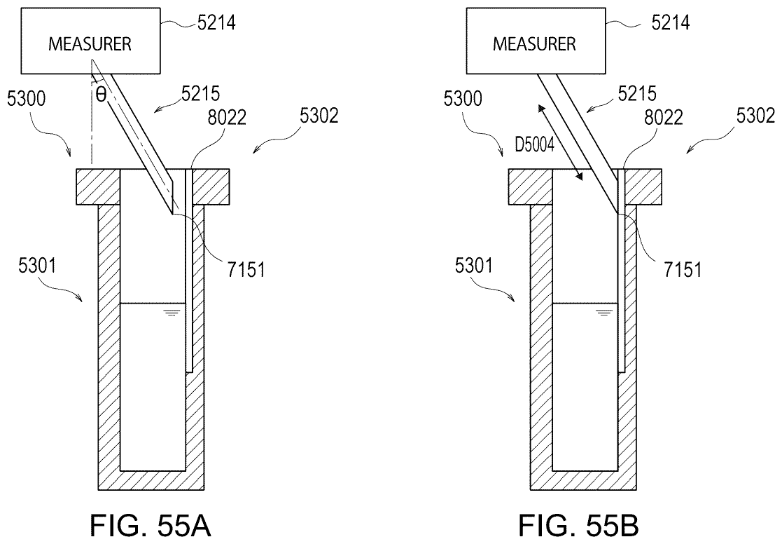

For example, the measurer 5214 moves in an oblique direction to move the connector 5215 in the oblique direction, and the connector 5215 and the plurality of terminals 5302 may be brought into contact with each other. FIGS. 55A and 55B are diagrams illustrating another example of the method of measuring a potential by the measurer 5214 according to the fourth embodiment and are diagrams corresponding to FIG. 54 in the fourth embodiment described above. FIG. 55A is a diagram illustrating a state in which the connector 5215 is moved, and FIG. 55B is a diagram illustrating a state in which the connector 5215 is in contact with the plurality of terminals 5302.

As illustrated in FIG. 55A, the connector 5215 illustrated in FIGS. 55A and 55B is inclined to have an angle θ with respect to the vertical direction and is electrically connected to the measurer 5214. An end surface 7151 of the connector 5215 is parallel to the contact surfaces of the plurality of terminals 5302, for example, to increase the contact area with the plurality of terminals 5302. In the example illustrated in FIG. 55A, to bring the plurality of terminals 5302 into contact with the connector 5215, the automatic analyzing apparatus 5001 moves the measurer 5214 in a direction D5004 as illustrated in FIG. 55B, thereby inserting the connector 5215 into the reaction cuvette 5300 and bringing the end surface 7151 of the connector 5215 into contact with the plurality of terminals 5302. As a result, the plurality of terminals 5302 and the measurer 5214 are brought into a conductive state. As a result, the measurer 5214 can measure the potentials of the plurality of terminals 5302 via the connector 5215. That is, as illustrated in FIGS. 55A and 55B, the measurer 5214 may be configured to be movable in an oblique direction.

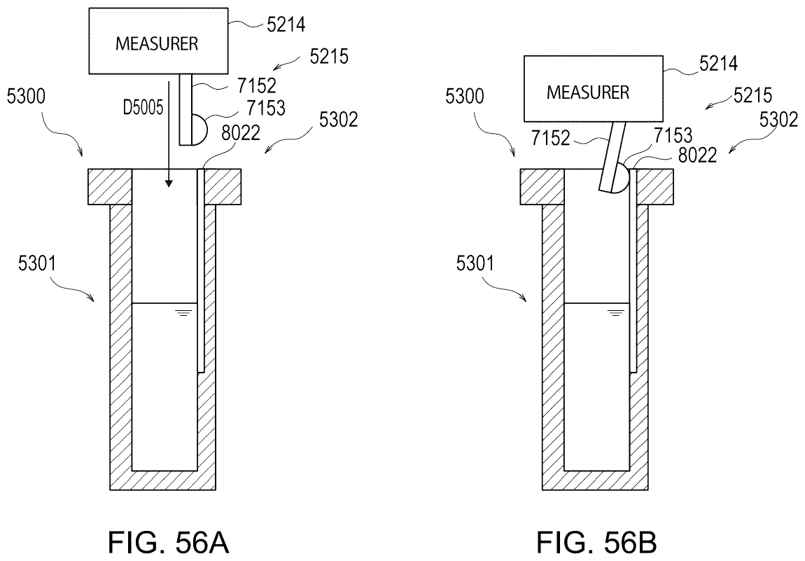

In addition, for example, the connector 5215 may be formed of an elastic material, the measurer 5214 may move in the vertical direction to move the connector 5215 in the vertical direction, and the connector 5215 and the plurality of terminals 5302 may be brought into contact with each other. FIGS. 56A and 56B are diagrams illustrating another example of the method of measuring a potential by the measurer 5214 according to the fourth embodiment and are diagrams corresponding to FIG. 54 in the fourth embodiment described above. FIG. 56A is a diagram illustrating a state in which the connector 5215 is moved, and FIG. 56B is a diagram illustrating a state in which the connector 5215 is in contact with the plurality of terminals 5302.

As illustrated in FIG. 56A, the connector 5215 illustrated in FIGS. 56A and 56B includes a connection shaft 7152 and a contact portion 7153. The connection shaft 7152 is electrically connected to the measurer 5214, for example, and is configured with a conductive material having elasticity. The contact portion 7153 is provided on a side surface of the connection shaft 7152 and in the vicinity of one end of the connection shaft 7152. The contact portion 7153 is formed of a conductive material. Note that the contact portion 7153 may be formed of a conductive material having elasticity. In the example illustrated in FIGS. 56A and 56B, to bring the plurality of terminals 5302 into contact with the connector 5215, the automatic analyzing apparatus 5001 lowers the measurer 5214 in a direction D5005, that is, in the vertical direction as illustrated in FIGS. 56A and 56B, thereby inserting the connector 5215 into the reaction cuvette 5300 and bringing the contact portion 7153 of the connector 5215 into contact with the plurality of terminals 5302. Here, as illustrated in FIG. 56B, since the connection shaft 7152 of the connector 5215 has elasticity, the measurer 5214 can be lowered in the vertical direction while bringing the contact portion 7153 into contact with the plurality of terminals 5302. As a result, the plurality of terminals 5302 and the measurer 5214 are brought into a conductive state. As a result, the measurer 5214 can measure the potentials of the plurality of terminals 5302 via the connector 5215. That is, as illustrated in FIGS. 56A and 56B, the measurer 5214 may be configured to be movable in the vertical direction.

As described above, as illustrated in FIGS. 55A to 56B, when the measurement of the electrolyte item is performed using the reaction cuvette 5300 illustrated in FIGS. 53A to 53C, the moving direction of the measurer 5214 is not limited to the up-down movement in the vertical direction and the movement in the horizontal direction, and may be the movement only by the up-down movement in the vertical direction or the movement in the oblique direction. That is, the moving direction of the measurer 5214 is arbitrary.

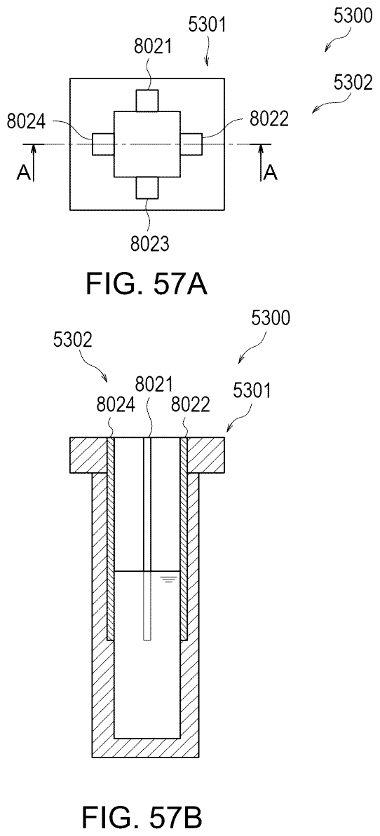

In the fourth embodiment described above, the plurality of terminals 5302 are provided on one inner wall surface of the reaction cuvette 5300, but the plurality of terminals 5302 may be provided in the reaction cuvette 5300 by providing each of the plurality of terminals 5302 on each of a plurality of inner wall surfaces of the reaction cuvette 5300. FIGS. 57A and 57B are diagrams illustrating another example of the reaction cuvette 5300 used in the analysis mechanism 5002 illustrated in FIG. 42 in the fourth embodiment and are diagrams corresponding to FIGS. 43A to 43C in the fourth embodiment described above. FIG. 57A is a diagram illustrating the reaction cuvette 5300 when viewed from above, and FIG. 57B is a cross-sectional view taken along line A-A in FIG. 57A. As illustrated in FIGS. 57A and 57B, also in the example illustrated in FIGS. 57A and 57B, the plurality of terminals 5302 are provided in the cuvette body 5301 by being integrally formed with the cuvette body 5301. In the example illustrated in FIGS. 57A and 57B, each of the ISEs 8021 to 8023 and the reference electrode 8024 is provided on each of four inner wall surfaces of the cuvette body 5301 having a straight cylindrical shape.

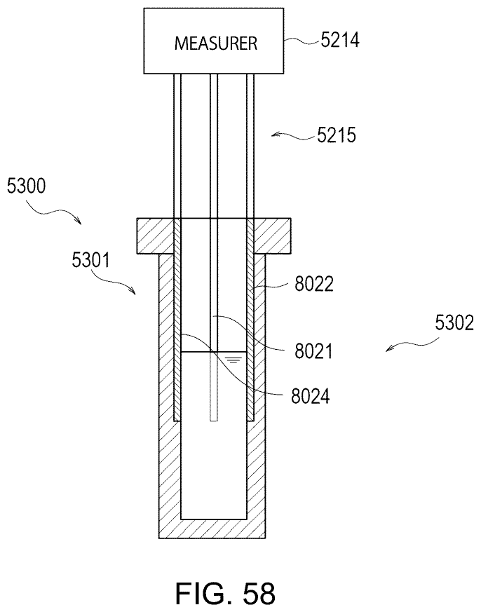

FIG. 58 is a diagram illustrating another example of the method of measuring a potential by the measurer 5214 according to the fourth embodiment and is a diagram corresponding to FIG. 47 in the fourth embodiment described above. As illustrated in FIG. 58, when the measurement of the electrolyte item is performed by using the reaction cuvette 5300 illustrated in FIGS. 57A and 57B in the analysis mechanism 5002, the connection terminal of the connector 5215 is configured to come into contact with each of the ISEs 8021 to 8023 and the reference electrode 8024 provided on each of the four inner wall surfaces of the cuvette body 5301 having a straight cylindrical shape. Therefore, the automatic analyzing apparatus 5001 can lower the measurer 5214 to bring the connection terminal of the connector 5215 into contact with the plurality of terminals 5302 exposed on the upper surface of the reaction cuvette 5300. As a result, the plurality of terminals 5302 and the measurer 5214 are brought into a conductive state. As a result, the measurer 5214 can measure the potentials of the plurality of terminals 5302 via the connector 5215.

In the fourth embodiment described above, the storage container 5211 stores the reaction cuvette 5300 provided with the plurality of integrally formed terminals 5302 and the measurement cuvette 7011 for measuring an item other than the concentration of the target substance in the sample or the mixture liquid, and selects the cuvette to be transported to the reaction disk 5201 according to the measurement item of the sample, but the storage container 5211 may store only the reaction cuvette 5300 provided with the plurality of integrally formed terminals 5302. Then, the automatic analyzing apparatus 5001 uses only the reaction cuvette 5300 regardless of the measurement item of the sample and does not need to include the measurement cuvette storage container 7112 and the measurement cuvette supplier 7122. Therefore, the automatic analyzing apparatus 5001 can be miniaturized.

In the fourth embodiment described above, the reaction cuvette 5300 and the measurement cuvette 7011 are supplied to the reaction cuvette supply position and the measurement cuvette supply position, respectively, but the present invention is not limited thereto. The reaction cuvette 5300 and the measurement cuvette 7011 may be supplied to one supply position. Then, T a supplying mechanism (not illustrated) for supplying the reaction cuvette 5300 supplied from the reaction cuvette storage container 7111 or the measurement cuvette 7011 supplied from the measurement cuvette storage container 7112 to the supply position may be provided. Then, the transportation control function 5093 selects either the reaction cuvette 5300 supplied from the reaction cuvette storage container 7111 and the measurement cuvette 7011 supplied from the measurement cuvette storage container 7112 according to the measurement item of the sample and controls the supply mechanism to supply the selected reaction cuvette 5300 or measurement cuvette 7011 to the supply position. Then, the transportation control function 5093 may control the transportation unit 5213 to transport the reaction cuvette 5300 or the measurement cuvette 7011 supplied to the supply position by the supply mechanism to the reaction disk 5201.

### Fifth Embodiment

In the fourth embodiment described above, the automatic analyzing apparatus 5001 measures the concentration of the target substance in the sample or the mixture liquid using the reaction cuvette 5300 provided with the plurality of integrally formed terminals 5302, but the reaction cuvette used for measuring the concentration of the target substance in the sample or the mixture liquid is not limited to the reaction cuvette provided with the plurality of integrally formed terminals 5302. Therefore, the automatic analyzing apparatus 5001 according to a fifth embodiment produces a reaction cuvette by adding a plurality of terminals to a measurement cuvette and measures the concentration of the target substance in the sample or the mixture liquid using the produced reaction cuvette. Hereinafter, portions different from the fourth embodiment described above are described.

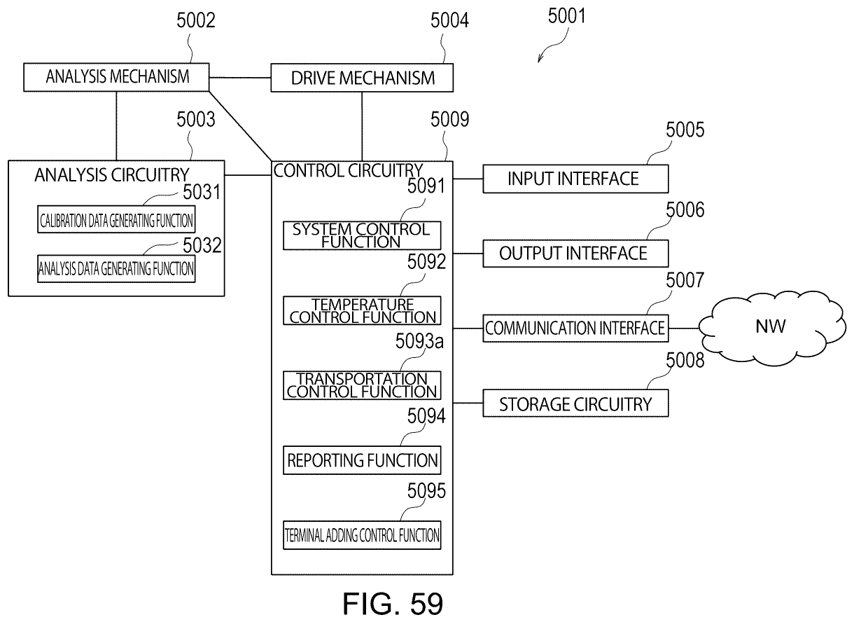

FIG. 59 is a block diagram illustrating an example of a functional configuration of the automatic analyzing apparatus 5001 according to the present embodiment and is a diagram corresponding to FIG. 41 in the fourth embodiment described above. As illustrated in FIG. 59, the automatic analyzing apparatus 5001 according to the present embodiment is configured by adding a terminal adding control function 5095 to the control circuitry 5009 in the automatic analyzing apparatus 5001 according to the fourth embodiment described above. In addition, the function of the transportation control function is different from that of the first embodiment and thus is referred to as a transportation control function 5093a in the present embodiment. Note that the terminal adding control function 5095 corresponds to a terminal addition control unit according to the present embodiment. Also, the configurations and functions other than the terminal adding control function are equivalent to those in FIG. 41 according to the fourth embodiment described above, and thus the description thereof is omitted.

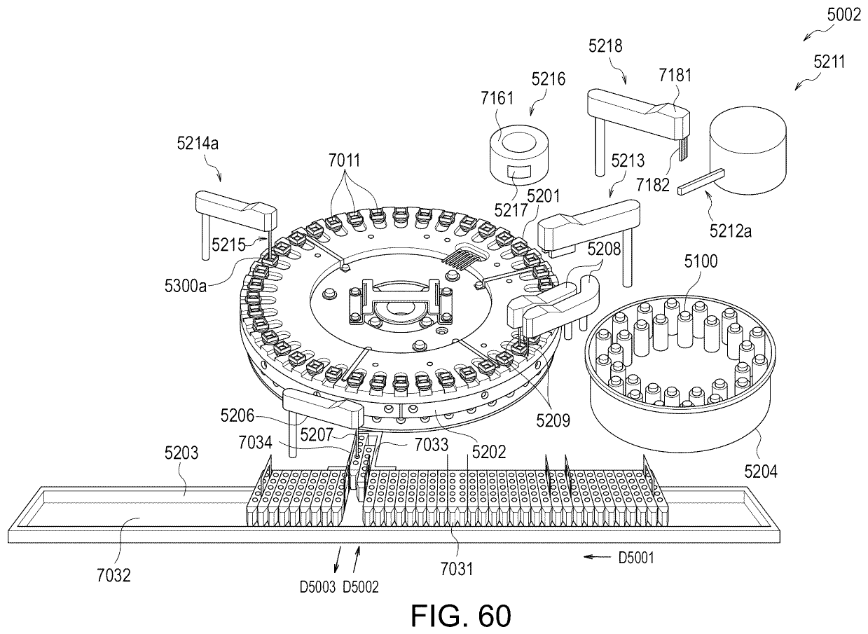

FIG. 60 is a diagram illustrating an example of a configuration of the analysis mechanism according to the fifth embodiment and is a diagram corresponding to FIG. 42 in the fourth embodiment described above. As illustrated in FIG. 60, the analysis mechanism 5002 according to the present embodiment is configured by adding a terminal applier 5218 to the analysis mechanism 5002 according to the fourth embodiment described above. In addition, the configurations of the storage container, the supplier, and the measurer are different from those of the fourth embodiment and thus are referred to as a storage container 5211a, a supplier 5212a, and a measurer 5214a according to the present embodiment. In addition, configurations and functions other than the storage container 5211a, the supplier 5212a, the measurer 5214a, and the terminal applier 5218 are similar to those in FIG. 42 in the fourth embodiment described above, and thus the description thereof is omitted.

The storage container 5211a accommodates the sample or the mixture liquid and stores a measurement cuvette 7011a for measuring each measurement item of the sample or the mixture liquid. Specifically, the storage container 5211a according to the present embodiment stores a plurality of empty measurement cuvettes 7011a. The storage container 5211a is provided in the vicinity of the outer periphery of the reaction disk 5201.

The supplier 5212a supplies the empty measurement cuvette 7011a from the storage container 5211a to the supply position. The supplier 5212a is configured with, for example, a belt, a slider, and a supply rail. Specifically, the supplier 5212a discharges the empty measurement cuvette 7011a from the storage container 5211a to the outside and supplies the measurement cuvette to the supply position. In the example illustrated in FIG. 60, the supplier 5212a is a supply rail provided, for example, to be inclined toward the supply position. Therefore, the measurement cuvette 7011a discharged from the storage container 5211a slides on the supply rail by gravity and moves toward the supply position. The supply position is, for example, a position where a rotating track which is a transportation path of the measurement cuvette 7011a in the transportation unit 5213 and a moving track of the measurement cuvette 7011a on the supplier 5212a intersect.

The measurer 5214a measures the potentials of the plurality of terminals 5302 provided in the reaction cuvette according to the present embodiment. The measurer 5214a according to the present embodiment is provided to be movable up and down in the vertical direction and provided rotatably in the horizontal direction or movably in the horizontal direction. Other configurations are equivalent to the configuration of the measurer 5214 in the fourth embodiment described above, and thus the description thereof is omitted.

The terminal applier 5218 adds the plurality of terminals 5302 to the measurement cuvette 7011a. Specifically, the terminal applier 5218 according to the present embodiment adds the plurality of terminals 5302 to the measurement cuvette 7011a supplied to the supply position by the supplier 5212a. Therefore, the terminal applier 5218 is provided in the vicinity of the supplier 5212a. As illustrated in FIG. 60, the terminal applier 5218 according to the present embodiment includes a terminal transportation arm 7181 and a terminal holder 7182.

The terminal transportation arm 7181 is provided to be movable up and down in the vertical direction and provided rotatably in the horizontal direction or movably in the horizontal direction by the drive mechanism 5004. The terminal transportation arm 7181 includes the terminal holder 7182 at one end.

The terminal holder 7182 holds one or a plurality of terminals added to the measurement cuvette 7011a. The terminal holder 7182 is, for example, a gripper. For example, the terminal holder 7182 according to the present embodiment holds a terminal sheet from a terminal storage container (not illustrated) storing the terminal sheet to which the plurality of terminals 5302 are attached and adds the held terminal sheet to the measurement cuvette 7011a. Therefore, the reaction cuvette according to the present embodiment is produced. The terminal sheet has, for example, the plurality of terminals 5302 attached to one surface and a double-sided tape, an adhesive, or the like for attaching the terminal sheet to the measurement cuvette 7011a on the other surface. Four terminals of the ISEs 8021 to 8023 and the reference electrode 8024 are attached as the plurality of terminals 5302 on one surface of the terminal sheet according to the present embodiment.

In the present embodiment, the terminal applier 5218 adds the plurality of terminals 5302 to the measurement cuvette 7011a by adding the terminal sheet to which the plurality of terminals 5302 are attached to the measurement cuvette 7011a, but the method of adding the plurality of terminals 5302 to the measurement cuvette 7011a is not limited to the case of using the terminal sheet. That is, a method of adding the plurality of terminals 5302 to the measurement cuvette 7011a is arbitrary, and for example, a terminal storage container may be provided for each terminal such as the ISEs 8021 to 8023 and the reference electrode 8024, the terminal applier 5218 may hold the terminal in the terminal storage container in which the necessary terminal is stored based on the measurement item of the sample, and the held terminal may be added to the measurement cuvette 7011a. That is, the terminal applier 5218 may add a plurality of terminals 5302 by adding terminals necessary for measurement one by one to the measurement cuvette 7011a.

The transportation control function 5093a is a function of controlling the up-down movement in the vertical direction and rotation in the horizontal direction of the transportation unit 5213 by controlling the drive mechanism 5004. Specifically, the transportation control function 5093a controls the transportation unit 5213 to transport the reaction cuvette 5300 to the reaction disk 5201. In addition, the transportation control function 5093a according to the present embodiment controls the transportation unit 5213 to transport the measurement cuvette 7011a to the reaction disk 5201. In addition, the transportation control function 5093a according to the present embodiment controls the transportation unit 5213 to transport the reaction cuvette 5300 or the measurement cuvette 7011a for which measurement is completed from the reaction disk 5201 to the disposal position.

The terminal adding control function 5095 controls the terminal applier 5218 to add the plurality of terminals 5302 to the measurement cuvette 7011a. Specifically, the terminal adding control function 5095 controls the terminal applier 5218 to cause the terminal holder 7182 to hold one or a plurality of terminals. Then, the terminal adding control function 5095 controls the terminal applier 5218 to add one or a plurality of terminals held by the terminal holder 7182 to the measurement cuvette 7011a at the supply position.

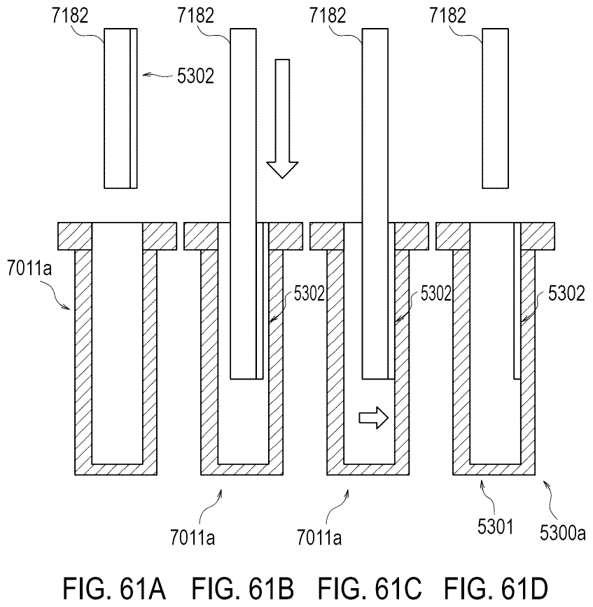

FIGS. 61A to 61D are schematic diagrams illustrating an operation example of the terminal applier 5218 in the automatic analyzing apparatus 5001 according to the present embodiment. As illustrated in FIG. 61A, the terminal adding control function 5095 controls the terminal applier 5218, causes the terminal holder 7182 of the terminal applier 5218 to hold the terminal sheet including the plurality of terminals 5302, and moves the terminal holder 7182 to the supply position. Next, as illustrated in FIG. 61B, the terminal adding control function 5095 controls the terminal applier 5218 to lower the terminal transportation arm 7181 at the supply position and insert the terminal holder 7182 into the measurement cuvette 7011. Next, as illustrated in FIG. 61C, the terminal adding control function 5095 controls the terminal applier 5218 to rotate or move the terminal transportation arm 7181 in the horizontal direction, thereby moving the terminal holder 7182 to the inner wall surface of the measurement cuvette 7011a and bringing the terminal sheet into contact with the inner wall surface. Then, as illustrated in FIG. 61D, the terminal adding control function 5095 controls the terminal applier 5218 to raise the terminal transportation arm 7181 and raise the terminal holder 7182. That is, the plurality of terminals 5302 according to the present embodiment are provided in the cuvette body 5301 by being added to the cuvette body 5301 by the terminal applier 5218 of the automatic analyzing apparatus 5001. As described above, a reaction cuvette 5300a according to the present embodiment is produced by adding the plurality of terminals 5302 to the measurement cuvette 7011a.

The reaction cuvette 5300a and the automatic analyzing apparatus 5001 that analyzes the sample by using the sample or the mixture liquid accommodated in the reaction cuvette 5300a configure an automatic analyzing system according to the present embodiment.

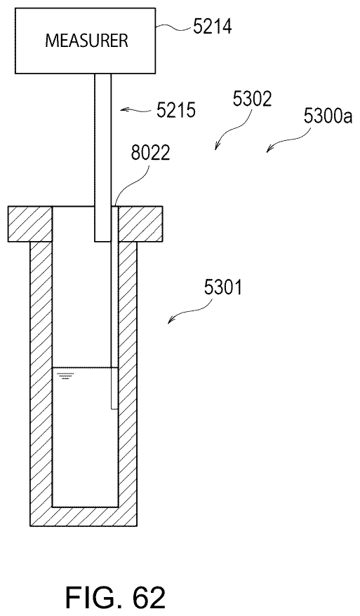

FIG. 62 is a diagram illustrating an example of the method of measuring a potential by the measurer 5214a according to the present embodiment and is a diagram corresponding to FIG. 47 in the fourth embodiment. As illustrated in FIG. 62, when the reaction cuvette 5300a is transported to the potential measuring position by the reaction disk 5201, the system control function 5091 controls the measurer 5214a to lower the measurer 5214a and lower the connector 5215. Then, the system control function 5091 inserts the connector 5215 to the reaction cuvette 5300a and moves the connector 5215 in the horizontal direction by moving the measurer 5214a in the horizontal direction, whereby the side surface of the connector 5215 is brought into contact with the plurality of terminals 5302 provided in the reaction cuvette 5300a. As a result, the plurality of terminals 5302 and the measurer 5214a are brought into a conductive state. As a result, the measurer 5214a measures the potentials of the plurality of terminals 5302 via the connector 5215.

When the measurement of the electrolyte item is performed using the reaction cuvette 5300a illustrated in FIG. 62, the movement of the measurer 5214a is not limited to the up-down movement in the vertical direction and the movement in the horizontal direction. That is, the moving direction of the measurer 5214a is arbitrary. For example, as in FIGS. 55A and 55B in the fourth embodiment described above, the automatic analyzing apparatus 5001 may be configured such that the connector 5215 is inclined to have an angle θ with respect to the vertical direction, the connector 5215 is electrically connected to the measurer 5214a, and the measurer 5214a is moved in an oblique direction. As a result, the automatic analyzing apparatus 5001 may move the measurer 5214a in the oblique direction to bring the end surface 7151 of the connector 5215 into contact with the plurality of terminals 5302.

In addition, similarly to FIGS. 56A and 56B in the fourth embodiment described above, the automatic analyzing apparatus 5001 includes the connector 5215 which is electrically connected to the measurer 5214 and includes the connection shaft 7152 configured with an elastic conductive material and the contact portion 7153 which is provided on the side surface of connection shaft 7152 and in the vicinity of one end of the connection shaft 7152 and is formed of a conductive material, and may lower the measurer 5214a in the vertical direction to bring the contact portion 7153 of the connector 5215 into contact with the plurality of terminals 5302 while inserting the connector 5215 to the reaction cuvette 5300.

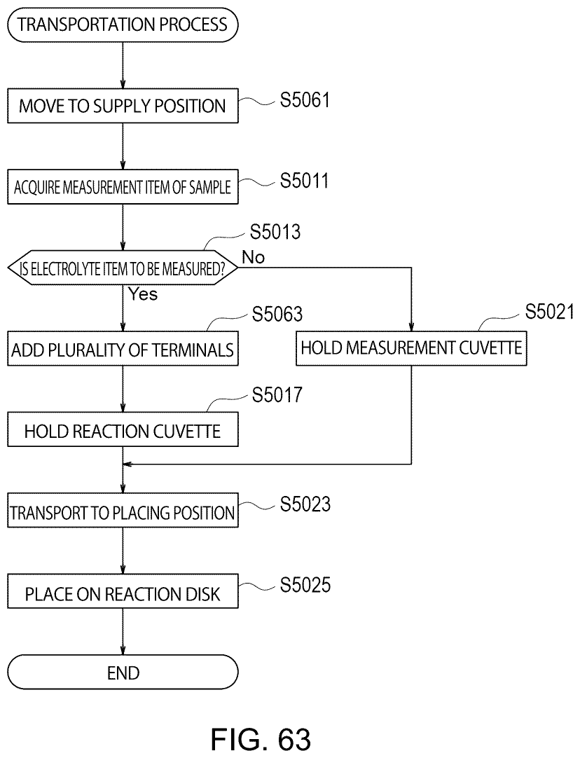

Next, a transportation process according to the present embodiment is described with reference to FIG. 63. FIG. 63 is a flowchart showing the contents of a transportation process executed by the automatic analyzing apparatus 5001 according to the present embodiment and is a diagram corresponding to FIG. 48 according to the fourth embodiment described above. In the transportation process, the reaction cuvette 5300a or the measurement cuvette 7011a is transported to the reaction disk 5201. For example, the transportation process is a process executed at a timing when the blood specimen is tested.

As illustrated in FIG. 63, first, the automatic analyzing apparatus 5001 moves the transportation unit 5213 to the supply position (step S5061). Specifically, the transportation control function 5093 in the control circuitry 5009 of the automatic analyzing apparatus 5001 controls the drive mechanism 5004, rotates the transportation arm of the transportation unit 5213, and moves the holder of the transportation unit 5213 to the supply position. In addition, since the processes in steps S5011 and S5013 after step S5061 are equivalent to those in FIG. 48 according to the fourth embodiment described above, the description thereof is omitted.

Then, in step S5013, when the electrolyte item is to be measured (step S5013: Yes), the automatic analyzing apparatus 5001 adds the plurality of terminals 5302 to the measurement cuvette 7011a (step S5063). Specifically, the terminal adding control function 5095 in the control circuitry 5009 of the automatic analyzing apparatus 5001 controls the terminal applier 5218 to add the plurality of terminals 5302 to the measurement cuvette 7011a supplied to the supply position. That is, in step S5063, the automatic analyzing apparatus 5001 adds the plurality of terminals 5302 to the measurement cuvette 7011a to produce the reaction cuvette 5300a. In addition, since the processes in steps S5017, S5021, S5023, and S5025 after step S5063 are equivalent to those in FIG. 48 according to the fourth embodiment described above, the description thereof is omitted. Also, by executing step S5025, the transportation process according to the present embodiment is ended.

As described above, according to the automatic analyzing apparatus 5001 of the present embodiment, by providing the terminal applier 5218, the terminal applier 5218 adds the plurality of terminals 5302 to the measurement cuvette 7011a and produces the reaction cuvette 5300a, and the measurer 5214a measures the potentials of the plurality of terminals 5302 by using the produced reaction cuvette 5300a, to measure the electrolyte item of the sample, and thus it is not necessary to provide a mechanism for moving the sample to measure the electrolyte item or a dispensing unit for dispensing the sample. As a result, the number of components of the automatic analyzing apparatus 5001 can be reduced while enabling the measurement of the electrolyte item, so that the automatic analyzing apparatus 5001 can be miniaturized.

In addition, since the reaction cuvette 5300a used in the automatic analyzing apparatus 5001 according to the present embodiment is a disposable reaction cuvette, it is possible to prevent the occurrence of carryover in the measurement of the electrolyte item.

Furthermore, in the automatic analyzing apparatus 5001 according to the present embodiment, since the temperature of the sample or the mixture liquid accommodated in the reaction cuvette 5300a is controlled using the thermostatic unit 5202 included in the automatic analyzing apparatus 5001, it is not necessary to provide a separate thermostatic mechanism for controlling the temperature of the sample or the mixture liquid when measuring the electrolyte item. As a result, the number of components of the automatic analyzing apparatus 5001 can be reduced while enabling the measurement of the electrolyte item, so that the automatic analyzing apparatus 5001 can be miniaturized.

In the fifth embodiment described above, the plurality of terminals 5302 are added to the measurement cuvette 7011a by the terminal applier 5218 at the supply position, but the position to which the plurality of terminals 5302 are added is not limited to the supply position. That is, the positions to which the plurality of terminals 5302 are added are arbitrary and for example, when the reaction disk 5201 transports the measurement cuvette 7011a to a predetermined position where the terminal applier 5218 is provided after the transportation unit 5213 places the measurement cuvette 7011a on the reaction disk 5201, the plurality of terminals 5302 may be added to the measurement cuvette 7011a to produce the reaction cuvette 5300a.

### Sixth Embodiment

In the fourth embodiment described above, in the automatic analyzing apparatus 5001, the connector 5215 which is electrically connected to the measurer 5214 comes into contact with the plurality of terminals 5302 provided in the reaction cuvettes 5300 to measure the potentials of the plurality of terminals 5302, but the method of measuring the potentials of the plurality of terminals 5302 is not limited to a case where the connector 5215 comes into contact with the plurality of terminals 5302. Therefore, the automatic analyzing apparatus 5001 according to a sixth embodiment may include a transfer unit that transfers the potentials of the plurality of terminals 5302, and the measurer 5214 may measure the plurality of potentials via the transfer unit and the connector 5215. Hereinafter, portions different from the fourth embodiment described above are described.

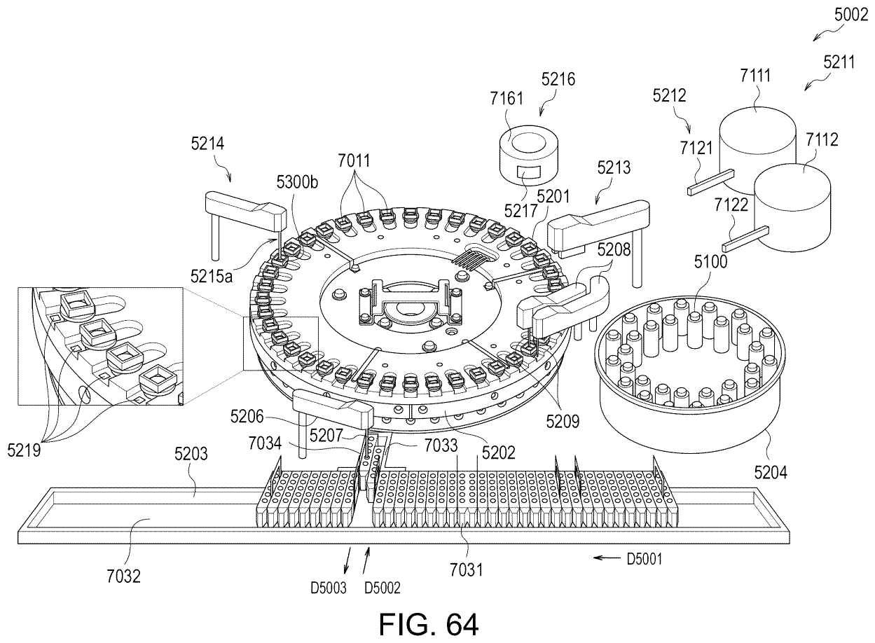

FIG. 64 is a diagram illustrating an example of a configuration of the analysis mechanism 5002 according to the present embodiment and is a diagram corresponding to FIG. 42 in the fourth embodiment described above. As illustrated in FIG. 64, the analysis mechanism 5002 according to the present embodiment is configured by adding a transfer unit 5219 to the analysis mechanism 5002 described above. Also, since the configuration of the connector is different from that of the fourth embodiment, the connector is referred to as a connector 5215a in the present embodiment. Also, the configurations and functions other than the connector 5215a and the transfer unit 5219 are equivalent to those in FIG. 42 according to the fourth embodiment described above, and thus the description thereof is omitted.

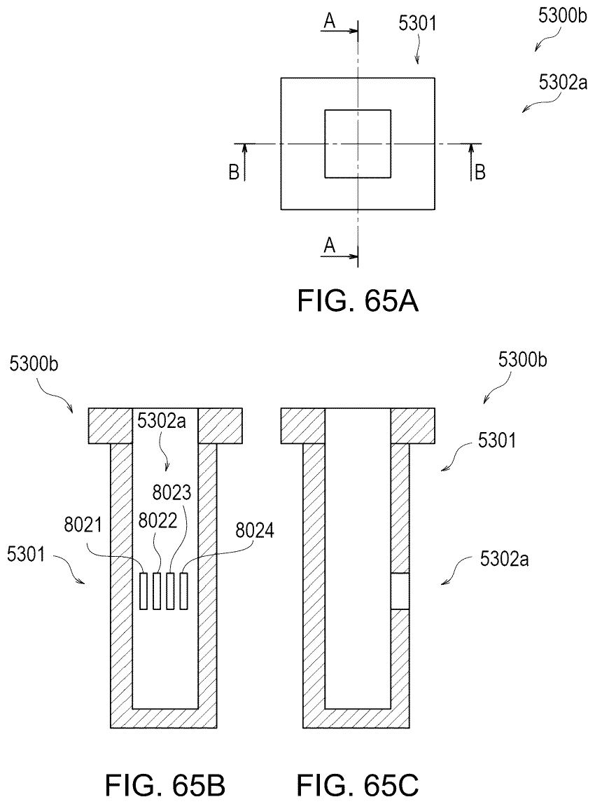

FIGS. 65A to 65C are diagrams illustrating an example of a reaction cuvette used in the analysis mechanism 5002 illustrated in FIG. 64 in the present embodiment and are diagrams corresponding to FIGS. 43A to 43C in the fourth embodiment described above. FIG. 65A is a diagram illustrating a reaction cuvette 5300b when viewed from above, FIG. 65B is a cross-sectional view taken along line A-A in FIG. 65A, and FIG. 65C is a cross-sectional view taken along line B-B in FIG. 65A. As illustrated in FIGS. 65A to 65C, the reaction cuvette 5300b according to the present embodiment includes the cuvette body 5301 and a plurality of terminals 5302a. Since the cuvette body 5301 is equivalent to that in FIGS. 43A to 43C according to the first embodiment described above, the description thereof is omitted.

The plurality of terminals 5302a are terminals which are provided in the cuvette body 5301 and measure the concentration of the target substance in the blood specimen or the mixture liquid accommodated in the cuvette body 5301. Further, the plurality of terminals 5302a according to the present embodiment are provided in the cuvette body 5301 by being integrally formed with the cuvette body 5301. As illustrated in FIGS. 65B and 65C, the plurality of terminals 5302a according to the present embodiment are provided in the side wall of the cuvette body 5301. One end of each of the plurality of terminals 5302a is exposed from the inner wall of the cuvette body 5301 to be able to contact the blood specimen or the mixture liquid accommodated in the cuvette body 5301. In addition, the other end of each of the plurality of terminals 5302a is exposed from the outer wall of the cuvette body 5301 to be able to come into contact with the transfer unit 5219. As illustrated in FIG. 65B, the number of the plurality of terminals 5302a according to the present embodiment is four. The four terminals according to the present embodiment are the ISEs 8021 to 8023 that selectively detect the electrolyte included in the blood specimen or the mixture liquid and the reference electrode 8024 that generates a constant potential, respectively.

The reaction cuvette 5300b and the automatic analyzing apparatus 5001 that analyzes the sample by using the sample or the mixture liquid accommodated in the reaction cuvette 5300b configure an automatic analyzing system according to the present embodiment.

The connector 5215a is a connection terminal electrically connected to the measurer 5214. Specifically, one end of the connector 5215a is electrically connected to the measurer 5214. In addition, the other end of the connector 5215a according to the present embodiment can come into contact with the transfer unit 5219 exposed from the reaction disk 5201. The connector 5215a includes a plurality of connection terminals to measure the potential between the ISEs 8021 to 8023 and the reference electrode 8024. The connector 5215a according to the present embodiment includes four connection terminals to come into contact with the ISEs 8021 to 8023 and the reference electrode 8024 at once. The connector 5215a is an example of a first connector according to the present embodiment.

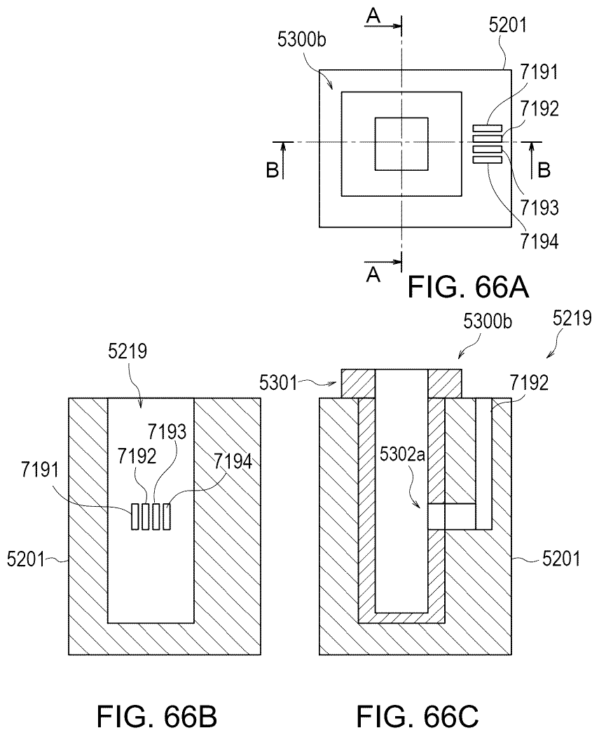

The transfer unit 5219 is a connection member that can be electrically connected to the plurality of terminals 5302a provided in the reaction cuvette 5300b. The transfer unit 5219 is an example of a second connector according to the present embodiment. Note that the transfer unit 5219 may be provided on a surface through which light by the photometric unit 5210 does not pass to prevent the surface through which the optical axis of the reaction cuvette 5300b passes from being damaged by the transfer unit 5219 when the reaction cuvette 5300b is placed on reaction disk 5201. In the analysis mechanism 5002 according to the present embodiment, the plurality of transfer units 5219 is provided. For example, the transfer units 5219 are provided in the same number as the number of the reaction cuvettes 5300b and the measurement cuvettes 7011 that can be held by the reaction disk 5201. That is, one transfer unit 5219 is provided for one reaction cuvette 5300b or measurement cuvette 7011 held by the reaction disk 5201. Since the configurations of the respective transfer units 5219 are the same, the transfer unit 5219 is described with reference to FIGS. 66A to 66C that illustrate one transfer unit 5219 as a representative. FIGS. 66A to 66C are schematic diagrams illustrating an example of a configuration of the transfer unit 5219 in the sixth embodiment. FIG. 66A is a diagram illustrating the transfer unit 5219 when viewed from above, FIG. 66B is a cross-sectional view taken along line A-A in FIG. 66A, and FIG. 66C is a cross-sectional view taken along line B-B in FIG. 66A. In FIG. 66B, the reaction cuvette 5300b is omitted for convenience of description.

As illustrated in FIGS. 66A and 66B, the transfer unit 5219 according to the present embodiment includes four connection members 7191 to 7194 to be electrically connected to the ISEs 8021 to 8023 and the reference electrode 8024, which are a plurality of terminals 5302a provided in the reaction cuvette 5300b, at once. As illustrated in FIGS. 66B and 66C, one end of the transfer unit 719 is exposed from the inner wall surface of the reaction disk 5201 to be electrically connectable to the plurality of terminals 5302a provided in the reaction cuvette 5300b when the reaction cuvette 5300b is held on the reaction disk 5201. In the present embodiment, one end of the transfer unit 5219 is formed in a convex shape. Therefore, it is possible to come into contact with the plurality of terminals 5302a provided in the reaction cuvette 5300b by friction. The other end of the transfer unit 5219 is exposed from the upper surface of the reaction disk 5201 to be electrically connectable to the connector 5215a.

Note that one end of the transfer unit 5219 is formed in a convex shape, and the transfer unit 5219 and the plurality of terminals 5302a of the reaction cuvette 5300b are brought into contact with each other by friction, but the method of bringing the transfer unit 5219 and the plurality of terminals 5302a into contact with each other is not limited to contact by friction. That is, the method of bringing the transfer unit 5219 into contact with the reaction cuvette 5300b is arbitrary, and a moving mechanism for moving the transfer unit 5219 may be provided in the reaction disk 5201. When the moving mechanism for moving the transfer unit 5219 is provided and when the reaction cuvette 5300b is held on the reaction disk 5201, the moving mechanism moves the transfer unit 5219 to bring the plurality of terminals 5302a into contact with the transfer unit 5219. As a result, the plurality of terminals 5302a and the transfer unit 5219 may be electrically connected.

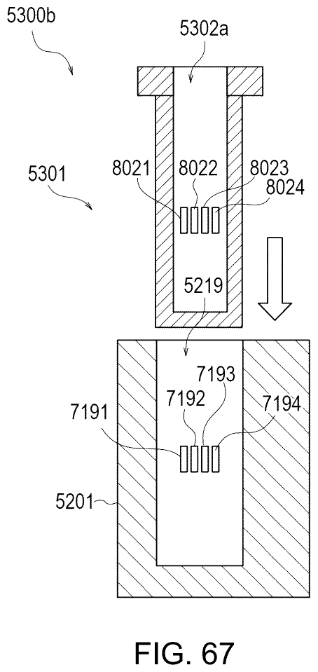

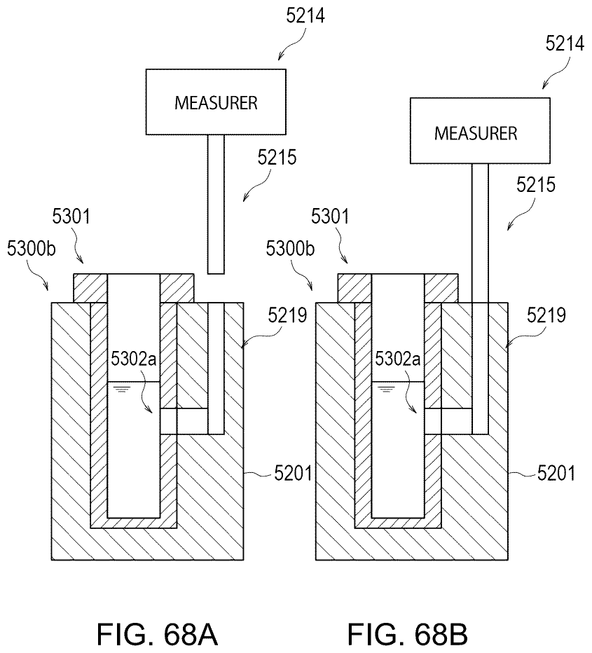

With reference to FIGS. 67 to 68B, the flow to the method of measuring a potential by the measurer 5214 according to the present embodiment is described. FIG. 67 is a schematic view illustrating a flow until the reaction cuvette 5300b is placed in the reaction disk 5201 in the present embodiment. FIGS. 68A and 68B are diagrams illustrating an example of the method of measuring a potential by the measurer 5214 according to the present embodiment and is a diagram corresponding to FIG. 47 in the fourth embodiment described above. As illustrated in FIG. 67, the automatic analyzing apparatus 5001 places the reaction cuvette 5300b transported by the transportation unit 5213 on the reaction disk 5201. Here, as illustrated in FIG. 67, the reaction cuvette 5300b is placed on the reaction disk 5201 by adjusting the positions of ISEs 8021 to 8023 and the reference electrode 8024 which are the plurality of terminals 5302a so that the ISEs 8021 to 8023 and the reference electrode 8024 which are the plurality of terminals 5302a of the reaction cuvette 5300b are brought into contact with and electrically connected to the connection members 7191 to 7194 of the transfer unit 5219.

Next, as illustrated in FIG. 68A, the reaction cuvette 5300b held by the reaction disk 5201 is transported to the potential measuring position by the reaction disk 5201. As illustrated in FIG. 68B, when the reaction cuvette 5300b is transported to the potential measuring position, the measurer 5214 is lowered, and the connector 5215a comes into contact with the transfer unit 5219. In the example illustrated in FIG. 68B, the connector 5215a comes into contact with the transfer unit 5219 exposed on the upper surface of the reaction disk 5201. As such, when the connector 5215a comes into contact with the transfer unit 5219, the plurality of terminals 5302a and the measurer 5214 are brought into a conductive state. That is, the measurer 5214 measures the potentials of the plurality of terminals 5302a via the connector 5215a and the transfer unit 5219. Then, when the measurement is completed, the measurer 5214 is raised, and the contact between the connector 5215a and the transfer unit 5219 is released. Hereinafter, a method in which the measurer 5214 measures the potentials of the plurality of terminals 5302a by bringing the connector 5215a into contact with the transfer unit 5219 is referred to as an indirect contact potential measuring method as necessary.

As described above, in the present embodiment, since the automatic analyzing apparatus 5001 includes the transfer unit 5219, the measurer 5214 can measure the potentials of the plurality of terminals 5302a of the reaction cuvette 5300b via the connector 5215a and the transfer unit 5219, so that the risk of contamination of the connector 5215a can be reduced and the occurrence of carryover can be reduced as compared with the direct contact potential measuring method.

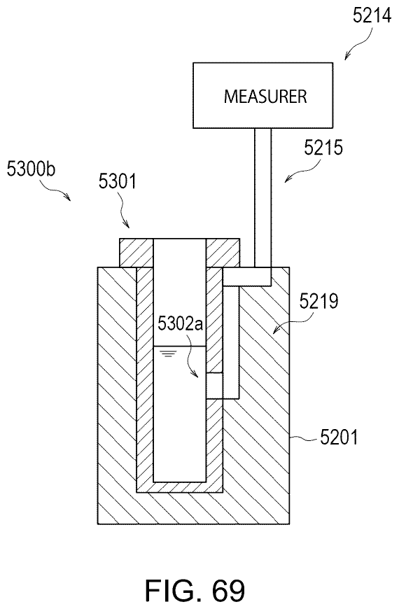

In the sixth embodiment described above, the transfer unit 5219 is provided inside the reaction disk 5201, and only both ends of the transfer unit 5219 are exposed, but the configuration of the transfer unit 5219 is not limited thereto. FIG. 69 is a diagram illustrating another example of the method of measuring a potential by the measurer 5214 according to the present embodiment and is a diagram corresponding to FIGS. 68A and 68B in the sixth embodiment described above. In the example illustrated in FIG. 69, the transfer unit 5219 may be continuously provided to have an L shape from the upper surface to the inner wall surface of the reaction disk 5201. By providing the transfer unit 5219 as such, it is possible to handle a manufacturing error of the plurality of terminals 5302a in the reaction cuvette 5300b to some extent. In addition, since the contact range of the connector 5215a with respect to the transfer unit 5219 is also increased, the connector 5215a can be connected to the transfer unit 5219 more reliably.

In the sixth embodiment described above, the plurality of terminals 5302a provided on the reaction cuvette 5300b are provided on one inner wall surface of the reaction cuvette 5300b, but each of the plurality of terminals 5302a may be provided on each of the four inner wall surfaces of the reaction cuvette 5300b. Then, each connection member of the transfer unit 5219 may be provided on each of the four inner wall surfaces of the reaction disk 5201 to correspond to the positions of the plurality of terminals 5302a provided in the reaction cuvette 5300b.

[Fourth Modification]

In the fourth to sixth embodiments described above, instead of using the disposable reaction cuvette, it is also possible to clean the reaction cuvette for which measurement is completed and to modify the reaction cuvette to use the cleaned reaction cuvette again. Hereinafter, portions different from those of the fourth embodiment described above are described using a case where the present modification is applied to the fourth embodiment as an example of a fourth modification.

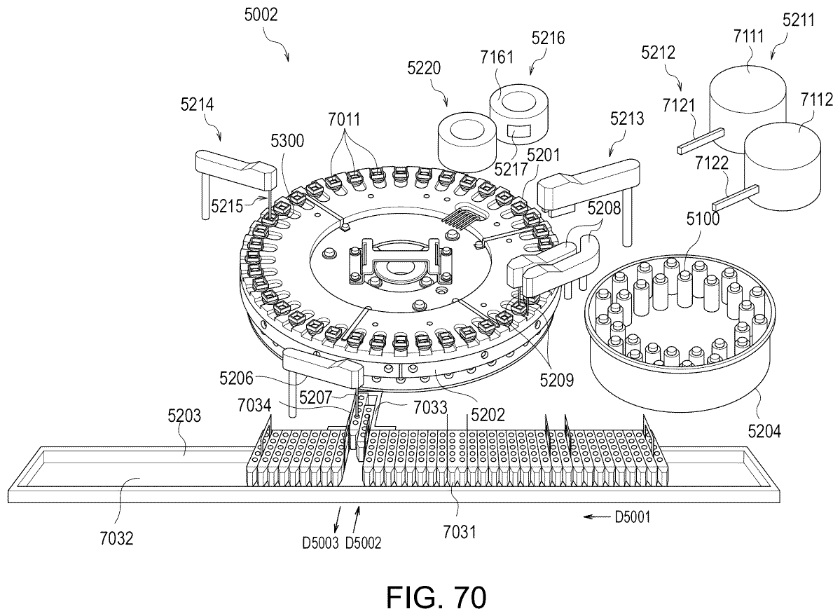

FIG. 70 is a diagram illustrating an example of a configuration of an analysis mechanism according to the fourth modification and is a diagram corresponding to FIG. 42 in the fourth embodiment described above. As illustrated in FIG. 70, the analysis mechanism 5002 according to the present modification is configured by adding a cleaning unit 5220 to the analysis mechanism 5002 according to the fourth embodiment described above. Also, the configurations and functions other than the cleaning unit 5220 are equivalent to those in FIG. 42 according to the fourth embodiment described above, and thus the description thereof is omitted.

The cleaning unit 5220 cleans the reaction cuvette 5300 for which measurement is completed. For example, the cleaning unit 5220 may clean the reaction cuvette 5300 by showering pure water or may clean the reaction cuvette 5300 by immersing the reaction cuvette 5300 in a pool storing pure water. The cleaning unit 5220 is provided on the transportation path of the reaction cuvette 5300 of the transportation unit 5213. Also, when the reaction cuvette 5300 for which measurement is completed is transported to the cleaning position by the transportation unit 5213, the cleaning unit 5220 cleans the reaction cuvette 5300.

In the fourth modification, the measurement cuvette 7011 for which measurement is completed may be cleaned by the cleaning unit 5220 similarly to the reaction cuvette 5300 or may be disposed of in the disposal unit 5216.

As described above, according to the automatic analyzing apparatus 5001 according to the fourth modification, by cleaning the reaction cuvette 5300, the reaction cuvette 5300 can be used again for the measurement of the electrolyte item, so that the operation cost of the automatic analyzing apparatus 5001 can be suppressed. Although the description of the fourth modification described above is description of a case where the fourth modification is applied to the fourth embodiment, it is obvious that the present modification can also be applied to the fifth and sixth embodiments.

### [Other Modifications]

In the first to third embodiments, the first modification, and the second modification described above, when the measuring chips stored in the storage container 216 are the predetermined remaining amount or less and when the measuring chips disposed of in the disposal containers 220 or 220a is the predetermined amount or more, the automatic analyzing apparatus 1 reports to the user, but the cases of reporting to the user is not limited thereto. For example, when an abnormality occurs such as a measuring chip is not supplied to the supply position P11, a photographed image of the supply position P11 by the optical camera cannot be acquired, sample aspiration cannot be performed normally, or a potential cannot be measured, the first reporting function 94 or the second reporting function 95 in the control circuitry 9 of the automatic analyzing apparatus 1 may report to the user. In addition, when an abnormality occurs, the measurement of the electrolyte item may be paused until the abnormality is eliminated.

Note that, in the first to third embodiments described above, the transportation mechanism 219 includes the heating unit 2197 and the temperature sensor 2198, and the heating unit 2197 is controlled based on the measurement result of the temperature sensor 2198 to control the temperature of the sample or the mixture liquid of the measuring chip 300 attached to the transportation mechanism 219, but the embodiment is not limited thereto. That is, the portion including the heating unit 2197 and the temperature sensor 2198 is arbitrary, and for example, the supplier 218 may include the heating unit 2197 and the temperature sensor 2198. In addition, the sample or the mixture liquid in the predetermined temperature may be aspirated by causing the transportation mechanism 219 not to include the heating unit 2197 and the temperature sensor 2198 and causing the temperature control function 92 to control the temperature of the sample or the mixture liquid accommodated in the reaction cuvette 2011 by controlling the thermostatic unit 202.

In addition, the application of the automatic analyzing apparatus 1 of the first to third embodiments described above to an automatic analyzing apparatus that performs a biochemical test is described, but the embodiment is not limited thereto. That is, the first to third embodiments can also be applied to another automatic analyzing apparatus that measures an electrolyte item, such as an automatic analyzing apparatus that performs a blood coagulation analysis test.

In the fourth to sixth embodiments described above, the reaction cuvette 5300, 5300a, or 5300b or the measurement cuvette 7011 or 7011a, for which measurement is completed, is transported by the transportation unit 5213 to the disposal position, but a disposal transportation unit for transporting the reaction cuvette 5300, 5300a, or 5300b or the measurement cuvette 7011 or 7011a, for which measurement is completed, to the disposal position may be provided separately from the transportation unit 5213. By providing the disposal transportation unit as such, it is possible to improve the throughput of transportation of the reaction cuvette 5300, 5300a, or 5300b or the measurement cuvette 7011 or 7011a to the reaction disk 5201 and transportation of the reaction cuvette 5300, 5300a, or 5300b or the measurement cuvette 7011 or 7011a, for which measurement is completed, to the disposal position, so that it is possible to improve the throughput of the entire automatic analyzing apparatus 5001.

In the fourth to sixth embodiments described above, when the amount of the measurement cuvette 7011 or 7011a or the reaction cuvette 5300, 5300a, or 5300b accommodated in the disposal unit 5216 is the predetermined amount or more, the reporting function 5094 in the control circuitry 5009 of the automatic analyzing apparatus 5001 reports to the user via the output interface 5006 or the communication interface 5007, but the content reported to the user is not limited to a case where the amount of the measurement cuvette 7011 or 7011a or the reaction cuvette 5300, 5300a, or 5300b accommodated in the disposal unit 5216 is the predetermined amount or more. For example, by providing a sensor to the storage container 5211, when the remaining amount of the measurement cuvette 7011 or 7011a or the reaction cuvette 5300, 5300a, or 5300b stored in the storage container 5211 or 5211a is the predetermined remaining amount or less based on the detection result of the sensor, report to the user may be performed, or when an error on the electrolyte measurement occurs such as an abnormality in the potential measured by the measurer 5214 or 5214a, an abnormality in the placement of the reaction cuvette 5300, 5300a, or 5300b or the measurement cuvette 7011 or 7011a, or a contact malfunction of the connector 5215 or 5215a, the user may be reported that the electrolyte measurement is not normally executed.

In the fourth to sixth embodiments described above, the connector 5215 or 5215a includes connection terminals in the same number as the number of the plurality of terminals 5302 or 5302a, but the number of the connection terminals included in the connector 5215 or 5215a may be less than the number of the plurality of terminals 5302 or 5302a. For example, when the number of terminals of the plurality of terminals 5302 or 5302a is four, the number of connection terminals of the connector 5215 or 5215a may be two. Then, to bring the two connection terminals of the connector 5215 or 5215a into contact with the ISEs 8021 to 8023 and the reference electrode 8024 of the plurality of terminals 5302 or 5302a, the connector 5215 or 5215a may include an adjustment mechanism for adjusting between the two connection terminals.

In addition, the application of the automatic analyzing apparatus 5001 of the fourth to sixth embodiments described above to an automatic analyzing apparatus that performs a blood coagulation analysis test is described, but the embodiment is not limited thereto. That is, the fourth to sixth embodiments can also be applied to another automatic analyzing apparatus that measures an electrolyte item such as an automatic analyzing apparatus that performs a biochemical test.

The term “processor” used herein refers to, for example, a central processing unit (CPU) or a graphics processing unit (GPU), or a circuit such as an application-specific integrated circuit (ASIC), a programmable logic device (such as a simple programmable logic device (SPLD)), a complex programmable logic device (CPLD), a field programmable gate array (FPGA)), etc. In the case of the processor being a CPU, for example, the processor realizes a function by reading and executing a program stored in a storage circuit. On the other hand, in the case of the processor being, for example, an ASIC, instead of a program being stored in a storage circuit, a corresponding function is directly incorporated as a logic circuit in the circuit of the processor. Each processor of the present embodiment is not limited to a configuration as a single circuit; a plurality of independent circuits may be combined into one processor to realize the function of the processor. Furthermore, multiple components or features may be integrated as one processor to realize the respective functions.

While certain embodiments and their modifications have been described, these embodiments and modifications have been presented by way of example only, and are not intended to limit the scope of the inventions. Indeed, a variety of other forms such as omissions, substitutions, changes and combinations may be made in the embodiments and modifications without departing from the spirit of the inventions. Such embodiments and modifications are intended to be covered by the scope and spirit of the inventions as well as the claimed inventions and their equivalents.

Regarding the above embodiments, the following supplementary notes are described as one aspect and selective features of the invention.

### (Supplementary Note 1)

A measuring chip, comprising:
a chip body configured to accommodate a sample or a mixture liquid obtained by mixing a reagent that reacts with the sample or a diluent that dilutes the sample with the sample;

an aspiration port configured to be provided in the chip body and aspirate the sample or the mixture liquid;

a plurality of terminals configured to be provided in the chip body and measure a concentration of a target substance in the sample or the mixture liquid aspirated from the aspiration port; and an attaching portion configured to attach the chip body to a transporter of an automatic analyzing apparatus.

### (Supplementary Note 2)

The measuring chip may further comprise a holder configured to be provided in the chip body and hold the sample or the mixture liquid aspirated from the aspiration port.

### (Supplementary Note 3)

The chip body may aspirate the sample or the mixture liquid by a capillary phenomenon via the aspiration port.

### (Supplementary Note 4)

The plurality of terminals may be provided in the chip body so that an axial direction of each of the plurality of terminals is perpendicular to a radial direction of the aspiration port.

### (Supplementary Note 5)

The plurality of terminals may be provided in the chip body so that one end of each of the plurality of terminals is exposed to outside from an outer wall of the chip body and an axial direction of each of the plurality of terminals are parallel to a radial direction of the aspiration port.

### (Supplementary Note 6)

The plurality of terminals may each include an ion selective electrode that selectively detects an electrolyte included in the sample or the mixture liquid and a reference electrode that generates a constant potential.

### (Supplementary Note 7)

An automatic analyzing apparatus, comprising:
a transporter configured to enable attachment of a measuring chip that measures a concentration of a target substance in a sample or a mixture liquid obtained by mixing a reagent that reacts with the sample or a diluent that dilutes the sample with the sample and transport the measuring chip;
a measurer configured to measure potentials of a plurality of terminals provided in the measuring chip transported by the transporter; and
a calculator configured to calculate a concentration of a target substance in the sample or the mixture liquid accommodated in the measuring chip based on the potential measured by the measurer.

### (Supplementary Note 8)

The transporter may include a measuring chip attached portion to which the measuring chip is attached, and a transportation arm that transports the measuring chip attached to the measuring chip attached portion along a predetermined transportation path.

### (Supplementary Note 9)

The automatic analyzing apparatus may further comprise an aspirator configured to be provided in the transporter and aspirate the sample or the mixture liquid to the measuring chip attached to the measuring chip attached portion of the transporter.

### (Supplementary Note 10)

The automatic analyzing apparatus may further comprise a connector configured to be provided in the transporter and electrically connected to the measurer, wherein the measurer may measure potentials of the plurality of terminals via the connector provided in the transporter.

### (Supplementary Note 11)

The transporter may include a rotating table configured to enable attachment of the measuring chip and rotate to transport the measuring chip along a predetermined transportation path; and a supporter configured to support the rotating table.

### (Supplementary Note 12)

The automatic analyzing apparatus may further comprise an aspirator configured to aspirate the sample or the mixture liquid to the measuring chip attached to the rotating table.

### (Supplementary Note 13)

The automatic analyzing apparatus may further comprise a connector configured to be provided in the aspirator and electrically connected to the measurer, wherein the measurer may measure potentials of the plurality of terminals via the connector provided in the aspirator.

### (Supplementary Note 14)

The automatic analyzing apparatus may further comprise a placing base configured to be provided on a transportation path of the transporter, be provided with a connector electrically connected to the measurer and place the measuring chip, wherein the measurer may measure potentials of the plurality of terminals via the connector provided in the placing base.

### (Supplementary Note 15)

The automatic analyzing apparatus may further comprise processing circuitry configured to control temperature of at least one of the measuring chip, the sample accommodated in the measuring chip, and the mixture liquid accommodated in the measuring chip.

### (Supplementary Note 16)

The automatic analyzing apparatus may further comprise a storage container configured to store the measuring chip; and a supplier configured to supply the measuring chip stored in the storage container at a supply position that is a position where the measuring chip is supplied.

### (Supplementary Note 17)

The automatic analyzing apparatus may further comprise a first detector configured to detect a remaining amount of the measuring chip stored in the storage container; and wherein the processing circuitry may be configured to report to a user when the remaining amount of the measuring chip stored in the storage container is a predetermined remaining amount or less based on a detection result of the first detector.

### (Supplementary Note 18)

The automatic analyzing apparatus may further comprise a disposal container in which the measuring chip for which measurement by the measurer is completed is disposed of.

### (Supplementary Note 19)

The automatic analyzing apparatus may further comprise a second detector configured to detect an amount of the measuring chip disposed of in the disposal container, wherein the processing circuitry may be configured to report to a user when an amount of the measuring chip disposed of in the disposal container is a predetermined amount or more based on a detection result of the second detector.

### (Supplementary Note 20)

An automatic analyzing system comprising:
a measuring chip configured to measure a concentration of a target substance in a sample or a mixture liquid obtained by mixing a reagent that reacts with the sample or a diluent that dilutes the sample with the sample; and
an automatic analyzing apparatus configured to analyze the sample by using the sample or the mixture liquid accommodated in the measuring chip,
wherein the measuring chip includes
   a chip body accommodating the sample or the mixture liquid;
   an aspiration port aspirating the sample or the mixture liquid provided to the chip body, and
   a plurality of terminals provided to the chip body and measuring a concentration of a target substance in the sample or the mixture liquid aspirated from the aspiration port, and
the automatic analyzing apparatus includes
   a transporter enabling attachment of the measuring chip and transporting the measuring chip,
   a measurer measuring potentials of the plurality of terminals provided in the measuring chip transported by the transporter, and
   a calculator calculating a concentration of a target substance in the sample or the mixture liquid accommodated in the chip body based on the potential measured by the measurer.

### (Supplementary Note 21)

A reaction cuvette, comprising:
a cuvette body configured to accommodate a sample or a mixture liquid obtained by mixing a reagent that reacts with the sample or a diluent that dilutes the sample with the sample; and
a plurality of terminals configured to be provided in the cuvette body and measure a concentration of a target substance of the sample or the mixture liquid accommodated in the cuvette body.

### (Supplementary Note 22)

The plurality of terminals may be provided in the cuvette body by being integrally formed with the cuvette body.

### (Supplementary Note 23)

The plurality of terminals may be provided in the cuvette body by being added to the cuvette body by a terminal applier of an automatic analyzing apparatus.

### (Supplementary Note 24)

The plurality of terminals may each include an ion selective electrode that selectively detects an electrolyte included in the sample or the mixture liquid and a reference electrode that generates a constant potential.

### (Supplementary Note 25)

An automatic analyzing apparatus comprising:
a reaction disk configured to hold a reaction cuvette that measures a concentration of a target substance of a sample or a mixture liquid obtained by mixing a reagent that reacts with the sample and a diluent that dilutes the sample with the sample;
a measurer configured to measure potentials of a plurality of terminals provided to the reaction cuvette; and
a calculator configured to calculate a concentration of a target substance in the sample or the mixture liquid accommodated in the reaction cuvette based on the potential measured by the measurer.

### (Supplementary Note 26)

The automatic analyzing apparatus may further comprise processing circuitry configured to control temperature of the sample or the mixture liquid accommodated in the reaction cuvette.

### (Supplementary Note 27)

The automatic analyzing apparatus may further comprise a reaction cuvette transportation mechanism configured to transport the reaction cuvette, and wherein the processing circuitry may be configured to control the reaction cuvette transportation mechanism to transport the reaction cuvette to the reaction disk.

### (Supplementary Note 28)

The automatic analyzing apparatus may further comprise a storage container configured to store the reaction cuvette that is provided by being integrally formed with the plurality of terminals and a measurement cuvette that accommodates the sample or the mixture liquid and measures an item other than a concentration of a target substance in the sample or the mixture liquid,
wherein the processing circuitry may be configured to
select any one of the reaction cuvette or the measurement cuvette based on a measurement item of the sample, and
control the reaction cuvette transportation mechanism and transport the selected reaction cuvette or measurement cuvette to the reaction disk.

### (Supplementary Note 29)

The automatic analyzing apparatus may further comprise a storage container configured to store the reaction cuvette provided with the plurality of terminals that are integrally formed with the reaction cuvette.

### (Supplementary Note 30)

The automatic analyzing apparatus may further comprise a storage container configured to store a measurement cuvette that accommodates the sample or the mixture liquid and measures the sample or the mixture liquid, and
a terminal applier configured to add a plurality of terminals to the measurement cuvette,
wherein the processing circuitry may be configured to control the terminal applier and add the plurality of terminals to the measurement cuvette may be further included.

### (Supplementary Note 31)

The automatic analyzing apparatus may further comprise a reaction cuvette disposal container in which the reaction cuvette is disposed of, and
a detector configured to detect an amount of the reaction cuvettes disposed of in the reaction cuvette disposal container,
wherein the processing circuitry may be configured to report to a user when the amount of the reaction cuvettes disposed of in the reaction cuvette disposal container is a predetermined amount or more based on a detection result of the detector.

### (Supplementary Note 32)

wherein the processing circuitry may be configured to clean the reaction cuvette provided with the plurality of terminals may be further included.

### (Supplementary Note 33)

The automatic analyzing apparatus may further comprise a first connector electrically connected to the measurer, wherein the measurer may measure the potentials of the plurality of terminals via the first connector.

### (Supplementary Note 34)

The automatic analyzing apparatus may further comprise a second connector electrically connectable to the plurality of terminals provided in the reaction cuvette, wherein the measurer may measure the potentials of the plurality of terminals via the first connector and the second connector.

### (Supplementary Note 35)

An automatic analyzing system comprising:
a reaction cuvette configured to measure a concentration of a target substance in a sample or a mixture liquid obtained by mixing a reagent that reacts with the sample or a diluent that dilutes the sample with the sample; and
an automatic analyzing apparatus configured to analyze the sample by using the sample or the mixture liquid accommodated in the reaction cuvette,
wherein the reaction cuvette includes
   a cuvette body accommodating the sample or the mixture liquid, and
   a plurality of terminals provided in the cuvette body and detecting a target substance in the sample or the mixture liquid accommodated in the cuvette body, and
the automatic analyzing apparatus includes
   a reaction disk holding the reaction cuvette,
   a measurer measuring potentials of the plurality of terminals of the reaction cuvette, and
   a calculator calculating a concentration of a target substance of the sample or the mixture liquid accommodated in the reaction cuvette based on the potential measured by the measurer.

1. A measuring chip, comprising:
a chip body configured to accommodate a sample or a mixture liquid obtained by mixing a reagent that reacts with the sample or a diluent that dilutes the sample with the sample;
an aspiration port configured to be provided in the chip body and aspirate the sample or the mixture liquid;
a plurality of terminals configured to be provided in the chip body and measure a concentration of a target substance in the sample or the mixture liquid aspirated from the aspiration port; and
an attaching portion configured to attach the chip body to a transporter of an automatic analyzing apparatus.

2. The measuring chip according to claim 1, further comprising a holder configured to be provided in the chip body and hold the sample or the mixture liquid aspirated from the aspiration port.

3. The measuring chip according to claim 1, wherein the chip body aspirates the sample or the mixture liquid by a capillary phenomenon via the aspiration port.

4. The measuring chip according to claim 1, wherein the plurality of terminals are provided in the chip body so that an axial direction of each of the plurality of terminals is perpendicular to a radial direction of the aspiration port.

5. The measuring chip according to claim 1, wherein the plurality of terminals are provided in the chip body so that one end of each of the plurality of terminals is exposed to outside from an outer wall of the chip body and an axial direction of each of the plurality of terminals are parallel to a radial direction of the aspiration port.

6. The measuring chip according to claim 1, wherein the plurality of terminals each include an ion selective electrode that selectively detects an electrolyte included in the sample or the mixture liquid and a reference electrode that generates a constant potential.

7. An automatic analyzing apparatus, comprising:
a transporter configured to enable attachment of a measuring chip that measures a concentration of a target substance in a sample or a mixture liquid obtained by mixing a reagent that reacts with the sample or a diluent that dilutes the sample with the sample and transport the measuring chip;
a measurer configured to measure potentials of a plurality of terminals provided in the measuring chip transported by the transporter; and
a calculator configured to calculate a concentration of a target substance in the sample or the mixture liquid accommodated in the measuring chip based on the potential measured by the measurer.

8. The automatic analyzing apparatus according to claim 7, wherein the transporter includes
a measuring chip attached portion to which the measuring chip is attached, and
a transportation arm that transports the measuring chip attached to the measuring chip attached portion along a predetermined transportation path.

9. The automatic analyzing apparatus according to claim 8, further comprising an aspirator configured to be provided in the transporter and aspirate the sample or the mixture liquid to the measuring chip attached to the measuring chip attached portion of the transporter.

10. The automatic analyzing apparatus according to claim 8, further comprising a connector configured to be provided in the transporter and electrically connected to the measurer,
wherein the measurer measures potentials of the plurality of terminals via the connector provided in the transporter.

11. The automatic analyzing apparatus according to claim 7, wherein the transporter includes
a rotating table configured to enable attachment of the measuring chip and rotate to transport the measuring chip along a predetermined transportation path; and
a supporter configured to support the rotating table.

12. The automatic analyzing apparatus according to claim 11, further comprising an aspirator configured to aspirate the sample or the mixture liquid to the measuring chip attached to the rotating table.

13. The automatic analyzing apparatus according to claim 12, further comprising a connector configured to be provided in the aspirator and electrically connected to the measurer,
wherein the measurer measures potentials of the plurality of terminals via the connector provided in the aspirator.

14. The automatic analyzing apparatus according to claim 7, further comprising a placing base configured to be provided on a transportation path of the transporter, be provided with a connector electrically connected to the measurer and place the measuring chip,
wherein the measurer measures potentials of the plurality of terminals via the connector provided in the placing base.

15. The automatic analyzing apparatus according to claim 7, further comprising processing circuitry configured to control temperature of at least one of the measuring chip, the sample accommodated in the measuring chip, and the mixture liquid accommodated in the measuring chip.

16. The automatic analyzing apparatus according to claim 15, further comprising
a storage container configured to store the measuring chip; and,
a supplier configured to supply the measuring chip stored in the storage container at a supply position that is a position where the measuring chip is supplied.

17. The automatic analyzing apparatus according to claim 16, further comprising
a first detector configured to detect a remaining amount of the measuring chip stored in the storage container; and
wherein the processing circuitry is configured to report to a user when the remaining amount of the measuring chip stored in the storage container is a predetermined remaining amount or less based on a detection result of the first detector.

18. The automatic analyzing apparatus according to claim 15, further comprising a disposal container in which the measuring chip for which measurement by the measurer is completed is disposed of.

19. The automatic analyzing apparatus according to claim 18, further comprising
a second detector configured to detect an amount of the measuring chip disposed of in the disposal container,
wherein the processing circuitry is configured to report to a user when an amount of the measuring chip disposed of in the disposal container is a predetermined amount or more based on a detection result of the second detector.

20. A reaction cuvette, comprising:
a cuvette body configured to accommodate a sample or a mixture liquid obtained by mixing a reagent that reacts with the sample or a diluent that dilutes the sample with the sample; and
a plurality of terminals configured to be provided in the cuvette body and measure a concentration of a target substance of the sample or the mixture liquid accommodated in the cuvette body.

21. The reaction cuvette according to claim 20, wherein the plurality of terminals are provided in the cuvette body by being integrally formed with the cuvette body.

22. The reaction cuvette according to claim 20, wherein the plurality of terminals are provided in the cuvette body by being added to the cuvette body by a terminal applier of an automatic analyzing apparatus.

23. The reaction cuvette according to claim 20, wherein the plurality of terminals each include an ion selective electrode that selectively detects an electrolyte that is the target substance included in the sample or the mixture liquid and a reference electrode that generates a constant potential.

24. An automatic analyzing system, comprising:
the reaction cuvette according to claim 20; and
an automatic analyzing apparatus that analyzes the sample by using the sample or the mixture liquid accommodated in the reaction cuvette,
wherein the automatic analyzing apparatus includes:
a reaction disk configured to hold the reaction cuvette;
a measurer configured to measure potentials of the plurality of terminals of the reaction cuvette; and
a calculator configured to calculate a concentration of a target substance in the sample or the mixture liquid accommodated in the reaction cuvette based on the potential measured by the measurer.
